(19) United States
(12) Patent Application Publication
(10) Pub. No.: US 2026/0057716 A1
(43) Pub. Date: Feb. 26, 2026

(54) INFORMATION PROCESSING DEVICE, INFORMATION PROCESSING METHOD, AND NON-TRANSITORY COMPUTER-READABLE STORAGE MEDIUM STORING PROGRAM

(71) Applicant: TOYOTA JIDOSHA KABUSHIKI KAISHA, Toyota-shi (JP)

(72) Inventor: Katsuya SASAKI, Nagoya-shi (JP)

(73) Assignee: TOYOTA JIDOSHA KABUSHIKI KAISHA, Toyota-shi (JP)

(21) Appl. No.: 19/304,499

(22) Filed: Aug. 19, 2025

(30) Foreign Application Priority Data
Aug. 21, 2024 (JP) 2024-139905
Mar. 18, 2025 (JP) 2025-043409

(51) Int. Cl. G07C 5/08

(52) U.S. Cl. CPC G07C 5/0841

(57) ABSTRACT

The information processing device includes a step of setting a plurality of time windows for segmenting data from the original data using two physical quantities related to damage to the device or the component as a first feature and a second feature, a step of segmenting data from the original data, a step of calculating a frequency distribution in the original data and a frequency distribution in the extracted data for the first feature divided into a plurality of parts by the second feature, and a step of determining whether the original data and the extracted data are similar using the frequency distributions. The information processing apparatus repeatedly executes these steps while changing the setting of a plurality of time windows, and outputs extracted data similar to the original data.

### CROSS-REFERENCE TO RELATED APPLICATIONS

This application is based upon and claims the benefit of priority from Japanese Patent Application No. 2024-139905, filed on Aug. 21, 2024, and Japanese Patent Application No. 2025-043409, filed on Mar. 18, 2025, the entire contents of which are incorporated herein by reference.

### BACKGROUND

### 1. Field

The present disclosure relates to an information processing device, an information processing method, and a non-transitory computer-readable storage medium storing a program.

### 2. Description of Related Art

Japanese Laid-Open Patent Publication No. 2008-108247 discloses an information processing device that compresses original data for analysis to reduce the size of the data for analysis. The original data for analysis is collected over a specified period using sensors installed on a vehicle.

The information processing device disclosed in the patent literature compresses data by extracting, from the original data, data obtained at the point in time when the vehicle reaches a certain vehicle speed and data obtained at the inflection point of the vehicle speed.

It is possible to analyze damage to the devices or components mounted on the vehicle using data acquired by a plurality of sensors mounted on the vehicle. If data suitable for analyzing the degree of damage can be extracted from the original data, the degree of damage can be analyzed in a shorter time by using the extracted data than by using the original data. The information processing device uses the travel data of the vehicle speed, position information, and time. The information processing device extracts a change pattern of the vehicle speed in association with the vehicle speed and the traveling position, and sets an operation schedule for the engine and the motor in which the fuel consumption amount is minimized. The information processing device cannot extract, from the original data, data suitable for analyzing the degree of damage to the devices or components mounted on the vehicle.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An aspect of the present disclosure information provides an information processing device configured to extract part of data from original data collected over a specified period using sensors mounted on a vehicle and analyze a degree of damage to a device or a component mounted on the vehicle. The information processing device includes processing circuitry. A physical quantity related to the damage to the device or the component included in the original data is defined as a first feature, and a physical quantity that is different from the first feature included in the original data is defined as a second feature. The processing circuitry is configured to execute a first process that divides the original data into multiple datasets using the second feature and calculates, for each of the datasets of the original data, a frequency distribution of the first feature in the dataset. The processing circuitry is configured to change time windows and repeatedly execute a second process that sets the time windows for segmenting data for a specific period of the original data such that a period obtained by summing periods of all the time windows is shorter than the specified period, a third process that segments the data from the original data using the time windows, a fourth process that divides extracted data into multiple datasets in correspondence with divisions of the datasets of the original data and calculates, for each of the datasets of the extracted data, the frequency distribution of the first feature in the dataset of the extracted data, the extracted data being obtained by combining all the data segmented by the time windows, and a fifth process that determines whether the original data is similar to the extracted data using the frequency distribution. The processing circuitry is configured to analyze, using the extracted data similar to the original data, the degree of the damage to the device or the component based on the first feature and the second feature.

An aspect of the present disclosure information provides an information processing method in which processing circuitry extracts part of data from original data collected over a specified period using sensors mounted on a vehicle and analyzes a degree of damage to a device or a component mounted on the vehicle. A physical quantity related to the damage to the device or the component included in the original data is defined as a first feature, and a physical quantity that is different from the first feature included in the original data is defined as a second feature. The information processing method includes executing, by the processing circuitry, a first process that divides the original data into multiple datasets using the second feature and calculates, for each of the datasets of the original data, a frequency distribution of the first feature in the dataset. The information processing method includes, by the processing circuitry, changing time windows and repeatedly executing a second process that sets the time windows for segmenting data for a specific period of the original data such that a period obtained by summing periods of all the time windows is shorter than the specified period, a third process that segments the data from the original data using the time windows, a fourth process that divides extracted data into multiple datasets in correspondence with divisions of the datasets of the original data and calculates, for each of the datasets of the extracted data, the frequency distribution of the first feature in the dataset of the extracted data, the extracted data being obtained by combining all the data segmented by the time windows, and a fifth process that determines whether the original data is similar to the extracted data using the frequency distribution. The information processing method includes analyzing, by the processing circuitry, using the extracted data similar to the original data, the degree of the damage to the device or the component based on the first feature and the second feature.

An aspect of the present disclosure information provides a non-transitory computer-readable storage medium storing a program that causes processing circuitry to extract part of data from original data collected over a specified period using sensors mounted on a vehicle and analyze a degree of damage to a device or a component mounted on the vehicle. A physical quantity related to the damage to the device or the component included in the original data is defined as a first feature, and a physical quantity that is different from the first feature included in the original data is defined as a second feature. The program, when executed by the processing circuitry, causes the processing circuitry to execute a first process that divides the original data into multiple datasets using the second feature and calculates, for each of the datasets of the original data, a frequency distribution of the first feature in the dataset. The program, when executed by the processing circuitry, causes the processing circuitry to change time windows and repeatedly execute a second process that sets the time windows for segmenting data for a specific period of the original data such that a period obtained by summing periods of all the time windows is shorter than the specified period, a third process that segments the data from the original data using the time windows, a fourth process that divides extracted data into multiple datasets in correspondence with divisions of the datasets of the original data and calculates, for each of the datasets of the extracted data, the frequency distribution of the first feature in the dataset of the extracted data, the extracted data being obtained by combining all the data segmented by the time windows, and a fifth process that determines whether the original data is similar to the extracted data using the frequency distribution. The program, when executed by the processing circuitry, causes the processing circuitry to analyze, using the extracted data similar to the original data, the degree of the damage to the device or the component based on the first feature and the second feature.

Other features and aspects will be apparent from the following detailed description, the drawings, and the claims.

### BRIEF DESCRIPTION OF THE DRAWINGS

FIG. 1 is a schematic diagram illustrating a relationship between a data center which is an embodiment of an information processing apparatus, a vehicle, and an information processing terminal.

FIG. 2 is a perspective view of the parking lock device.

FIG. 3 is a graph showing a part of the original data of the physical quantity related to the damage to the parking lock device, where section (a) shows the transition of the vehicle speed when the shift position of the vehicle is the parking position, and section (b) shows the transition of the inclination angle of the vehicle when the shift position of the vehicle is the parking position.

FIG. 4 is a flowchart illustrating the flow of processing executed by the processing circuit of the data center.

FIG. 5 is a graph illustrating the frequency distribution of the vehicle speed obtained when the inclination angle is positive and the shift position of the vehicle in the original data is the parking position.

FIG. 6 is a graph illustrating the frequency distribution of the vehicle speed obtained when the inclination angle is zero and the shift position of the vehicle in the original data is the parking position.

FIG. 7 is a graph illustrating the frequency distribution of the vehicle speed obtained when the inclination angle is negative and the shift position of the vehicle in the original data is the parking position.

FIG. 8 is a corrected frequency distribution for the vehicle speed after correction in the extracted data.

FIG. 9 is a sectional view of the rotor.

FIG. 10 is a graph showing a part of the original data of the physical quantity related to the damage to the rotor, where section (a) shows the transition of the angular acceleration of the rotor, section (b) shows the transition of the temperature of the rotor, section (c) shows the transition of the temperature of the motor coil, and section (d) shows the transition of the ATF temperature.

FIG. 11 is a frequency distribution of the angular acceleration of the rotor in the original data when the temperature of the rotor or the temperature of the motor coil is lower than the predetermined temperature.

FIG. 12 is a frequency distribution of the angular acceleration of the rotor in the original data when the temperature of the rotor or the temperature of the motor coil is equal to or higher than the predetermined temperature.

FIG. 13 is a corrected frequency distribution of the corrected angular acceleration in the extracted data.

FIG. 14 is a frequency distribution of the angular acceleration of the rotor in the original data when the ATF temperature is lower than the predetermined temperature.

FIG. 15 is a frequency distribution of the angular acceleration of the rotor in the original data when the ATF temperature is equal to or higher than the predetermined temperature.

FIG. 16 is a cross-sectional view of a differential side portion including an oil seal.

FIG. 17 is a graph showing a part of the original data of the physical quantity related to the damage to the oil seal, where section (a) shows the transition of the rotational speed of the drive shaft, section (b) shows the transition of the ATF temperature, and section (c) shows the transition of the ambient temperature.

FIG. 18 is a frequency distribution of the rotational speed of the drive shaft in the original data when the ATF temperature is lower than the predetermined temperature.

FIG. 19 is a frequency distribution of the rotational speed of the drive shaft in the original data when the ATF temperature is equal to or higher than the predetermined temperature.

FIG. 20 is a graph showing the relationship between the temperature division of the ATF temperature and the weighting of the frequency of the rotational speed of the drive shaft.

FIG. 21 is a corrected frequency distribution for the rotational speed after correction in the extracted data.

FIG. 22 is a frequency distribution of the rotational speed of the drive shaft in the original data when the ambient temperature is lower than the predetermined temperature.

FIG. 23 is a frequency distribution of the rotational speed of the drive shaft in the original data when the ambient temperature is equal to or higher than the predetermined temperature.

FIG. 24 is a cross-sectional view of a power split mechanism including a planetary gear unit.

FIG. 25 is a graph showing a part of original data of the physical quantity related to the damage to the planetary gear unit, where section (a) shows the transition of the torque input to the planetary carrier, section (b) shows the transition of the ATF temperature, section (c) shows the transition of the rotational speed of the second oil pump, and section (d) shows the transition of the inclination angle of the vehicle.

FIG. 26 is a frequency distribution of the input torque to the planetary carrier in the original data when the ATF temperature is lower than the predetermined temperature.

FIG. 27 is a frequency distribution of the input torque to the planetary carrier in the original data when the ATF temperature is equal to or higher than the predetermined temperature.

FIG. 28 is a graph showing the relationship between the temperature division of the ATF temperature and the weighting of the frequency of the input torque.

FIG. 29 is a corrected frequency distribution for the input torque after correction in the extracted data.

FIG. 30 is a frequency distribution of the input torque to the planetary carrier in the original data when the rotational speed of the oil pump is less than the predetermined speed.

FIG. 31 is a frequency distribution of the input torque to the planetary carrier in the original data when the rotational speed of the oil pump is equal to or higher than the predetermined speed.

FIG. 32 is a frequency distribution of the input torque to the planetary carrier in the original data when the inclination angle is positive.

FIG. 33 is a frequency distribution of the input torque to the planetary carrier in the original data when the inclination angle is zero.

FIG. 34 is a frequency distribution of the input torque to the planetary carrier in the original data when the inclination angle is negative.

FIG. 35 is a schematic view showing the relationship between the drive shaft and the steering mechanism.

FIG. 36 is a graph showing a part of the original data of the physical quantity related to the damage to the drive shaft, where section (a) shows the transition of the torque input to the drive shaft, and section (b) shows the transition of the steering wheel angle.

FIG. 37 is a frequency distribution of the input torque to the drive shaft in the original data when the steering wheel angle is greater than or equal to the predetermined angle to the right.

FIG. 38 is a frequency distribution of the input torque to the drive shaft in the original data when the steering wheel angle is less than the predetermined angle to the right and left.

FIG. 39 is a frequency distribution of the input torque to the drive shaft in the original data when the steering wheel angle is greater than or equal to the predetermined angle to the left.

FIG. 40 is a corrected frequency distribution of the corrected input torque in the extracted data.

FIG. 41 is a schematic diagram of a battery and power control unit.

FIG. 42 is a graph showing a part of the original data of the physical quantity related to the damage to the battery, where section (a) shows the transition of the output of the first motor generator, section (b) shows the transition of the temperature of the battery, section (c) shows the transition of the SOC of the battery, section (d) shows the transition of the charging power upper limit value of the battery, and section (e) shows the transition of the discharging power upper limit value of the battery.

FIG. 43 is a frequency distribution of the output of the first motor generator in the original data when the temperature of the battery is lower than the predetermined temperature.

FIG. 44 is a frequency distribution of the output of the first motor generator in the original data when the temperature of the battery is equal to or higher than the predetermined temperature.

FIG. 45 is a corrected frequency distribution of the output of the first motor generator after correction in the extracted data.

FIG. 46 is a frequency distribution of the output of the first motor generator in the original data when the SOC of the battery is less than the first predetermined value.

FIG. 47 is a frequency distribution of the output of the first motor generator in the original data when the SOC of the battery is greater than or equal to the first predetermined value and less than the second predetermined value.

FIG. 48 is a frequency distribution of the output of the first motor generator in the original data when the SOC of the battery is equal to or higher than the second preset value.

FIG. 49 is a frequency distribution of the output of the first motor generator in the original data when the charging power upper limit value of the battery is less than the predetermined value.

FIG. 50 is a frequency distribution of the output of the first motor generator in the original data when the charging power upper limit value of the battery is greater than or equal to the predetermined value.

FIG. 51 is a frequency distribution of the output of the first motor generator in the original data when the discharging power upper limit value of the battery is less than the predetermined value.

FIG. 52 is a frequency distribution of the output of the first motor generator in the original data when the discharging power upper limit value of the battery is greater than or equal to the predetermined value.

FIG. 53 is a schematic diagram of a cooling system including a radiator mounted on the vehicle of FIG. 1.

FIG. 54 is a graph showing a part of the original data of the physical quantity related to the damage to the radiator, where section (a) shows the transition of the sprung mass acceleration of the vehicle, section (b) shows the transition of the temperature of the coolant, section (c) shows the transition of the rotational speed of the crankshaft, and section (d) shows the transition of the rotational speed of the water pump.

FIG. 55 is a frequency distribution of the sprung mass acceleration in the original data when the temperature of the coolant is lower than the predetermined temperature.

FIG. 56 is a frequency distribution of the sprung mass acceleration in the original data when the temperature of the coolant is equal to or higher than the predetermined temperature.

FIG. 57 is a corrected frequency distribution of the corrected sprung mass acceleration in the extracted data.

FIG. 58 is a frequency distribution of the rotational speed of the water pump in the original data when the temperature of the coolant is lower than the predetermined temperature.

FIG. 59 is a frequency distribution of the rotational speed of the water pump in the original data when the temperature of the coolant is equal to or higher than the predetermined temperature.

FIG. 60 is a corrected frequency distribution for the rotational speed of the water pump after correction in the extracted data.

FIG. 61 is a frequency distribution of the sprung mass acceleration in the original data when the crankshaft rotational speed is out of the predetermined range.

FIG. 62 is a frequency distribution of the sprung mass acceleration in the original data when the crankshaft rotational speed is within the predetermined range.

FIG. 63 is a graph showing the relationship between the classification of the crankshaft rotational speed and the weighting of the sprung mass acceleration.

FIG. 64 is a corrected frequency distribution of the corrected sprung mass acceleration in the extracted data.

FIG. 65 is a schematic diagram showing a configuration of an engine mounted on the vehicle of FIG. 1.

FIG. 66 is a graph showing a part of the original data of the physical quantity related to the deposit accumulation amount in the intake system of the engine, where section (a) shows the transition of the valve overlap amount, and section (b) shows the transition of the road surface information category.

FIG. 67 is a frequency distribution of the valve overlap amount in the original data when the road surface information category is a paved road.

FIG. 68 is a frequency distribution of the valve overlap amount in the original data when the road surface information category is the gravel road.

FIG. 69 is a frequency distribution of the valve overlap amount in the original data when the road surface information category is a dirt road.

FIG. 70 is a graph showing the relationship between the valve overlap amount and the deposit accumulation amount.

FIG. 71 is a frequency distribution of the deposit accumulation amount in the extracted data.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

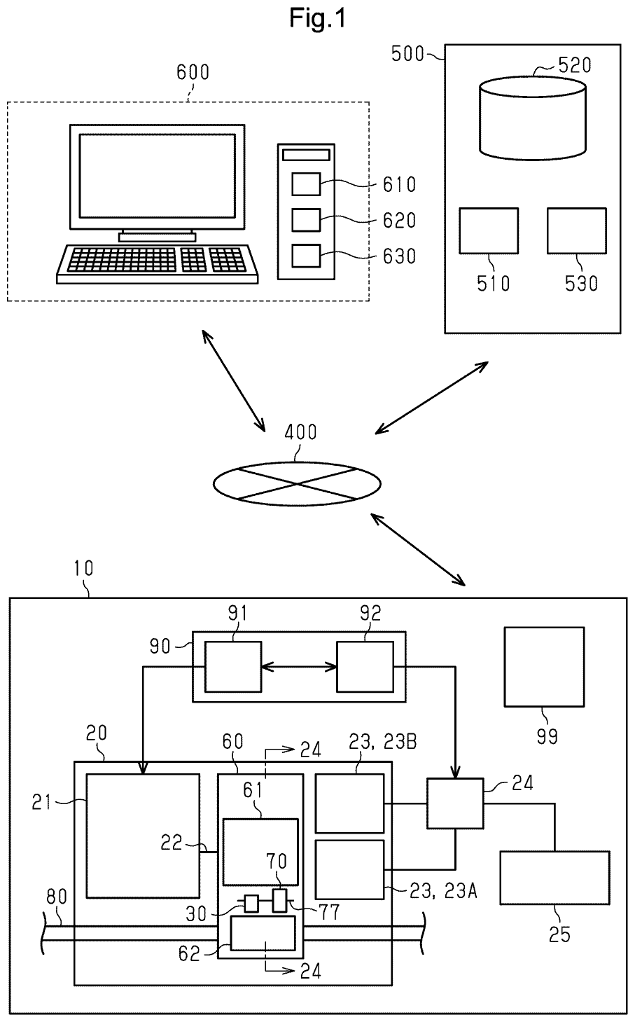

Hereinafter, a first embodiment of an information processing apparatus will be described with reference to FIGS. 1 to 8.

### Configuration of Information Processing System

FIG. 1 shows a configuration of an information processing system. The information processing system includes a data center 500 including an information processing apparatus, an information processing terminal 600, a plurality of vehicles 10, and a communication network 400. The data center 500 can communicate with the plurality of vehicles 10 and the information processing terminal 600 via the communication network 400.

### Configuration of Data Center 500

As illustrated in FIG. 1, the data center 500 includes a processing circuitry 510, a storage device 520, and a communication device 530. The processing circuitry 510 is an information processing apparatus and includes a CPU that executes processing in accordance with a program and a ROM in which the program is stored. The storage device 520 can store a large amount of data. The communication device 530 performs wired or wireless communication via the communication network 400. The communication device 530 includes hardware such as a network adapter, various types of communication software, or a combination thereof.

### Configuration of Information Processing Terminal 600

As illustrated in FIG. 1, the information processing terminal 600 includes a processing circuit 610, a storage device 620, and a communication device 630. The processing circuit 610 includes a CPU that executes processing in accordance with a program and a ROM in which the program is stored. The storage device 620 can store a large amount of data. The communication device 630 performs wired or wireless communication via the communication network 400. The communication device 630 includes hardware such as a network adapter, various types of communication software, or a combination thereof.

The information processing terminal 600 is, for example, a personal computer.

### Configuration of Vehicle 10

The vehicle 10 includes a communication device 99. The communication device 99 transmits data acquired by the vehicle 10 to the data center 500 via the communication network 400. The vehicle 10 includes a hybrid mechanism 20, a power control unit 24 (hereinafter referred to as PCU 24), a battery 25, and a vehicle control unit 90. The vehicle control unit 90 includes a first control device 91 that controls the hybrid mechanism 20 and a second control device 92 that controls the PCU 24. The vehicle control unit 90 includes a plurality of sensors that collect data. The first control device 91 includes a CPU that controls the operation state of the hybrid mechanism 20. The first control device 91 controls the hybrid mechanism 20 based on the data collected by the sensors. The second control device 92 includes a central processing unit that controls the PCU 24. The second control device 92 controls the PCU 24 based on the data collected by the sensor. Examples of the data collected by the vehicle control unit 90 include the crankshaft rotational speed, the motor generator rotational speed, the rotor temperature, the SOC of the battery, and the temperature of the battery.

The hybrid mechanism 20 includes an engine 21, a motor generator 23, a power split mechanism 60, and a drive shaft 80. The power split mechanism 60 includes a planetary gear unit 61, a differential device 62, a reduction gear 70, an output shaft 77, and the parking lock device 30. The engine 21 transmits its output to the power split mechanism 60 via the engine output shaft 22. The motor generator 23 is an electric motor. The motor generator 23 is rotated by using the electric power of the battery 25 converted by the PCU 24. The power split mechanism 60 shifts the outputs of the engine 21 and the motor generator 23 by a plurality of gears including a planetary gear unit 61 and a reduction gear 70. The power split mechanism 60 causes the vehicle 10 to travel by differentially controlling the shifted power by the differential device 62 and transmitting the power to the drive shaft 80.

### Configuration of Parking Lock Device 30

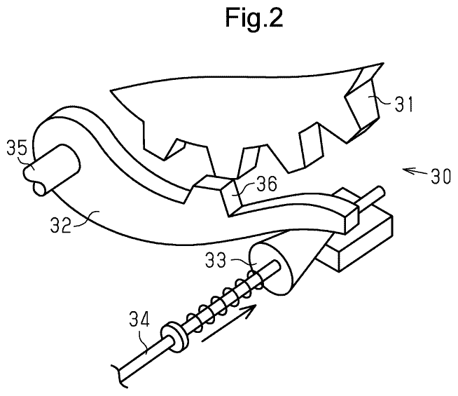

The parking lock device 30 is accommodated in a case of a power split mechanism 60 serving as a transmission. As shown in FIG. 2, the parking lock device 30 includes a parking gear 31, a lock pole 32, a tapered portion 33, a rod 34, a support shaft 35, and a locking piece 36. The parking gear 31 is fixed to, for example, the output shaft 77 to which the reduction gear 70 is fixed. Since only one end of the lock pole 32 is fixed by the support shaft 35, the lock pole 32 can be rotated about the support shaft 35. The lock pole 32 is provided with a locking piece 36. When the locking piece 36 is engaged with the parking gear 31, the rotation of the parking gear 31 is mechanically restricted. Thus, the output shaft 77 is locked so as not to rotate.

FIG. 2 shows a state of the parking lock device 30 when the parking lock is released. The operation of the parking lock device 30 when the output shaft 77 is locked from this state will be described. A rod 34 is connected to the root side of a tapered portion 33 which becomes thinner from the root side toward the tip side. The tapered portion 33 is in contact with the lock pole 32. When the actuator connected to the rod 34 is operated, the rod 34 is pushed forward toward the distal end of the tapered portion 33. At this time, since the tapered portion 33 also moves at the same time, the contact point between the tapered portion 33 and the lock pole 32 moves in a direction away from the central axis of the tapered portion 33. As a result, the lock pole 32 is pushed up by the tapered portion 33 and rotationally moved about the support shaft 35 toward the parking gear 31. Thus, the locking piece 36 is engaged with the parking gear 31, so that the rotation of the parking gear 31 is mechanically restricted.

When the output shaft 77 is unlocked, the parking lock device 30 operates as follows. The rod 34 is pulled back in the root direction of the tapered portion 33 by the actuator. Then, the contact point between the tapered portion 33 and the lock pole 32 moves toward the distal end of the tapered portion 33. The lock pole 32 that has been pushed up by the tapered portion 33 rotates about the support shaft 35 in a direction away from the parking gear 31. Accordingly, the locking piece 36 is not engaged with the parking gear 31, and the rotation of the output shaft 77 is not mechanically restricted.

### Data Extraction

The information processing terminal 600 is used to analyze the degree of damage to a device or a component mounted on a vehicle. When analyzing the degree of damage, the information processing terminal 600 transmits an instruction to the data center 500. The processing circuitry 510 of the data center 500 that has received the instruction performs analysis by using a part of the enormous amount of data stored in the storage device 520 of the data center 500. The data to be used is selected from a large amount of data stored in the storage device 520 in accordance with the purpose of analysis. These pieces of data include data of physical quantities related to damage to devices or components collected using a plurality of sensors mounted on the vehicle 10. These physical quantities are referred to as features. The processing circuitry 510 analyzes the degree of damage accumulated in the parking lock device 30 of the specific vehicle 10 using the feature. In this case, the feature is the vehicle speed and the inclination angle of the vehicle 10 to be analyzed when the shift position of the vehicle 10 to be analyzed is the parking position.

A flow in which the processing circuitry 510 analyzes the degree of damage to a specific device or component of a specific vehicle 10 in accordance with a program will be described below. The processing circuitry 510 acquires the data of the feature related to the specific vehicle 10 from the storage device 520. A load related to the specific device or component is calculated based on the acquired data of the feature. Based on the calculated load, the processing circuitry 510 estimates the damage that has accumulated in the specific device or component. The processing circuitry 510 transmits the damage estimation result to the information processing terminal 600 and displays it.

To perform such an analysis, the processing circuitry 510 utilizes a large amount of data collected over a long period of time. In this analysis, since the processing circuitry 510 performs an enormous amount of calculation, a long time is required for the analysis.

Therefore, it is conceivable to extract extracted data that captures features of the entire original data from a large amount of data that is the original data. If such extracted data can be extracted, the processing circuitry 510 can perform analysis in a shorter time by using the extracted data. For example, in the case of estimating the damage to the component when traveling for 100,000 hours, the processing circuitry 510 estimates the damage by using the extracted data for 20,000 hours extracted from the original data for 100,000 hours. Then, the processing circuitry 510 multiplies the estimated value calculated from the extracted data for 20,000 hours by 5 to calculate an estimated value of damage to the device or the component when traveling for 100,000 hours.

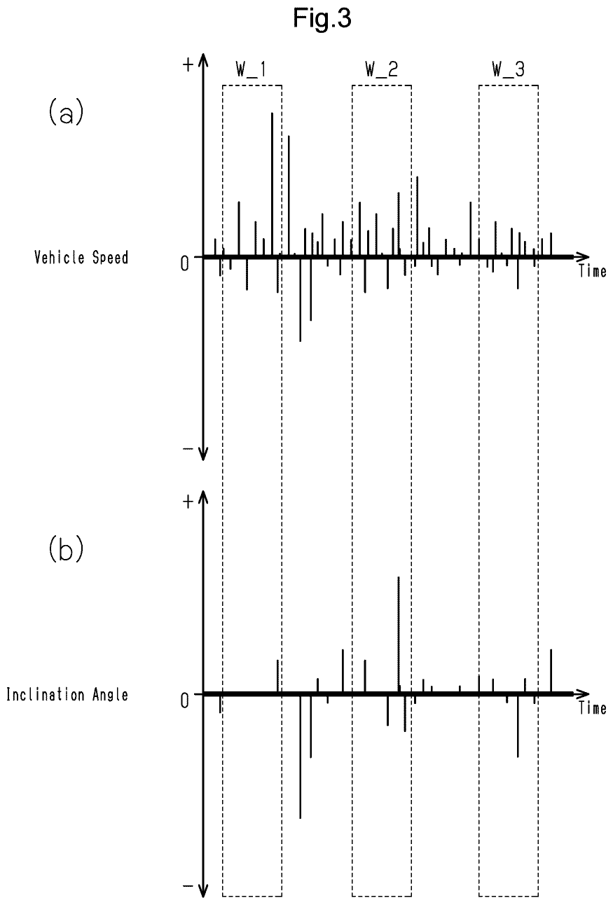

FIG. 3 shows original data of the feature related to the parking lock device 30. The original data shown in FIG. 3 is part of data for 100,000 hours in one vehicle 10. The original data shown in FIG. 3 includes a vehicle speed and an inclination angle as features.

Section (a) of FIG. 3 shows the vehicle speed when the shift position of the vehicle 10 is the parking position in the data of 100,000 hours. The vehicle speed is a positive value when the vehicle is traveling forward. The vehicle speed is a negative value when the vehicle is moving backward. Section (b) of FIG. 3 shows the inclination angle of the vehicle 10 when the shift position of the vehicle 10 is the parking position in the data of 100,000 hours. The inclination angle has a positive value in the case of an upward slope. The inclination angle has a negative value in the case of a downhill.

The vehicle speed of the vehicle 10 and the inclination angle of the vehicle 10 are correlated with the damage to the parking lock device 30 of the vehicle 10. The processing circuitry 510 analyzes the damage accumulated in the parking lock device 30 from the data including the vehicle speed and the inclination angle as the feature.

The extracted data is created by cutting out data from the original data using a plurality of time windows. In FIG. 3, as an example of the plurality of time windows, three time windows of a first time window W_1, a second time window W_2, and a third time window W_3 are respectively indicated by broken lines. The start and end of each time window are set so that the respective time windows do not overlap. In this example, data for 20000 hours is cut out as extracted data. Therefore, the start time and the end time of each time window are set such that the length of the period obtained by summing the periods of all the time windows is 20000 hours.

The data center 500 searches for the setting of the start time and the end time of each time window indicating the segmentation pattern for extracting the extracted data that captures the feature of the entire original data. The data center 500 stores, in the storage device 520, information of the segmentation pattern for extracting the extracted data described above. The information of the stored segmentation pattern is information of the setting of each time window found by the search.

The processing circuitry 510 extracts data from the original data based on the information of the segmentation pattern stored in the storage device 520. The processing circuitry 510 then analyzes the degree of damage to the device or component by using the extracted data.

### Segmentation Pattern Search Process

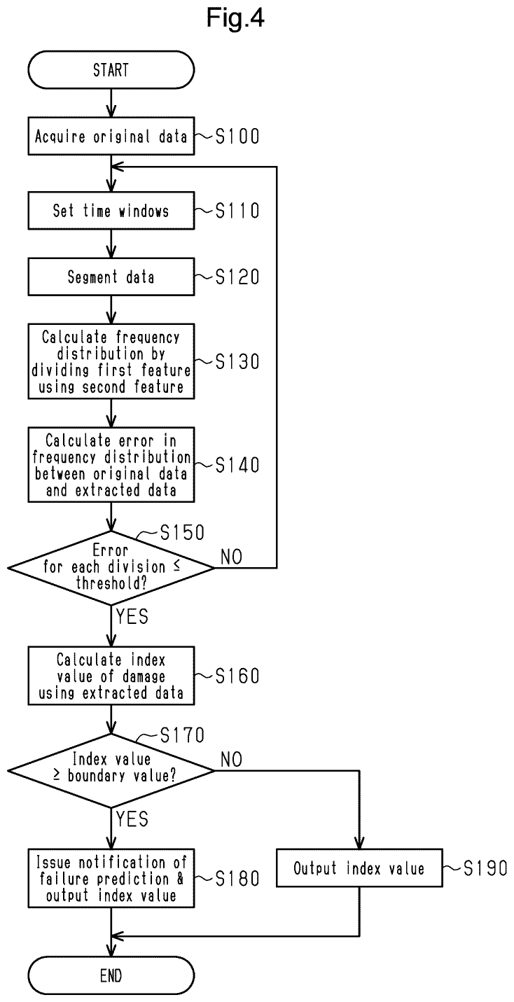

FIG. 4 is a flowchart illustrating the flow of a series of processes related to a segmentation pattern search process. The series of processes is executed by the processing circuitry 510 of the data center 500 in accordance with a program.

As shown in FIG. 4, the processing circuitry 510 acquires original data in the process of step S100. The original data is part of data selected in accordance with the purpose of analysis from a huge amount of data stored in the storage device 520 of the data center 500.

The original data used to analyze the degree of damage to the parking lock device 30 of one vehicle 10 is data of a target vehicle 10 selected from a huge amount of data of multiple vehicles 10.

Next, the processing circuitry 510 sets time windows in order to extract extracted data from the original data in the process of step S110.

In the example shown in FIG. 3, all the time windows have the same period. As shown in FIG. 3, data to be segmented by each segmented window is data of a corresponding feature in the same period.

The processing circuitry 510 randomly sets the number of time windows, the start time of each time window, and the end time of each time window every time the process of step S110 is executed. At this time, the processing circuitry 510 sets the time windows such that they do not overlap each other. In this manner, the processing circuitry 510 randomly sets multiple time windows such that the period obtained by summing all the time windows is equal to a preset period. In the process of step S110, the processing circuitry 510 may set multiple time windows by fixing the period of each time window to be constant as illustrated in FIG. 3. In the process of step S110, the processing circuitry 510 may set multiple time windows by fixing the number of time windows to a certain number.

In this manner, multiple time windows are set through the process of step S110 to determine a segmentation pattern for segmenting data from the original data. Upon determining the segmentation pattern in this manner, the processing circuitry 510 advances the process to step S120.

In the process of step S120, the processing circuitry 510 segments data from the original data in the determined segmentation pattern. That is, in the process of step S120, the processing circuitry 510 segments data from the original data using the set time windows. Then, the processing circuitry 510 combines all the data segmented using the time windows to generate the extracted data.

Next, in the process of step S130, the processing circuitry 510 calculates the frequency distributions of the original data and the extracted data. The original data includes multiple features. One of the features is defined as a first feature, and one of the other features different from the first feature is defined as a second feature.

In the process of step S130, the processing circuitry 510 classifies the data of the first feature included in the original data into multiple divisions using the data of the second feature obtained when the first feature is collected. That is, the processing circuitry 510 divides the data of the first feature included in the original data into multiple datasets using the data of the second feature obtained when the first feature is collected. Similarly, the processing circuitry 510 classifies the data of the first feature included in the extracted data into multiple divisions using the data of the second feature so as to respectively correspond to the divisions of the original data. That is, in the same manner as the original data, the processing circuitry 510 divides the data of the first feature included in the extracted data into multiple datasets using the data of the second feature. Based on the data of the first feature of the original data and the extracted data classified into multiple divisions in this manner, the processing circuitry 510 calculates the frequency distribution of the first feature for each of the divisions of the original data and the extracted data.

In a frequency distribution, the data of the first feature is classified into multiple classes, and the distribution of frequencies (i.e., the number of data points in each class) is presented. Since the total frequency of the first feature included in the data is different between the original data and the extracted data, the frequency distribution of the original data cannot be simply compared with the frequency distribution of the extracted data. When the extracted data for 20,000 hours is extracted from the original data for 100,000 hours, the total frequency of the extracted data is approximately one fifth of that of the original data. In this case, the frequency distribution of the extracted data having the total frequency equivalent to that of the original data can be obtained by multiplying the frequency of each class of the extracted data by five. Instead of the above-described method, the distribution of data in the original data can be compared with the distribution of data in the extracted data by calculating a relative frequency distribution as the frequency distribution of the original data and the extracted data. The relative frequency distribution indicates the percentage of the total frequency accounted for by each class.

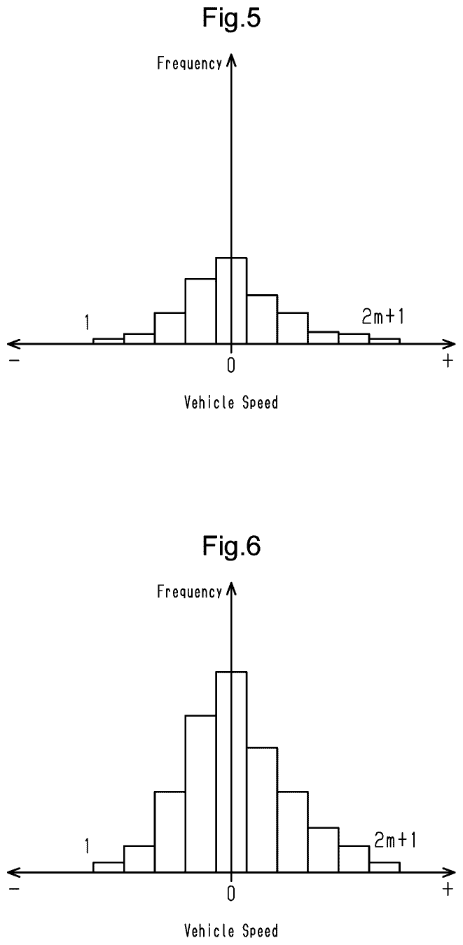

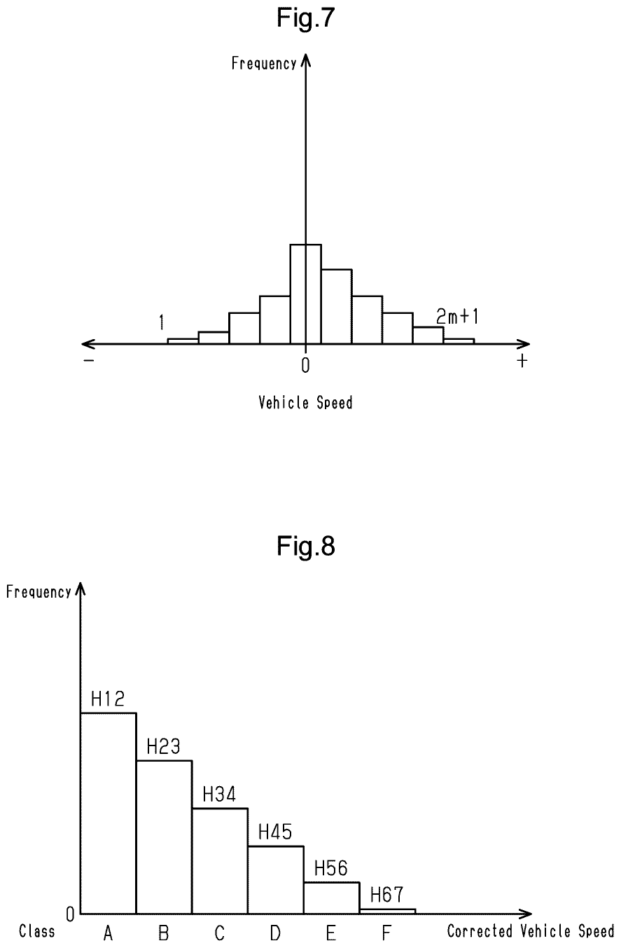

In the analysis of the degree of damage to the parking lock device 30, the first feature is the vehicle speed obtained when the shift position of the vehicle 10 is the parking position. The second feature is the inclination angle of the vehicle 10. FIG. 5 shows the frequency distribution of the vehicle speed of the original data obtained when the inclination angle of the vehicle 10 is positive. FIG. 6 shows the frequency distribution of the vehicle speed of the original data obtained when the inclination angle of the vehicle 10 is zero. FIG. 7 shows the frequency distribution of the vehicle speed of the original data obtained when the inclination angle of the vehicle 10 is negative.

As shown in FIGS. 5 to 7, in these frequency distributions, the classes are divided such that the number of classes in the positive direction is equal to the number of classes in the negative direction, with zero vehicle speed as the central value. In the examples shown in FIGS. 5 to 7, the class having the smallest vehicle speed value is set to 1. In the examples shown in FIGS. 5 to 7, the vehicle speed is divided into (2m+1) classes, labeled from 1 to 2m+1. The frequency distribution of the extracted data is also calculated based on the class divisions corresponding to those of the original data. In this manner, the processing circuitry 510 divides the vehicle speed included in the original data and the extracted data into three categories: a category in which the inclination angle is positive, a category in which the inclination angle is negative, and a category in which the inclination angle is zero. The processing circuitry 510 calculates the above-described frequency distribution for each of the three inclination angle categories.

Next, in the process of step S140 illustrated in FIG. 4, the processing circuitry 510 calculates, for each of the divisions according to the second feature, the error between the frequency distribution of the first feature in the original data and the frequency distribution of the first feature in the extracted data. For example, the processing circuitry 510 calculates a mean absolute error MAE. The mean absolute error MAE is expressed by the following Equation 1.

$$MAE = \frac{1}{n} {\sum }_{i = 1}^{n} \vert {Y}_{i} - {y}_{i} \vert \qquad Equation 1$$

In Equation 1, n is the total number of classes in the frequency distribution. For instance, in the examples illustrated in FIGS. 5 to 7, n is 2m+1. i is an index identifying a class in the frequency distribution. For instance, in the examples shown in FIGS. 5 to 7, i is an index ranging from 1 to 2m+1. Y is the frequency of the first feature in the corresponding class of the original data. y is the frequency of the first feature in the corresponding class of the extracted data.

As shown in Equation 1 above, for each division, the processing circuitry 510 calculates, as an error, the sum of the errors of the frequency in the classes of the first feature between the frequency distribution in the original data and the frequency distribution in the extracted data.

After calculating the errors for all the divisions, the processing circuitry 510 advances the process to step S150. In the process of step S150, the processing circuitry 510 determines whether all of the calculated errors for the respective divisions are less than or equal to a threshold. The threshold is a value used to determine whether the extracted data having a frequency distribution close to the frequency distribution in the original data has been extracted by the set segmentation pattern. Based on the error being less than or equal to the threshold, the magnitude of the threshold is set in advance so as to determine that the extracted data having a frequency distribution close to the frequency distribution in the original data has been extracted. The threshold can be determined as a different value for each division.

In the process of step S150, when determining that all of the errors for the respective divisions are less than or equal to the threshold (step S150: YES), the processing circuitry 510 records the segmentation pattern. Specifically, the processing circuitry 510 causes the storage device 520 to store data of the start time and the end time of each time window in the segmentation pattern as information used to identify the segmentation pattern. Upon recording the segmentation pattern in this manner, the processing circuitry 510 advances the process to step S160.

In the process of step S150, when determining that all of the errors are larger than the threshold (step S150: NO), the processing circuitry 510 returns the process to step S110. That is, the processing circuitry 510 starts a process that sets new time windows in order to reset the time windows and extract the extracted data from the original data.

In this manner, the processing circuitry 510 repeats the processes of steps S110 to S150 until extracted data similar to the original data is extracted using the frequency distribution of the first feature divided by the second feature. As a result, the segmentation pattern in which all of the errors are less than or equal to the threshold is stored in the storage device 520.

### Calculation of Fatigue Damage Level and Predictive Notification of Failure Occurrence

In the process of step S160, the processing circuitry 510 segments the extraction datum from the original data and extracts the extraction datum based on the segmentation pattern of the extraction datum similar to the original data stored in the storage device 520.

Next, the processing circuitry 510 calculates an index value indicating the degree of damage to the device or component by using the extracted data in accordance with the program. For example, the index value is a fatigue damage level. The fatigue damage level is a value from 0 to 1 indicating a ratio of the damage accumulated in the device or the component with the damage causing the fatigue failure in the device or the component as 1.

The processing circuitry 510 calculates an index value using the extracted data which is a part of the original data. Therefore, the processing circuitry 510 calculates the index value corresponding to the original data by converting the calculated index value into the size corresponding to the original data. For example, when the original data is data for 100,000 hours and the extracted data is data for 20000 hours, the index value corresponding to the original data is obtained by multiplying the calculated index value by 5.

Here, the fatigue damage level is calculated as an index value indicating the magnitude of damage accumulated in the parking lock device 30 based on the extracted data.

The damage accumulated by the collision between the parking gear 31 and the lock pole 32 increases as the collision energy generated between the parking gear 31 and the lock pole 32 increases. That is, as the vehicle speed at the time when the shift position of the vehicle 10 is set to the parking position increases, a larger damage is accumulated in the parking lock device 30. When the parking lock is applied while the vehicle 10 is traveling on an inclined ground, the load on the parking lock device 30 due to the vehicle weight increases as the inclination angle increases, and the accumulated damage increases.

As an example, the processing circuitry 510 calculates the fatigue damage level of the parking lock device 30 by the following method.

The processing circuitry 510 calculates the frequency distribution for each division based on the data obtained by dividing the vehicle speed when the shift position is the parking position by the inclination angle at that time. The processing circuitry 510 corrects the vehicle speed with respect to the frequency distribution of the section in which the inclination angle of the vehicle 10 is not zero among the calculated frequency distributions by using Equation 2 shown below.

$${V}_{c} = V - a \times sin θ \qquad Equation 2$$

In Equation 2, Vc represents the corrected vehicle speed, V represents the vehicle speed when the shift position is the parking position, a represents a coefficient, and θ represents the road surface gradient. Θ is a positive value when the road surface gradient is an upward gradient. Θ becomes a negative value when the road surface gradient is a downward gradient.

As shown in Equation 2, by correcting the vehicle speed when the shift position is the parking position in accordance with the division of the inclination angle, it is possible to consider the accumulation of damage to the parking lock device 30 due to the inclination angle of the vehicle 10. For example, in a case where the shift position is set to the parking position when the vehicle 10 is traveling forward on an upward slope, the corrected vehicle speed Vc is a value smaller than V. On an upward slope, the load due to the vehicle weight is generated in a direction in which the vehicle 10 moves backward, and thus the load is corrected so as to be partially offset by the vehicle speed in the forward direction of the vehicle 10.

Based on the corrected vehicle speed Vc obtained in this manner, the processing circuitry 510 aggregates the frequency distributions of all the sections into one frequency distribution corresponding to the case where the inclination angle is zero, and calculates a corrected frequency distribution which is a new frequency distribution in the extracted data.

Next, the processing circuitry 510 calculates the fatigue damage level based on the corrected frequency distribution. FIG. 8 shows an example of a corrected frequency distribution in the analysis of the degree of damage to the parking lock device 30. In this correction frequency distribution, the corrected vehicle speed Vc is classified into six classes A to F. The frequency Hij of each class indicates the number of data in which the vehicle speed Vc after correction is greater than or equal to Vi and less than Vj. For example, in the class B, the corrected vehicle speed Vc is greater than or equal to V2 and less than V3, and the frequency thereof is expressed as H23. An upper limit frequency Gij is set for each class. The upper limit frequency Gij indicates an upper limit damage accumulation frequency at which fatigue failure occurs in the parking lock device 30 when damage due to the corrected vehicle speed Vc included in the corresponding class is accumulated. As an example, in a case where G34 is L times, when the collision between the parking gear 31 and the lock pole 32 occurs L times such that the corrected vehicle speed Vc is included in the range equal to or higher than the V3 and lower than the V4, the fatigue failure occurs in the parking lock device 30. The processing circuitry 510 calculates the fatigue damage level according to the following Equation 3 using the frequency Hij for each class and the upper limit frequency Gij for each class in the corrected frequency distribution.

$$Fatigue Damage Level = \frac{{H}_{12}}{{G}_{12}} + \frac{{H}_{23}}{{G}_{23}} + … + \frac{{H}_{56}}{{G}_{56}} + \frac{{H}_{67}}{{G}_{67}} \qquad Equation 3$$

When the processing circuitry 510 calculates the fatigue damage level based on Equation 3, the processing proceeds to step S170 illustrated in FIG. 4.

In the process of step S170, the processing circuitry 510 determines whether the fatigue damage level is greater than or equal to a boundary value. The boundary value is a value for predicting that the possibility of occurrence of fatigue failure is high based on the fact that the fatigue damage level is equal to or higher than the boundary value. For example, 0.9 can be set as the boundary value of the fatigue damage level. In this case, based on the fact that the fatigue reaches 90% of the fatigue leading to the fatigue fracture, it is possible to predict that the possibility of leading to the fatigue fracture is high.

In the process of step S170, when it is determined that the fatigue damage level is greater than or equal to the boundary value (step S170: YES), the processing circuitry 510 advances the process to step S180. In the process of step S180, the processing circuitry 510 outputs the fatigue damage level and the failure prediction. Specifically, the processing circuitry 510 transmits the fatigue damage level and the failure prediction to the information processing terminal 600, and causes the information processing terminal 600 to display them.

The failure prediction is, for example, a message indicating that the occurrence of fatigue failure has been predicted. In this manner, in a case where the calculated fatigue damage level is greater than or equal to the boundary value, the processing circuitry 510 notifies that the occurrence of the fatigue failure is predicted.

In the process of step S170, when it is determined that the fatigue damage level is less than the boundary value (step S170: NO), the processing circuitry 510 advances the process to step S190. In the process of step S190, the processing circuitry 510 outputs the fatigue damage level. Specifically, the processing circuitry 510 of the data center 500 transmits the calculated fatigue damage level to the information processing terminal 600, and displays the fatigue damage level on the information processing terminal 600.

When the process of step S180 or step S190 is executed, the processing circuitry 510 ends the series of processes based on the program.

### Operation of First Embodiment

The data center 500, which is an information processing apparatus of the present embodiment, extracts part of data from original data collected over a specified period using a plurality of sensors mounted on the vehicle 10, and analyzes the degree of damage accumulated in the parking lock device 30.

The data center 500 includes a processing circuitry 510 that executes processing in accordance with a program. The original data includes, as the first feature, the vehicle speed when the shift position of the vehicle 10 is the parking position. The original data includes data of the inclination angle of the vehicle 10 as the second feature. In the data center 500, the processing circuitry 510 executes a search process. The process includes a first process (step S130) of dividing the first feature into a plurality of sections by the second feature included in the original data and calculating the frequency distribution of the first feature in the original data for each section. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data that satisfies the condition that the error is less than or equal to the threshold. The processing circuitry 510 calculates the fatigue damage level as the index value of the damage by using the extracted data in which the errors are less than or equal to the thresholds (step S160).

According to the data center 500, the analysis can be performed using the extracted data in which the distribution of the feature related to the damage to the parking lock device 30 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of First Embodiment

(1-1) According to the data center 500 which is the information processing apparatus of the first embodiment, it is possible to extract data suitable for analyzing the degree of damage to a device or a component mounted on a vehicle from original data. Therefore, according to the information processing apparatus, it is possible to analyze the degree of damage to the device or the component in a shorter time than in a case where the original data is used.

(1-2) According to the information processing method of the first embodiment, data suitable for analyzing the degree of damage to a device or a component mounted on a vehicle can be extracted from original data. Therefore, according to the above-described information processing method, it is possible to analyze the degree of damage to a device or a component in a shorter time than in the case of using original data.

(1-3) The program provided in the processing circuitry 510 of the first embodiment causes the processing circuitry 510 to extract, from the original data, data suitable for analyzing the degree of damage to a device or a component mounted on a vehicle. Therefore, according to the above-described program, it is possible to cause the processing circuitry 510 to analyze the degree of damage to the device or component in a shorter time than in the case of using the original data.

(1-4) In the fifth process (steps S140 and S150), the processing circuitry 510 of the data center 500 calculates the difference between the frequency distributions of the original data and the extracted data for each of the sorted datasets. When all of the calculated errors for the respective sections are less than or equal to the threshold, it is determined that the original data and the extracted data are similar to each other.

According to the above-described data center 500, the extracted data having a small error in any section is used for the analysis of damage. Therefore, according to the above-described data center 500, it is possible to preferably determine whether the original data and the extracted data are similar to each other without being affected by the difference in the total frequency for each division.

(1-5) The processing circuitry 510 of the data center 500 corrects the first feature included in the extracted data according to the classification, and analyzes the degree of damage to the device or the component based on the corrected first feature.

Even in the case of data having the same first feature, when the second feature is different, the influence on the analysis result is different. By correcting the first feature according to the classification, the influence of the difference in the second feature can be incorporated into the corrected first feature. Therefore, according to the data center 500 described above, it is possible to perform analysis in which the influence of the second feature is also reflected on the basis of the corrected first feature.

(1-6) The data center 500 analyzes the degree of damage to the parking lock device 30 that prevents rotation of the output shaft 77 in the power split mechanism 60 that functions as a transmission. The processing circuitry 510 of the data center 500 sets the vehicle speed when the shift position of the transmission is the parking position as the first feature, and sets the inclination angle of the vehicle as the second feature.

The parking lock device 30 accumulates damage due to the collision between the parking gear 31 and the lock pole 32. The accumulation of damage progresses as the number of collisions increases. The damage accumulated by the collision increases as the collision energy generated between the parking gear 31 and the lock pole 32 increases. That is, as the vehicle speed when the shift position is set to the parking position increases, the damage accumulated in the parking lock device 30 increases. When the shift position is set to the parking position while the vehicle 10 is traveling on a slope, the magnitude of damage accumulated in the parking lock device 30 varies depending on the magnitude of the inclination angle. As the inclination angle increases, a load due to the weight of the vehicle is applied to the parking lock device 30, and thus damage accumulated in the parking lock device 30 increases. The data center 500 acquires the extracted data by using the two physical quantities that affect the magnitude of the damage accumulated in the parking lock device 30 as the features.

Therefore, according to the data center 500, it is possible to extract data suitable for analyzing the degree of damage to the parking lock device 30.

### Second Embodiment

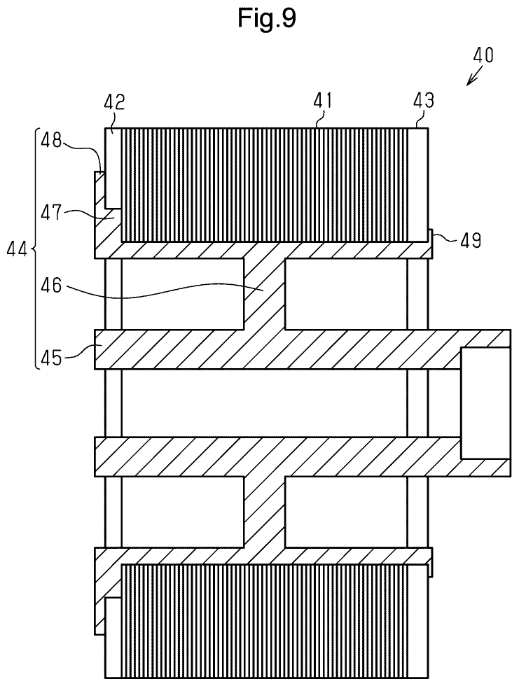

Next, a second embodiment of the information processing apparatus will be described with reference to FIGS. 9 to 15. The second embodiment is an information processing apparatus that analyzes the degree of damage to a rotor 40 of a motor generator 23, which is one of rotating machines mounted on a vehicle. The second embodiment is different from the first embodiment in a device or a component to be analyzed for the degree of damage. In the following description, differences from the first embodiment will be mainly described. Detailed description of the same members as those in the first embodiment will be omitted. Also in the second embodiment, the information processing apparatus that analyzes the degree of damage is the processing circuitry 510 of the data center 500.

### Configuration of Motor Generator 23

As described with reference to FIG. 1, the hybrid mechanism 20 mounted on the vehicle 10 includes the motor generator 23. The motor generator 23 includes a rotor 40 and a stator.

As shown in FIG. 9, the rotor 40 includes a rotor core 41, a rotor shaft 44, an end plate 42, and an end plate 43. As shown in FIG. 9, the rotor shaft 44 includes a central axis 45 and a mounting portion 46. The mounting portion 46 is in direct contact with the rotor core 41 and the end plate 42,43. A small flange 47 and a large flange 48 are provided at one end of the mounting portion 46. A caulked portion 49 is provided at the other end of the mounting portion 46.

The rotor core 41 is an annular electromagnetic steel plate, and is laminated along the rotation axis of the rotor shaft 44. Annular end plates 42,43 are disposed at both ends of the stacked rotor cores 41.

As shown in FIG. 9, the end plate 42 located at the left end of the stacked rotor cores 41 is in contact with the large flange 48 of the rotor shaft 44 on the surface opposite to the surface in contact with the stacked rotor cores 41. In the end plate 42, a convex portion provided on the inner circumferential surface of the annular ring is fitted into a concave portion provided on the outer circumferential surface of the small flange 47 of the rotor shaft 44. In the laminated rotor core 41, a convex portion provided on an inner circumferential surface of an annular ring of the rotor core 41 and a concave portion provided in the mounting portion 46 of the rotor shaft 44 are fitted to each other. The rotor core 41 and the end plate 42 can rotate integrally with the rotor shaft 44 by fitting the concave portion and the convex portion in this manner. The end plate 43 located at the right end of the stacked rotor cores 41 is fixed to the rotor shaft 44 by being pressed toward the rotor core 41 by the caulked portion 49 and at the same time being caulked radially outward of the end plate 43.

The rotor 40 rotates about a central axis 45 of the rotor shaft 44. The rotational speed of the rotor 40 frequently changes in accordance with acceleration and deceleration of the vehicle. At this time, when a sudden change in the rotational speed occurs, damage accumulates in the rotor 40 due to inertia. The end plate 43 is pressed against the rotor core 41 by the caulked portion 49 and is fixed to the rotor shaft 44. In this configuration, when a rapid change in rotational speed occurs, a slight deviation occurs between the rotor core 41 and the end plate 43, and the rotor core 41 and the end plate 43 collide with each other, whereby damage is accumulated. As a result, the caulked portion 49 between the rotor shaft 44 and the end plate 43 is loosened, which leads to failure of the rotor 40.

### Data Extraction

The information processing terminal 600 transmits an instruction to analyze the degree of damage to the rotor 40, which is a rotating machine, to the data center 500. Then, similarly to the first embodiment, the data center 500 performs a process of cutting out data from the original data using a plurality of time windows.

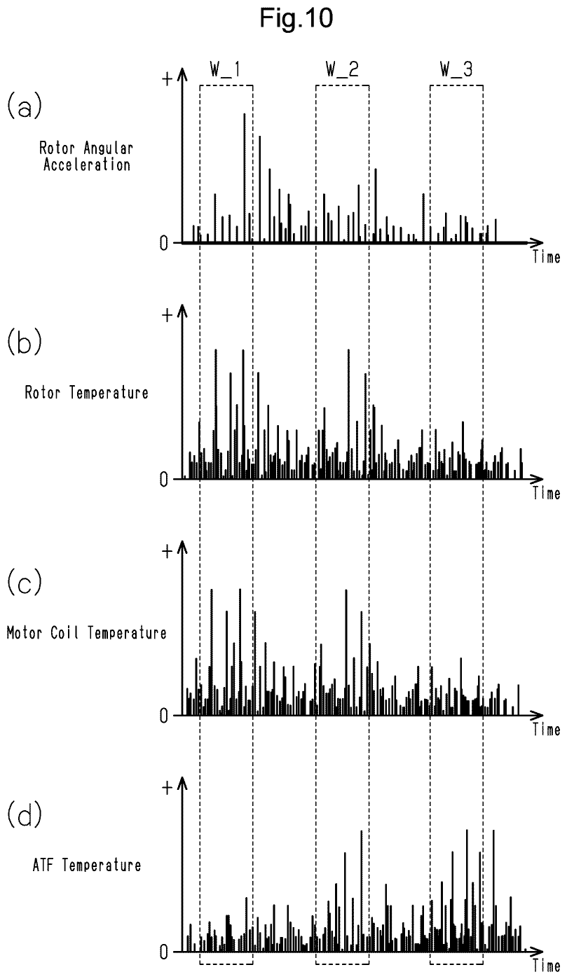

FIG. 10 shows original data of a feature related to the rotor 40 of a specific vehicle 10. The original data shown in FIG. 10 is part of data for 100,000 hours in the vehicle 10 to be analyzed. The original data shown in FIG. 10 includes, as features, the angular velocity of the rotor 40, the temperature of the rotor 40, the temperature of the motor coil of the motor generator 23, which is a temperature correlated with the temperature of the rotor 40, and the automatic transmission fluid (ATF) temperature, which is the temperature of the refrigerant that cools the rotor 40. The feature is a physical quantity correlated with damage to the rotor 40. Section (a) of FIG. 10 shows the angular acceleration of the rotor 40, that is, the amount of change in the rotational speed. Section (b) of FIG. 10 shows the temperature of the rotor 40. Section (c) of FIG. 10 shows the temperature of the motor coil of the motor generator 23. Section (d) of FIG. 10 shows the ATF temperature. The data center 500 finds a segmentation pattern for extracting extracted data that captures the features of the entire original data including the above-described feature. The processing circuitry 510 analyzes the damage accumulated in the rotor 40 of the vehicle 10 to be analyzed using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the rotor 40 of the vehicle 10 to be analyzed.

Next, in the process of step S110, the processing circuitry 510 determines a segmentation pattern by setting a plurality of time windows in the same manner as in the first embodiment. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

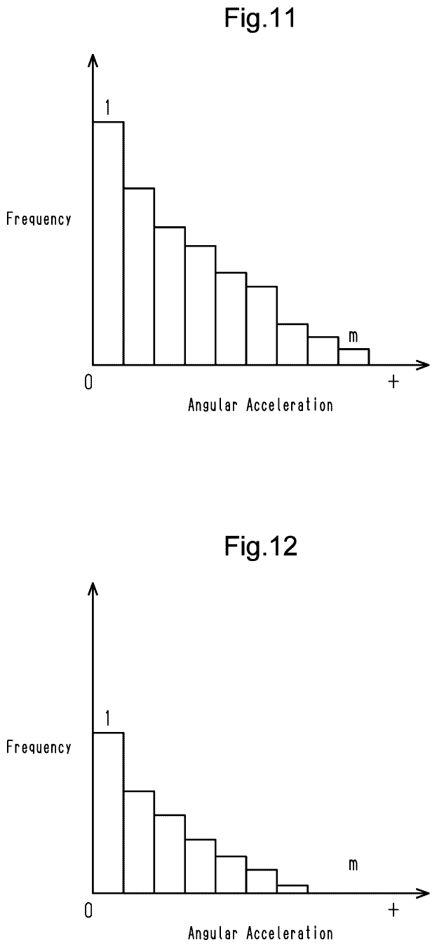

In the process of step S130, the processing circuitry 510 calculates the frequency distributions of the features related to the damage to the rotor 40. In the analysis of the degree of damage to the rotor 40, the first feature is the angular acceleration of the rotor 40. The second feature is the temperature of the rotor 40 or the temperature of the motor coil of the motor generator 23. The processing circuitry 510 divides the angular acceleration of the rotor 40 into a plurality of sections according to the temperature of the rotor 40 or the temperature of the motor coil, and calculates the frequency distribution of the original data and the extracted data obtained by combining all the data segmented by the plurality of time windows, as in the first embodiment. FIG. 11 shows the frequency distribution of the angular acceleration of the rotor 40 in the original data when the temperature of the rotor 40 or the motor coil of the vehicle 10 to be analyzed is lower than the predetermined temperature. FIG. 12 shows the frequency distribution of the angular acceleration of the rotor 40 in the original data when the temperature of the rotor 40 or the motor coil of the vehicle 10 to be analyzed is equal to or higher than the predetermined temperature. As shown in FIGS. 11 and 12, in these frequency distributions, the angular acceleration is divided into m classes of 1 to m with the angular acceleration of zero as the minimum class. The frequency distribution of the extracted data is also calculated based on the class divisions corresponding to those of the original data. In the case of this example, the processing circuitry 510 divides the angular acceleration of the rotor 40 included in the original data and the extracted data into two sections of a section in which the temperature of the rotor 40 or the temperature of the motor coil is lower than a predetermined temperature and a section in which the temperature is equal to or higher than the predetermined temperature. The processing circuitry 510 calculates the frequency distribution as described above for each of the two divisions of the temperature of the rotor 40 or the temperature of the motor coil.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 11 and 12, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Fatigue Damage Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the second embodiment, similarly to the first embodiment, the fatigue damage level is calculated as an index value indicating the degree of damage accumulated in the rotor 40 based on the extracted data.

In the rotor 40, when a change in the rotational speed occurs, the end plate 43 constituting the rotor 40 rattles due to inertia acting on the rotor 40, so that collision between the end plate 43 and the rotor core 41 is repeated and damage is accumulated. The accumulation of damage increases as the amount of change in the rotational speed, that is, the angular acceleration, increases. Since the strength of the end plate 43 and the rotor core 41 changes depending on the temperature, the magnitude of damage accumulated by the collision changes according to the temperature of the rotor 40 at the time of the collision.

As an example, the processing circuitry 510 calculates the fatigue damage level of the rotor 40 by the following method.

The processing circuitry 510 calculates a frequency distribution for each division based on data obtained by dividing the angular acceleration of the rotor 40 by the temperature of the rotor 40 or the temperature of the motor coil at that time. One of the plurality of calculated sections is determined as a reference section. Next, with respect to the data of the section other than the reference section, the data of the angular acceleration included in the section is corrected according to the section of the temperature. This correction can be performed by using an arbitrary method that can reflect a change in the caulking strength of the caulked portion 49 and the press-fitting force to the rotor core 41 and the end plate 43 due to the temperature in consideration of the thermal expansion coefficient, the thermal conductivity, and the like of each member constituting the rotor 40. As an example, when the angular acceleration ωc after correction is calculated by defining a mathematical equation in which the temperature of the rotor 40 or the temperature of the motor coil is incorporated, the subsequent processing is as follows.

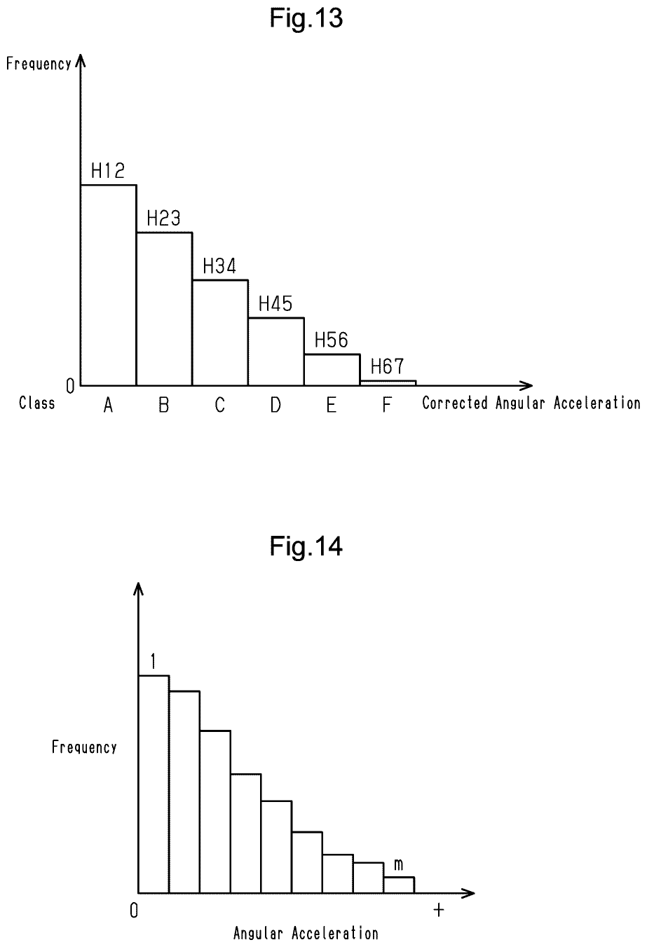

Based on the corrected angular acceleration ωc obtained by using the formula as described above, the processing circuitry 510 aggregates the frequency distributions of all the sections into one frequency distribution determined as a reference section, and calculates a corrected frequency distribution which is a new frequency distribution in the extracted data. Next, the processing circuitry 510 calculates the fatigue damage level based on the corrected frequency distribution. FIG. 13 shows an example of the corrected frequency distribution in the analysis of the degree of damage to the rotor 40. In this correction frequency distribution, the corrected angular acceleration ωc is classified into six classes A to F. The frequency Hij of each class indicates the number of data in which the angular acceleration ωc after correction is greater than or equal to ωi and less than ωj. For example, in class B, the corrected angular accelerations ωc greater than or equal to ω2 and less than ω3 are classified, and the frequency thereof is expressed as H23. An upper limit frequency Gij is set for each class. The upper limit frequency Gij indicates an upper limit damage accumulation frequency at which fatigue failure occurs in the rotor 40 when damage due to the corrected angular acceleration ωc included in the corresponding class is accumulated. As an example, when G34 is L times, the rotor 40 is fatigue-fractured when the rotational speed changes L times such that the corrected angular velocity ωc falls within the range of ω3 or more and less than ω4. Similarly to the first embodiment, the processing circuitry 510 calculates the fatigue damage level according to Equation 3 using the frequency Hij for each class and the upper limit frequency Gij for each class in the corrected frequency distribution. After calculating the fatigue damage level, the processing circuitry 510 advances the process to step S170 illustrated in FIG. 4.

The processing circuitry 510 performs the same processing as in the first embodiment for the process of the subsequent steps S170 to S190.

### Operation of Second Embodiment

The data center 500, which is an information processing apparatus according to the second embodiment, extracts part of data from original data collected over a specified period using a plurality of sensors mounted on the vehicle 10, and analyzes the degree of damage accumulated in the rotor 40 of the motor generator 23.

The data center 500 includes a processing circuitry 510 that executes processing in accordance with a program. The original data includes the angular acceleration of the rotor 40, which is a rotating machine mounted on the vehicle 10, as the first feature. The original data includes, as the second feature, the temperature of the rotor 40 or the temperature of the motor coil of the motor generator 23, which is a temperature correlated with the temperature of the rotor 40. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the fatigue damage level as the index value of the damage by using the extracted data in which the errors are less than or equal to the thresholds (step S160).

According to the data center 500, the analysis can be performed using the extracted data in which the distribution of the feature related to the damage to the rotor 40 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantage of Second Embodiment

The second embodiment has the following advantages in addition to the advantages (1-1) to (1-5) of the first embodiment.

(2-1) The data center 500 analyzes the degree of damage to the rotor 40 of the motor generator 23, which is a rotating machine. The processing circuitry 510 of the data center 500 sets the angular acceleration of the rotor 40 as a first feature, and sets the temperature of the rotor 40 or the temperature of the motor coil of the motor generator 23 as a second feature.

In the rotor 40, when a change in rotational speed occurs, the end plate 43 constituting the rotor 40 rattles due to inertia acting on the rotor 40. Thus, collision between the end plate 43 and the rotor core 41 is repeated, the rotor core 41 wears, and damage is accumulated. The accumulation of damage increases as the amount of change in the rotational speed, that is, the angular acceleration, increases. Since the strength of the member constituting the rotor 40 changes depending on the temperature, the magnitude of the damage accumulated by the collision changes according to the temperature of the rotor 40 at the time of the collision. The data center 500 acquires the extracted data by using the two physical quantities affecting the magnitude of the damage accumulated in the rotor 40 as the features. Therefore, according to the data center 500, it is possible to extract data suitable for analyzing the degree of damage to the rotor 40.

### Modifications of Second Embodiment

The second embodiment may be modified as follows. The second embodiment and the following modifications of the second embodiment can be implemented in combination with each other as long as there is no technical contradiction.

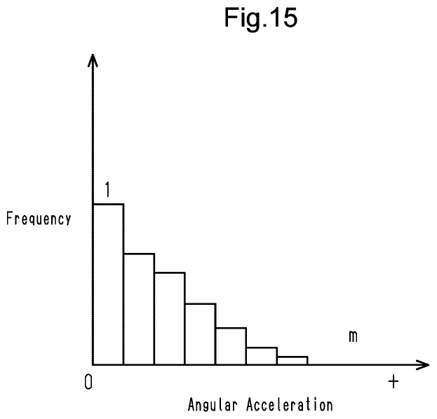

The data center 500 extracts data by dividing the rotational speed of the rotor 40 into a plurality of sections according to the temperature of the rotor 40 or the temperature of the motor coil of the motor generator 23. The data center 500 can use the temperature of the refrigerant that cools the rotor 40 as the second feature instead of the temperature of the rotor 40 or the temperature of the motor coil of the motor generator 23. The temperature of the coolant that cools the rotor 40 is, for example, the ATF temperature. The processing circuitry 510 of the data center 500 divides the angular acceleration of the rotor 40 into a plurality of sections according to the ATF temperature, and calculates the frequency distribution of the original data and the extracted data. For example, FIG. 14 shows the frequency distribution of the angular acceleration of the rotor 40 in the original data when the ATF temperature of the vehicle 10 to be analyzed is lower than the predetermined temperature. FIG. 15 shows the frequency distribution of the angular acceleration of the rotor 40 in the original data when the ATF temperature of the vehicle 10 to be analyzed is equal to or higher than the predetermined temperature. In these frequency distributions, the angular acceleration is divided into m classes of 1 to m with the angular acceleration of zero as the minimum class. The processing circuitry 510 calculates the frequency distribution of the angular acceleration in the original data and the extracted data, as shown in FIGS. 14 and 15, for each section of the ATF temperature. The data center 500 may extract the extracted data from the original data by using the frequency distribution calculated by being classified according to the ATF temperature.

Since the strength of each member constituting the rotor 40 changes depending on the temperature, the magnitude of damage accumulated by the collision changes according to the temperature of the rotor 40 at the time of the collision. The ATF temperature, which is the temperature of the refrigerant that cools the rotor 40, affects the temperature of the rotor 40. The data center 500 acquires the extracted data by using the ATF temperature, which affects the magnitude of damage accumulated in the rotor 40, as the second feature. Therefore, the data center 500 can extract data suitable for analyzing the degree of damage to the rotor 40.

The data center 500 analyzes the degree of damage to the rotor 40 of the motor generator 23 mounted on the hybrid mechanism 20 as a rotating machine. However, the rotating machine whose degree of damage can be analyzed by the data center 500 is not limited to the rotor 40 of the motor generator 23. Similarly to the rotor 40, the present invention can be used to analyze the degree of damage to other rotating machines constituted by a combination of a plurality of members. For example, the present invention can be used to analyze the degree of damage to a crankshaft, a shaft with a gear, or other rotating devices or components.

### Third Embodiment

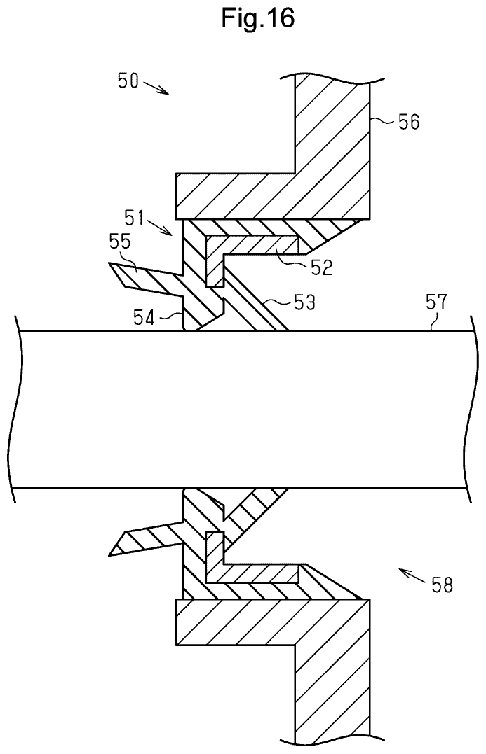

Next, a third embodiment of the information processing apparatus will be described with reference to FIGS. 16 to 23. The third embodiment is an information processing apparatus that analyzes the degree of damage to an oil seal, which is one of seal components with which a rotor mounted on a vehicle is in sliding contact. The third embodiment is different from the first embodiment in a device or a component to be analyzed for the degree of damage. In the following description, differences from the first embodiment will be mainly described. Detailed description of the same members as those in the first embodiment will be omitted. Also in the third embodiment, the information processing apparatus that analyzes the degree of damage is the processing circuitry 510 of the data center 500.

### Configuration of Differential Side Portion 50

FIG. 16 is a schematic cross-sectional view of the differential side portion 50. The differential side portion 50 is a portion in which the drive shaft 57 protrudes from the housing 56 accommodating the differential device 62 to the outside of the housing 56. In FIG. 16, the right side of the drawing is a space corresponding to the inside of the housing 56.

As shown in FIG. 16, the differential side portion 50 includes an oil seal 51 in addition to the housing 56 and the drive shaft 57. The oil seal 51 is an annular component having a cross-sectional shape shown in FIG. 16 and including a core portion 52, a main lip 53, a sub-lip 54, and a side lip 55. The oil seal 51 is fitted and fixed to the opening 58 of the housing 56. The drive shaft 57 is configured to protrude to the outside of the housing 56 through the opening 58 of the housing 56 and the inside of the annular ring of the oil seal 51.

The main lip 53 and the sub-lip 54 of the oil seal 51 are in sliding contact with the drive shaft 57. Therefore, the main lip 53 and the sub-lip 54 wear due to friction with the drive shaft 57, and deterioration progresses. The oil seal 51 is a component having a function of preventing leakage of lubricating oil from the inside of the housing and simultaneously preventing entry of dust from the outside of the housing. That is, the oil seal 51 is in contact with the lubricating oil inside the housing and the outside air outside the housing. Therefore, the deterioration of the oil seal 51 depends on the temperature of the lubricating oil and the ambient temperature.

### Data Extraction

The information processing terminal 600 transmits, to the data center 500, an instruction to analyze the degree of damage to the oil seal 51, which is a seal component in sliding contact with the drive shaft 57, which is a rotor. Then, similarly to the first embodiment, the data center 500 performs a process of cutting out data from the original data using a plurality of time windows.

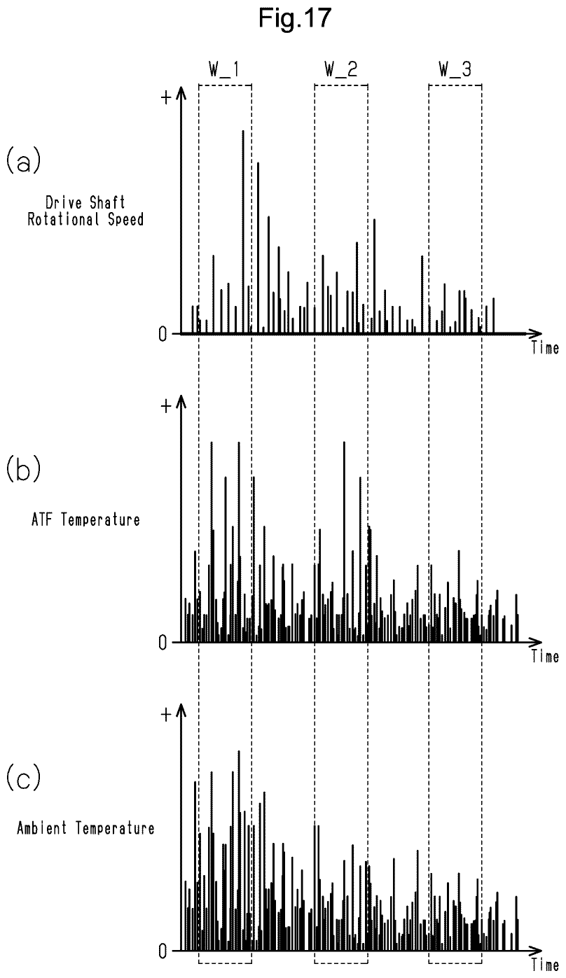

FIG. 17 shows original data of the feature related to the oil seal 51 of the specific vehicle 10. The original data shown in FIG. 17 is part of data for 100,000 hours in the vehicle 10 to be analyzed. The original data shown in FIG. 17 includes, as features, the rotational speed of the drive shaft 57, the temperature of the ATF that is the fluid sealed by the oil seal 51, and the ambient temperature. The feature is a physical amount correlated with the damage to the oil seal 51. Section (a) of FIG. 17 shows the rotational speed of the drive shaft 57. Section (b) of FIG. 17 shows the temperature of the ATF. Section (c) of FIG. 17 shows the ambient temperature. The data center 500 finds a segmentation pattern for extracting extracted data that captures the features of the entire original data including the above-described feature. The processing circuitry 510 analyzes the damage accumulated in the oil seal 51 of the vehicle 10 to be analyzed by using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the oil seal 51 of the vehicle 10 to be analyzed.

Next, in the process of step S110, the processing circuitry 510 sets a plurality of time windows as in the first embodiment, and determines a segmentation pattern. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

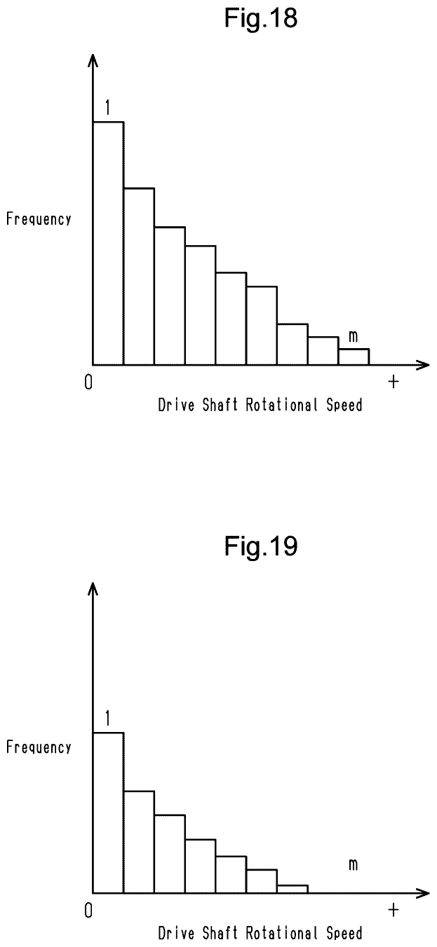

In the process of step S130, the processing circuitry 510 calculates the frequency distributions of the features related to the damage to the oil seal 51. In the analysis of the degree of damage to the oil seal 51, the first feature is the rotational speed of the drive shaft 57. The second feature is the ATF temperature. The processing circuitry 510 divides the rotational speed of the drive shaft 57 into a plurality of sections according to the ATF temperature, and calculates the frequency distribution of the original data and the extracted data obtained by combining all the data segmented by the plurality of time windows, as in the first embodiment. FIG. 18 shows a frequency distribution of the rotational speed of the drive shaft 57 in the original data when the ATF temperature of the vehicle 10 to be analyzed is lower than the predetermined temperature. FIG. 19 shows the frequency distribution of the rotational speed of the drive shaft 57 in the original data when the ATF temperature of the vehicle 10 to be analyzed is equal to or higher than the predetermined temperature. As shown in FIGS. 18 and 19, in these frequency distributions, the rotational speed is divided into m classes of 1 to m with the rotational speed of zero as the minimum class. The frequency distribution of the extracted data is also calculated based on the class divisions corresponding to those of the original data. In the case of this example, the processing circuitry 510 divides the rotational speed of the drive shaft 57 included in the original data and the extracted data into two sections of a section in which the ATF temperature is lower than a predetermined temperature and a section in which the ATF temperature is equal to or higher than the predetermined temperature. The processing circuitry 510 calculates the frequency distribution as described above for each of the two sections of the ATF temperature.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 18 and 19, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Deterioration Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the third embodiment, the deterioration level is calculated as an index value indicating the degree of damage accumulated in the oil seal 51 based on the extracted data. For example, the deterioration level can be defined as a value from 0 to 1 indicating the ratio of deterioration accumulated in the oil seal 51, with the deterioration level leading to the occurrence of a problem related to the oil seal 51 being 1. The deterioration of the oil seal is, for example, wear and deformation of the oil seal. Such deterioration may cause problems such as leakage of lubricating oil and insufficient lubrication of the differential device.

The oil seal 51 in sliding contact with the drive shaft 57 wears and deteriorates due to friction with the drive shaft 57. Therefore, deterioration due to sliding contact is more likely to progress as the rotational speed of the drive shaft 57 is higher. The oil seal 51 is more likely to deteriorate as the temperature of the oil seal 51 increases. The temperature of the oil seal 51 is affected by the temperature of the ATF sealed by the oil seal 51.

As an example, the processing circuitry 510 calculates the deterioration level of the oil seal 51 by the following method.

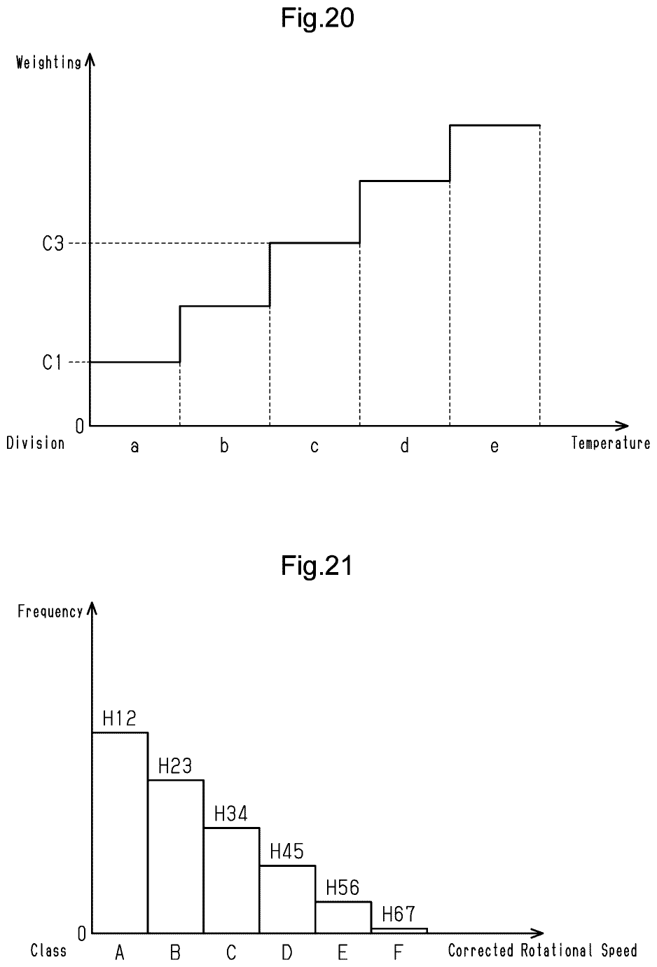

The processing circuitry 510 calculates a frequency distribution for each division based on data obtained by dividing the rotational speed of the drive shaft 57 by the ATF temperature at that time. Among the plurality of sections for which the frequency distribution is calculated, the section with the lowest ATF temperature is determined as a reference section. Next, the processing circuitry 510 performs a process of correcting the frequency distribution of the sections other than the section in which the ATF temperature is the lowest to a frequency distribution corresponding to the frequency distribution in the section in which the ATF temperature is the lowest in accordance with the temperature section of the ATF temperature. FIG. 20 is a graph showing the relationship between the temperature range of the ATF temperature and the weighting of the frequency of the rotational speed. By using FIG. 20, the frequency distribution of a certain section can be corrected to a frequency distribution corresponding to the frequency distribution in the division where the ATF temperature is the lowest. In FIG. 20, the ATF temperature is divided into five divisions a to e with the lowest temperature division a. For example, when the frequency distribution in the temperature section c is corrected to the frequency distribution corresponding to the temperature section a, the frequency Fi of each class of the corrected frequency distribution is calculated using FIG. 20 and the following Equation 4.

$${F}_{i} = {f}_{i} \times \frac{{C}_{3}}{{C}_{1}} \qquad Equation 4$$

In Equation 4, i is an index identifying a class in the frequency distribution. In the example illustrated in FIGS. 18 and 19, i is an index ranging from 1 to m. fi is the frequency of the class I in the temperature section c. Fi is the frequency of the class I when fi is corrected to the frequency in the temperature section a. As shown in FIG. 20, C3 and C1 are coefficients used for weighting the temperature section c and the temperature section a, respectively.

The processing circuitry 510 calculates the frequency of each class of the corrected frequency distribution using Equation 4 above. Then, the processing circuitry 510 adds the calculated frequency of each class to the frequency of each class corresponding to the frequency distribution of the section with the lowest ATF temperature. In this manner, the processing circuitry 510 integrates the frequency distributions of the plurality of sections into the frequency distribution of the section with the lowest ATF temperature, and calculates a corrected frequency distribution that is a new frequency distribution in the extracted data.

Next, the processing circuitry 510 calculates the deterioration level based on the corrected frequency distribution. FIG. 21 shows an example of a corrected frequency distribution in the analysis of the degree of damage to the oil seal 51. In this correction frequency distribution, the rotational speed Rc after correction is classified into six classes A to F. The frequency Hij of each class indicates the number of data in which the corrected rotational speed Rc is greater than or equal to Ri and less than Rj. For example, in the class B, the corrected rotational speed Rc is greater than or equal to R2 and less than R3, and the frequency thereof is expressed as H23. An upper limit frequency Gij is set for each class. The upper limit frequency Gij indicates an upper limit damage accumulation frequency at which a failure occurs in the oil seal 51 when the damage due to the corrected rotational speed Rc included in the corresponding class is accumulated. As an example, in a case where G34 is L times, when the drive shaft 57 rotates L times such that the corrected rotational speed Rc is included in the range of R3 or more and less than R4, a failure occurs in the oil seal 51. The processing circuitry 510 calculates the deterioration level in accordance with the following Equation 5 using the frequency Hij for each class and the upper limit frequency Gij for each class in the corrected frequency distribution.

$$Deterioration Level = \frac{{H}_{12}}{{G}_{12}} + \frac{{H}_{23}}{{G}_{23}} + … + \frac{{H}_{56}}{{G}_{56}} + \frac{{H}_{67}}{{G}_{67}} \qquad Equation 5$$

Upon calculating the deterioration level, the processing circuitry 510 advances the process to step S170 illustrated in FIG. 4.

The processing circuitry 510 performs the same processing as in the first embodiment for the process of the subsequent steps S170 to S190.

### Operation of Third Embodiment

The data center 500 which is the information processing apparatus of the third embodiment extracts part of data from original data collected over a specified period using a plurality of sensors mounted on the vehicle 10. Using the extracted data, the data center 500 analyzes the degree of damage accumulated in the oil seal 51 provided in the differential side portion 50.

The data center 500 includes a processing circuitry 510 that executes processing in accordance with a program. The original data includes, as the first feature, the rotational speed of the drive shaft 57, which is a rotor in sliding contact with the oil seal 51 mounted on the vehicle 10. The original data includes the ATF temperature, which is the temperature of the fluid sealed by the oil seal 51, as the second feature. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the deterioration level as the index value of the damage by using the extracted data in which the errors are less than or equal to the thresholds (step S160).

According to the data center 500, the analysis can be performed by using the extracted data in which the distribution of the feature related to the damage to the oil seal 51 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantage of Third Embodiment

The third embodiment has the following advantages in addition to the advantages (1-1) to (1-5) of the first embodiment.

(3-1) The data center 500 analyzes the degree of damage to the oil seal 51, which is a seal component in sliding contact with the drive shaft 57, which is a rotor. The processing circuitry 510 of the data center 500 uses the rotational speed of the drive shaft 57 as a first feature and the ATF temperature as a second feature.

The oil seal 51 in sliding contact with the drive shaft 57 wears and deteriorates due to friction with the drive shaft 57. Therefore, deterioration due to friction is more likely to progress as the rotational speed of the drive shaft 57 is higher. The oil seal 51 is more likely to deteriorate as the temperature of the oil seal 51 increases. The temperature of the oil seal 51 is affected by the temperature of the ATF that is the fluid sealed by the oil seal 51. The data center 500 acquires the extracted data by using the two physical quantities affecting the magnitude of the damage accumulated in the oil seal 51 as the features. Therefore, according to the data center 500, it is possible to extract data suitable for analyzing the degree of damage to the oil seal 51.

### Modification of Third Embodiment

The third embodiments may be modified as follows. The third embodiment and the following modifications of the third embodiment can be implemented in combination with each other as long as there is no technical contradiction.

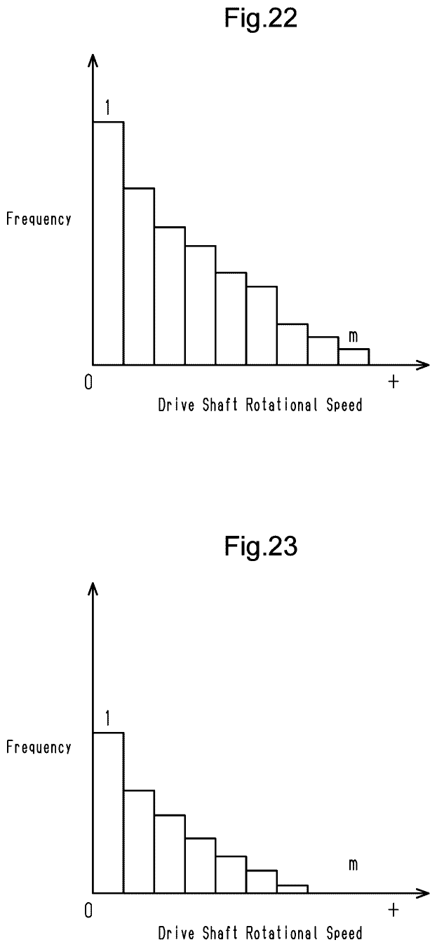

The data center 500 extracts data by dividing the rotational speed of the drive shaft 57 into a plurality of sections according to the ATF temperature. The data center 500 can use the ambient temperature instead of the ATF temperature as the second feature. The processing circuitry 510 of the data center 500 calculates the frequency distribution of the original data and the extracted data by dividing the rotational speed of the drive shaft 57 into a plurality of sections according to the ambient temperature. For example, FIG. 22 shows a frequency distribution of the rotational speed of the drive shaft 57 in the original data when the ambient temperature around the vehicle 10 to be analyzed is lower than the predetermined temperature. FIG. 23 shows the frequency distribution of the rotational speed of the drive shaft 57 in the original data when the ambient temperature around the vehicle 10 to be analyzed is equal to or higher than the predetermined temperature. In these frequency distributions, the rotational speed is divided into m classes of 1 to m with the rotational speed of zero as the minimum class. The processing circuitry 510 calculates the frequency distribution of the rotational speed between the original data and the extracted data as illustrated in FIGS. 22 and 23 for each classification of the ambient temperature. The data center 500 can extract the extracted data from the original data by using the frequency distribution calculated by dividing the data according to the ambient temperature.

The oil seal 51 wears and deteriorates due to friction with the drive shaft 57. Therefore, deterioration due to friction is more likely to progress as the rotational speed of the drive shaft 57 is higher. The oil seal 51 is more likely to deteriorate as the temperature of the oil seal 51 increases. The temperature of the oil seal 51 is affected by the ambient temperature. The data center 500 acquires the extracted data by using the two physical quantities affecting the progress of the deterioration of the oil seal 51 as the features. Therefore, according to the data center 500, it is possible to extract data suitable for analyzing the degree of damage to the oil seal 51.

The data center 500 extracts data using the rotational speed of the drive shaft 57 as the first feature and the ATF temperature as the second feature. However, the physical quantities used as the first feature and the second feature are not limited to the physical quantities described above. Any physical quantity, such as humidity or climate information based on vehicle position information, may be used as long as the physical quantity affects the degree of damage to the seal component with which the rotor is in sliding contact. For example, humidity affects the deterioration of the oil seal 51. The oil seal 51 is more likely to deteriorate as the humidity around the seal increases.

The data center 500 described above analyzes the degree of damage to the oil seal 51 provided in the differential side portion 50 as a seal component with which the rotor is in sliding contact. However, the seal component of which the degree of damage can be analyzed by the data center 500 is not limited to the oil seal 51. For example, the present invention can be used to analyze the degree of damage to a transmission shaft, a propeller shaft, or any other seal component with which a rotor is in sliding contact.

### Fourth Embodiment

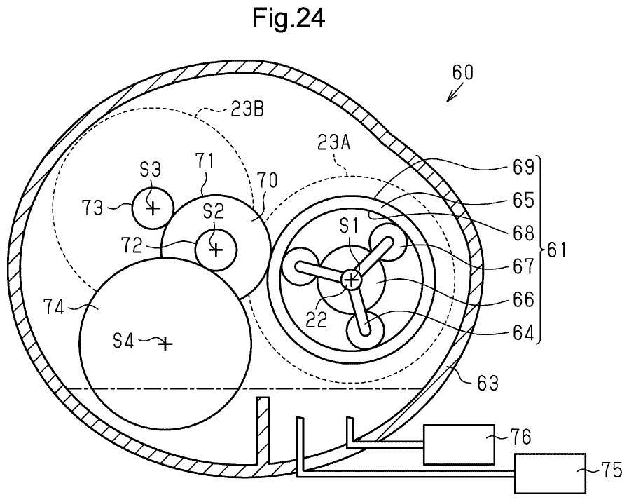

Next, a fourth embodiment of the information processing apparatus will be described with reference to FIGS. 24 to 34. The fourth embodiment is an information processing apparatus that analyzes the degree of damage to a planetary gear unit 61 mounted on a vehicle. The fourth embodiment is different from the first embodiment in a device or a component to be analyzed for the degree of damage. In the following description, differences from the first embodiment will be mainly described. Detailed description of the same members as those in the first embodiment will be omitted. Also in the fourth embodiment, the information processing apparatus that analyzes the degree of damage is the processing circuitry 510 of the data center 500.

### Configuration of Power Split Mechanism 60

The power split mechanism 60 is a power transmission device that transmits power generated by the engine 21, the first motor generator 23A, and the second motor generator 23B to driving wheels of the vehicle 10. As shown in FIG. 24, the power split mechanism 60 includes a planetary gear unit 61, a reduction gear 70, a motor gear 73, and a differential ring gear 74 inside the case 63. A power split mechanism 60 shown in FIG. 24 is used, for example, in a front-wheel drive vehicle. The planetary gear unit 61 includes a sun gear 66, three pinion gears 67, a planetary carrier 64, and a ring 65. The sun gear 66 is positioned at the center of the planetary gear unit 61. The sun gear 66 is connected to the first motor generator 23A. The three pinion gears 67 are disposed around the sun gear 66 while being supported by the planetary carrier 64. The ring 65 is provided with a ring gear 68 on its inner peripheral surface and an engine output gear 69 on its outer peripheral surface. The rotation axis of the sun gear 66, the rotation axis of the planetary carrier 64, the rotation axis of the ring 65, and the engine output shaft 22 are on the same straight line. The engine output shaft 22 is an output shaft of the engine 21. The output of the engine 21 is input to the planetary carrier 64.

FIG. 24 shows the axis S1 to the axis S4. The axis S1 is an axis through which a rotation shaft of the sun gear 66, a rotation shaft of the planetary carrier 64, a rotation shaft of the ring 65, and the engine output shaft 22 pass. The axis S2 is an axis through which the rotation shaft of the reduction gear 70 passes. The axis S3 is an axis through which the rotational shaft of the second motor generator 23B and the rotational shaft of the motor gear 73 pass. The motor gear 73 is fixed to an output shaft of the second motor generator 23B. The axis S4 is an axis passing through a rotation axis of the differential ring gear 74.

The output torque of the engine 21 is input to the planetary gear unit 61 via the engine output shaft 22. The input torque is distributed from the pinion gears 67 connected by the planetary carrier 64 to the sun gear 66 and the ring gear 68. The sun gear 66 is coupled to the first motor generator 23A. The first motor generator 23A is, for example, a rotating machine used for both electric power generation and traveling. The torque distributed to the ring gear 68 rotationally drives the ring 65, thereby rotationally driving the engine output gear 69. The engine output gear 69 meshes with a large reduction gear 71 of the reduction gear 70. At the same time, the large reduction gear 71 also meshes with a motor gear 73 provided in the second motor generator 23B. The second motor generator 23B is, for example, a rotating machine for traveling. As shown in FIG. 24, the reduction gear 70 includes a small reduction gear 72 in addition to the large reduction gear 71. The small reduction gear 72 is meshed with the differential ring gear 74. The driving force of the differential ring gear 74 is transmitted to the driving wheels via the differential device 62. With the above configuration, the power split mechanism 60 can transmit power to the drive wheels after integrating the input torques of the engine 21 and the motor generator 23 into one by the large reduction gear 71.

Each gear part in the case 63 including the planetary gear unit 61 is lubricated by the lubricating oil. The lubrication with the lubricating oil is performed by, for example, scraping up the lubricating oil with a gear immersed in the lubricating oil or spraying the lubricating oil supplied by an oil pump. Lubricating oil is stored in a lower portion of the case 63. The one dot chain line in FIG. 24 indicates the liquid level of the lubricating oil stored in the case 63. As shown in FIG. 24, a lower portion of the differential ring gear 74 is immersed in the lubricating oil. Therefore, when the differential ring gear 74 rotates, the gears in the case 63 are lubricated by the scooped lubricating oil. On the other hand, the first oil pump 75 and the second oil pump 76 suck the lubricating oil stored in the lower portion of the case 63 and output the lubricating oil to the supply path of the lubricating oil. The first oil pump 75 is, for example, an oil pump connected to a gear driven by the differential ring gear 74. In this case, the supply of the lubricating oil by the first oil pump 75 correlates with the rotational speed of the differential ring gear 74. The second oil pump 76 is, for example, an oil pump connected to the engine output shaft 22 of the engine 21. In this case, the supply of the lubricating oil by the second oil pump 76 correlates with the rotational speed of the engine 21. Therefore, the lubrication state of the planetary gear unit 61 depends on the scooping of the lubricating oil by the differential ring gear 74 and the supply of the lubricating oil by the first oil pump 75 and the second oil pump 76.

### Data Extraction

The information processing terminal 600 transmits an instruction to analyze the degree of damage to the planetary gear unit 61 to the data center 500. Then, similarly to the first embodiment, the data center 500 performs a process of cutting out data from the original data using a plurality of time windows.

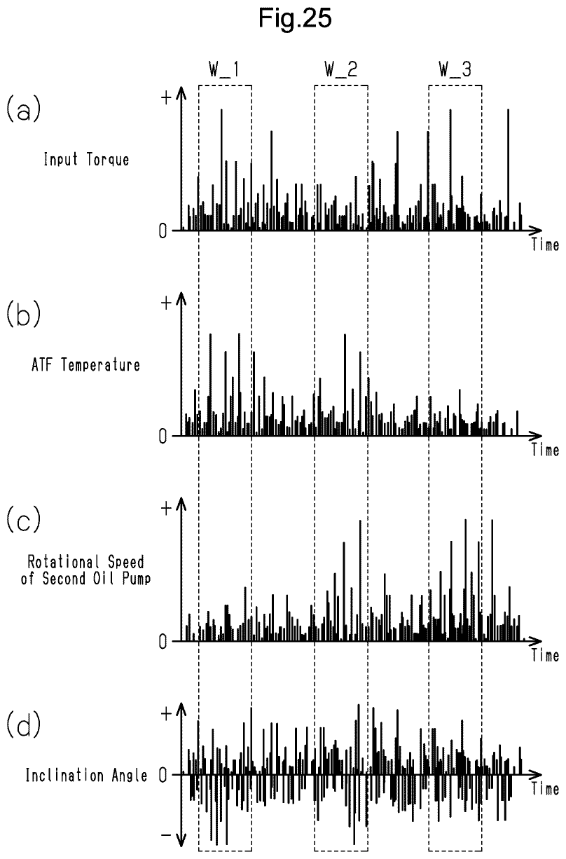

FIG. 25 shows original data of the feature related to the planetary gear unit 61 of the specific vehicle 10. The original data shown in FIG. 25 is part of data for 100,000 hours in the vehicle 10 to be analyzed. The original data shown in FIG. 25 includes, as a feature, torque input to the planetary gear unit 61, for example, torque input to the planetary carrier 64. The original data includes the temperature of the ATF which is the lubricating oil for lubricating the planetary gear unit 61, the rotational speed of the second oil pump 76 which is a pump for discharging the lubricating oil for lubricating the planetary gear unit 61, and the inclination angle of the vehicle 10. The feature is a physical amount correlated with the damage to the planetary gear unit 61. Section (a) of FIG. 25 shows the torque input to the planetary carrier 64. Section (b) of FIG. 25 shows the ATF temperature. Section (c) of FIG. 25 shows the rotational speed of the second oil pump 76. Section (d) of FIG. 25 shows the inclination angle of the vehicle 10. The data center 500 finds a segmentation pattern for extracting extracted data that captures the features of the entire original data including the above-described feature. The processing circuitry 510 analyzes the damage accumulated in the planetary gear unit 61 of the vehicle 10 to be analyzed by using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the planetary gear unit 61 of the vehicle 10 to be analyzed.

Next, in the process of step S110, the processing circuitry 510 sets a plurality of time windows as in the first embodiment, and determines a segmentation pattern. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

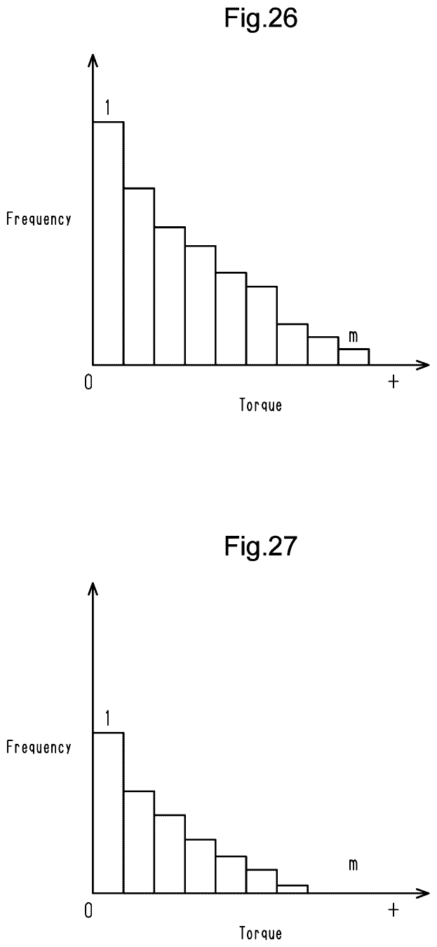

In the process of step S130, the processing circuitry 510 calculates the frequency distributions of the features related to the damage to the planetary gear unit 61. In the analysis of the degree of damage to the planetary gear unit 61, the first feature is the torque input to the planetary carrier 64. The second feature is the ATF temperature. The processing circuitry 510 divides the torque input to the planetary carrier 64 into a plurality of sections according to the ATF temperature, and calculates the frequency distribution of the original data and the extracted data obtained by combining all the data segmented by the plurality of time windows, as in the first embodiment. FIG. 26 shows the frequency distribution of the torque input to the planetary carrier 64 in the original data when the ATF temperature of the vehicle 10 to be analyzed is lower than the predetermined temperature. FIG. 27 shows the frequency distribution of the torque input to the planetary carrier 64 in the original data when the ATF temperature of the vehicle 10 to be analyzed is equal to or higher than the predetermined temperature. As shown in FIGS. 26 and 27, in these frequency distributions, the input torque is divided into m classes of 1 to m with the input torque of zero as the minimum class. The frequency distribution of the extracted data is also calculated based on the class divisions corresponding to those of the original data. In this example, the processing circuitry 510 divides the torque input to the planetary carrier 64, which is included in the original data and the extracted data, into two sections: a section in which the ATF temperature is lower than a predetermined temperature and a section in which the ATF temperature is equal to or higher than the predetermined temperature. The processing circuitry 510 calculates the frequency distribution as described above for each of the two sections of the ATF temperature.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 26 and 27, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Fatigue Damage Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the fourth embodiment, similarly to the first embodiment, the fatigue damage level is calculated as an index value indicating the degree of damage accumulated in the planetary gear unit 61 based on the extracted data.

The planetary gear unit 61 wears due to repetition of engagement and collision between the gears, and damage accumulates. As the torque input to the planetary carrier 64 increases, the stress acting between the gears increases, and the damage accumulated by the engagement and collision increases. The lubrication state of the planetary gear unit 61 affects the friction acting between the gears of the planetary gear unit 61. When the temperature of the lubricating oil that lubricates the planetary gear unit 61 rises, the supply of the lubricating oil to the planetary gear unit 61 becomes favorable, and the friction between the gears decreases. Therefore, when the temperature of the lubricating oil that lubricates the planetary gear unit 61 rises, accumulation of damage to the planetary gear unit 61 is suppressed.

As an example, the processing circuitry 510 calculates the fatigue damage level of the planetary gear unit 61 by the following method.

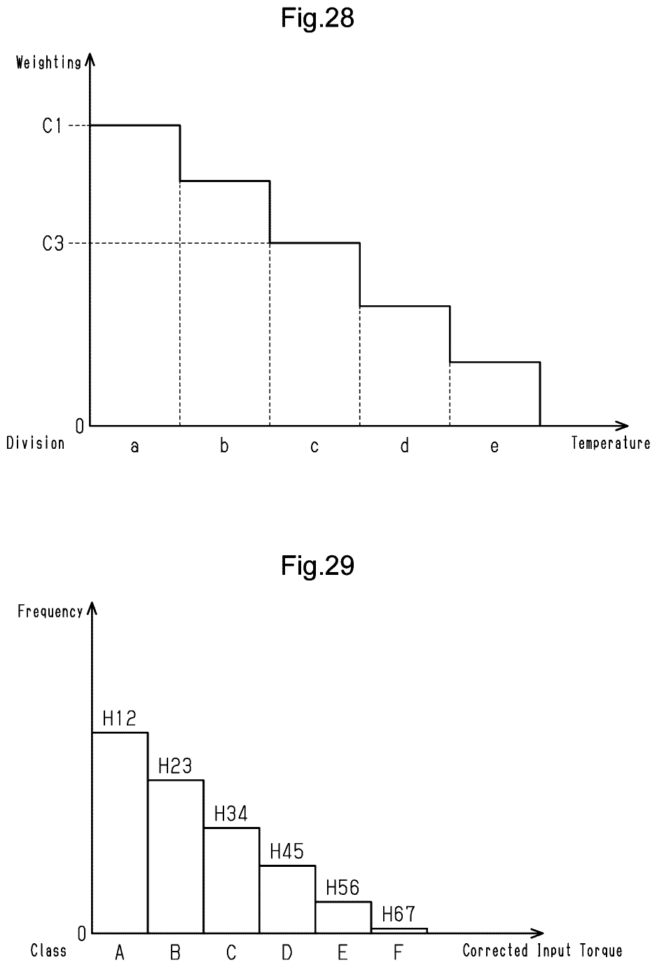

The processing circuitry 510 calculates the frequency distribution for each division based on the data obtained by dividing the torque input to the planetary carrier 64 by the ATF temperature at that time. Among the plurality of sections for which the frequency distribution is calculated, the section with the lowest ATF temperature is determined as a reference section. Next, the processing circuitry 510 performs a process of correcting the frequency distribution of the sections other than the section in which the ATF temperature is the lowest to a frequency distribution corresponding to the frequency distribution in the section in which the ATF temperature is the lowest in accordance with the temperature section of the ATF temperature. FIG. 28 is a graph showing the relationship between the temperature range of the ATF temperature and the weighting of the frequency of the input torque. By using FIG. 28, the frequency distribution of a certain section can be corrected to a frequency distribution corresponding to the frequency distribution in the section where the ATF temperature is the lowest. In FIG. 28, the ATF temperature is divided into five sections a to e, with the lowest temperature division a. For example, in a case where the frequency distribution in the temperature section c is corrected to the frequency distribution corresponding to the temperature section a, the frequency of each class of the corrected frequency distribution is calculated using Equation 4, similarly to the third embodiment.

In Equation 4, i is an index identifying a class in the frequency distribution. In the example illustrated in FIGS. 26 and 27, i is an index ranging from 1 to m. fi is the frequency of the class I in the temperature section c. Fi is the frequency of the class I when fi is corrected to the frequency in the temperature section a. As shown in FIG. 28, C3 and C1 are coefficients used for weighting the temperature section c and the temperature section a, respectively.

The processing circuitry 510 calculates the frequency of each class of the corrected frequency distribution using Equation 4 above. Then, the processing circuitry 510 adds the calculated frequency of each class to the frequency of each class corresponding to the frequency distribution of the section with the lowest ATF temperature. In this manner, the processing circuitry 510 integrates the frequency distributions of the plurality of sections into the frequency distribution of the section with the lowest ATF temperature, and calculates a corrected frequency distribution that is a new frequency distribution in the extracted data.

Next, the processing circuitry 510 calculates the fatigue damage level based on the corrected frequency distribution. FIG. 29 shows an example of a corrected frequency distribution in the analysis of the degree of damage to the planetary gear unit 61. In this correction frequency distribution, the corrected input torque Tc is classified into six classes A to F. The frequency Hij of each class indicates the number of data in which the input torque Tc after correction is greater than or equal to Ti and less than Tj. For example, in the class B, the corrected input torque Tc is classified as T2 or more and less than T3, and the frequency thereof is expressed as H23. An upper limit frequency Gij is set for each class. The upper limit frequency Gij indicates an upper limit damage accumulation frequency at which fatigue failure occurs in the planetary gear unit 61 when damage due to the corrected input torque Tc included in the corresponding class is accumulated. As an example, in a case where G34 is L times, when a torque such that the corrected input torque Tc is included in a range greater than or equal to the T3 and less than the T4 is input to the planetary carrier 64 L times, the planetary gear unit 61 is fatigue-fractured. Similarly to the first embodiment, the processing circuitry 510 calculates the fatigue damage level according to Equation 3 using the frequency Hij for each class and the upper limit frequency Gij for each class in the corrected frequency distribution. After calculating the fatigue damage level, the processing circuitry 510 advances the process to step S170 illustrated in FIG. 4.

The processing circuitry 510 performs the same processing as in the first embodiment for the process of the subsequent steps S170 to S190.

### Operation of Fourth Embodiment

The data center 500 which is the information processing apparatus of the fourth embodiment extracts part of data from original data collected over a specified period using a plurality of sensors mounted on the vehicle 10, and analyzes the degree of damage accumulated in the planetary gear unit 61.

The data center 500 includes a processing circuitry 510 that executes processing in accordance with a program. The original data includes, as the first feature, the torque input to the planetary carrier 64 which is the torque input to the planetary gear unit 61 mounted on the vehicle 10. The original data includes the ATF temperature, which is the temperature of the lubricating oil that lubricates the planetary gear unit 61, as the second feature. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the fatigue damage level as the index value of the damage by using the extracted data in which the errors are less than or equal to the thresholds (step S160).

According to the data center 500, the analysis can be performed using the extracted data in which the distribution of the feature related to the damage to the planetary gear unit 61 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of Fourth Embodiment

The fourth embodiment has the following advantages in addition to the advantages (1-1) to (1-5) of the first embodiment.

(4-1) The data center 500 analyzes the degree of damage to the planetary gear unit 61, and the processing circuitry 510 of the data center 500 uses the torque input to the planetary carrier 64 as the first feature and the ATF temperature as the second feature.

The planetary gear unit 61 wears due to repetition of engagement and collision between the gears, and damage accumulates. As the torque input to the planetary carrier 64 increases, the stress acting between the gears increases, and the damage accumulated by the engagement and collision increases. The lubrication state of the planetary gear unit 61 affects the friction acting between the gears of the planetary gear unit 61. When the temperature of the lubricating oil that lubricates the planetary gear unit 61 rises, the supply of the lubricating oil to the planetary gear unit 61 becomes favorable, and the friction between the gears decreases. Therefore, when the temperature of the lubricating oil that lubricates the planetary gear unit 61 rises, accumulation of damage to the planetary gear unit 61 is suppressed. The data center 500 acquires the extracted data by using the two physical quantities affecting the accumulation of damage in the planetary gear unit 61 as the features. Therefore, according to the data center 500, it is possible to extract data suitable for analyzing the degree of damage to the planetary gear unit 61.

### Modification of Fourth Embodiment

The above-described fourth embodiment may be modified as follows. The fourth embodiment and the following modifications of the fourth embodiment can be implemented in combination with each other as long as there is no technical contradiction.

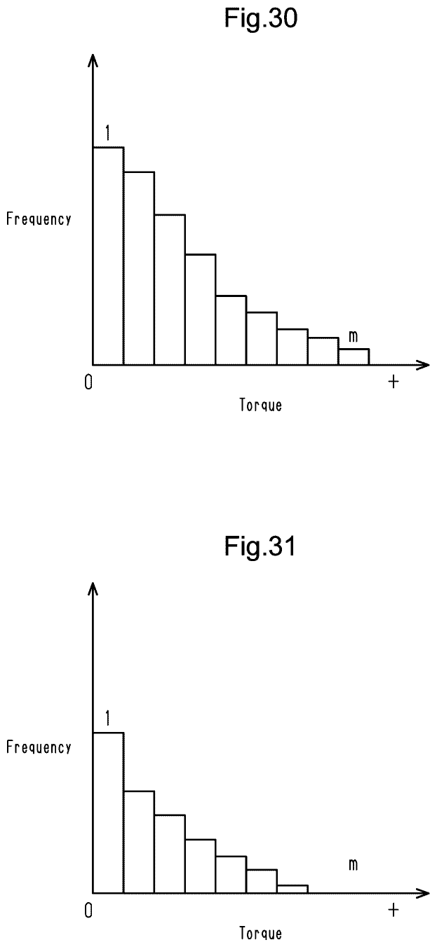

The data center 500 extracts data by dividing the torque input to the planetary carrier 64 into a plurality of sections according to the ATF temperature. Instead of the ATF temperature, the data center 500 may use, as the second feature, the rotational speed of a pump that discharges lubricating oil for lubricating the planetary gear unit 61. The processing circuitry 510 of the data center 500 calculates the frequency distribution of the original data and the extracted data by dividing the torque input to the planetary carrier 64 into a plurality of sections according to the rotational speed of the pump that discharges the lubricating oil that lubricates the planetary gear unit 61. The pump described above is, for example, the second oil pump 76. For example, FIG. 30 shows a frequency distribution of the torque input to the planetary carrier 64 in the original data when the rotational speed of the second oil pump 76 of the vehicle 10 to be analyzed is lower than the predetermined speed. FIG. 31 shows a frequency distribution of the torque input to the planetary carrier 64 in the original data when the rotational speed of the second oil pump 76 of the vehicle 10 to be analyzed is equal to or higher than the predetermined speed. In these frequency distributions, the input torque is divided into m classes of 1 to m with the input torque of zero as the minimum class. The processing circuitry 510 calculates the frequency distribution of the input torque between the original data and the extracted data as shown in FIGS. 30 and 31 for each division of the rotational speed of the second oil pump 76. The data center 500 can extract the extracted data from the original data by using the frequency distribution calculated by being classified according to the rotational speed of the second oil pump 76.

The lubrication state of the planetary gear unit 61 affects the friction acting between the gears of the planetary gear unit 61. When the rotational speed of the second oil pump 76 increases, the supply of the lubricating oil to the planetary gear unit 61 is improved, and the friction between the gears decreases. Therefore, as the rotational speed of the second oil pump 76 increases, accumulation of damage on the planetary gear unit 61 is suppressed. The data center 500 acquires the extracted data by using the two physical quantities affecting the accumulation of damage in the planetary gear unit 61 as the features. Therefore, according to the data center 500, it is possible to extract data suitable for analyzing the degree of damage to the planetary gear unit 61.

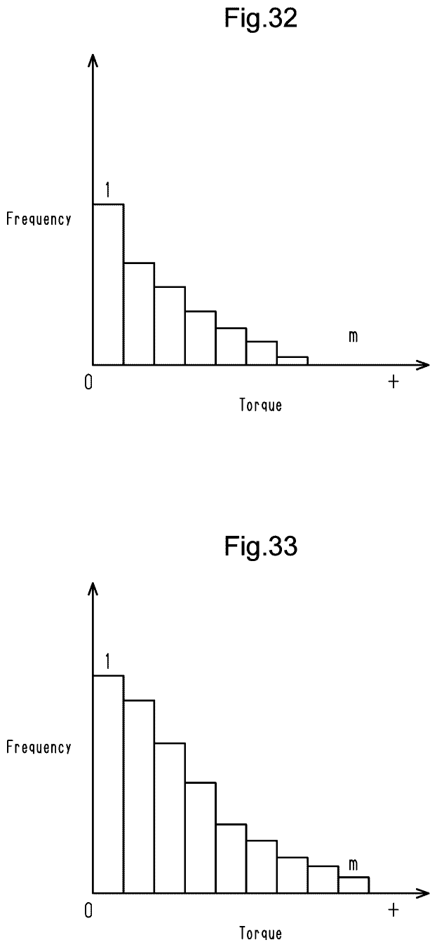

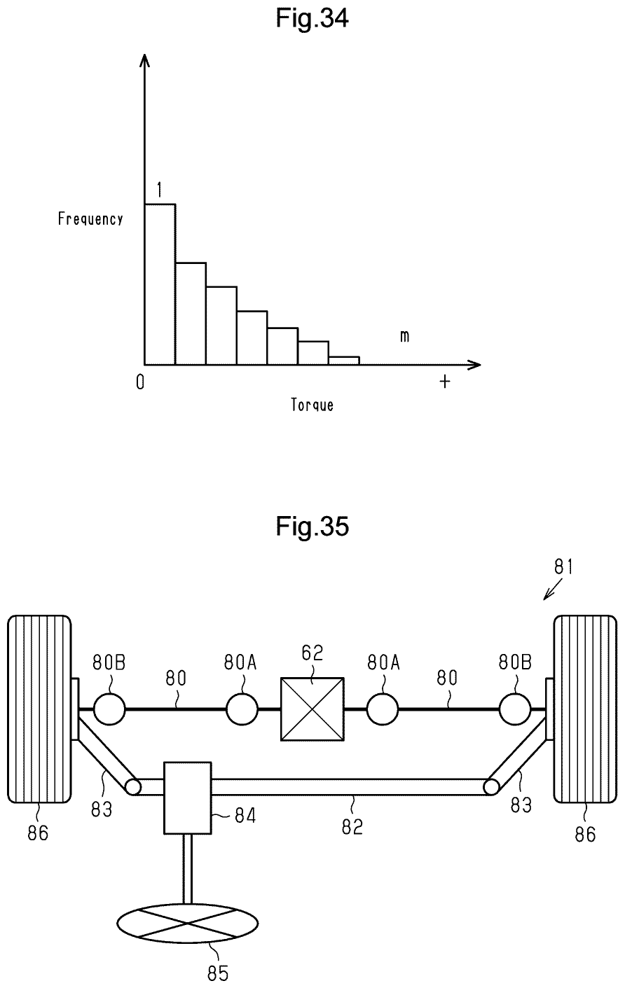

On the other hand, the data center 500 can use the inclination angle of the vehicle 10 as the second feature instead of the ATF temperature. The processing circuitry 510 of the data center 500 divides the torque input to the planetary carrier 64 into a plurality of sections according to the inclination angle of the vehicle 10, and calculates the frequency distribution of the original data and the extracted data. For example, FIG. 32 shows the frequency distribution of the torque input to the planetary carrier 64 in the original data when the inclination angle of the vehicle 10 to be analyzed is positive. When the inclination angle is positive, the vehicle 10 is positioned on an upward slope. FIG. 33 shows the frequency distribution of the torque input to the planetary carrier 64 in the original data when the inclination angle of the vehicle 10 to be analyzed is zero. FIG. 34 shows the frequency distribution of the torque input to the planetary carrier 64 in the original data when the inclination angle of the vehicle 10 to be analyzed is negative. When the inclination angle is negative, the vehicle 10 is positioned on a downward slope. In these frequency distributions, the input torque is divided into m classes of 1 to m with the input torque of zero as the minimum class. The processing circuitry 510 calculates the frequency distribution of the input torque in the original data and the extracted data as shown in FIGS. 32 to 34 for each section of the inclination angle of the vehicle 10. The data center 500 can extract the extracted data from the original data by using the frequency distribution calculated by dividing the data according to the inclination angle of the vehicle 10.

The planetary gear unit 61 wears due to repetition of engagement and collision between the gears, and damage accumulates. As the torque input to the planetary carrier 64 increases, the stress acting between the gears increases, and the damage accumulated by the engagement and collision increases. The lubrication state of the planetary gear unit 61 affects the friction acting between the gears of the planetary gear unit 61. When the vehicle 10 is inclined, the position of the liquid surface of the lubricating oil in the case 63 changes, and the immersed state of the differential ring gear 74 immersed in the lubricating oil changes. Therefore, the inclination of the vehicle 10 changes the lubrication state of the planetary gear unit 61 due to the splashing of the lubricating oil, which affects the damage accumulated in the planetary gear unit 61. The data center 500 acquires the extracted data by using the two physical quantities affecting the accumulation of damage in the planetary gear unit 61 as the features. Therefore, according to the data center 500, it is possible to extract data suitable for analyzing the degree of damage to the planetary gear unit 61.

The data center 500 extracts data by using the torque input to the planetary gear unit 61 as the first feature and the ATF temperature as the second feature. However, the physical quantities used as the first feature and the second feature are not limited to the physical quantities described above. Any physical quantity other than those described above may be used as long as the physical quantity affects the degree of damage to the planetary gear unit 61. For example, a physical quantity reflecting a traveling mode of the vehicle such as a hybrid mode or an EV mode may be used. In the EV mode, the second oil pump 76 that rotates along with the rotation of the engine 21 is stopped, and the supply of the lubricating oil to the planetary gear unit 61 becomes defective. Therefore, during traveling in the EV mode, accumulation of damage to the planetary gear unit 61 increases.

The data center 500 described above analyzes the degree of damage to the planetary gear unit 61 formed by meshing the sun gear 66, the pinion gear 67, and the ring gear 68. However, the gear part of which the degree of damage can be analyzed by the data center 500 is not limited to the planetary gear unit 61. Similarly to the planetary gear unit 61, the present invention can be used to analyze the degree of damage to other gear components and power split devices that are configured by meshing a plurality of gears.

### Fifth Embodiment

Next, a fifth embodiment of the information processing apparatus will be described with reference to FIGS. 35 to 40. The fifth embodiment is an information processor for analyzing the degree of damage to an outer joint 80B of a drive shaft 80 mounted in the vehicle. The fifth embodiment is different from the first embodiment in a device or a component to be analyzed for the degree of damage. In the following description, differences from the first embodiment will be mainly described. Detailed description of the same members as those in the first embodiment will be omitted. Also in the fifth embodiment, the information processing apparatus that analyzes the degree of damage is the processing circuitry 510 of the data center 500.

### Configuration of a Steering Mechanism 81

FIG. 35 is a schematic view showing the steering mechanism 81 of the vehicle 10. The vehicle 10 is a front-wheel drive vehicle in which front wheels serve as both driving wheels and steered wheels. The steering mechanism 81 drives steerable drive wheels 86 by the power of the engine 21 and the motor generator 23 transmitted via the power split mechanism 60. The steering mechanism 81 changes the steering angles of the steerable drive wheels 86 in accordance with the steering wheel angle. The drive shaft 80 transmits power from the power split mechanism 60 to the steerable drive wheels 86. The differential device 62 of the power split mechanism 60 is connected to the left and right drive shafts 80. The left and right drive shafts 80 are provided with inner joints 80A at coupling portions with the differential device 62. Further, outer joints 80B are provided on the left and right drive shafts 80 at the connecting portions with the steerable drive wheels 86. In the vehicle 10, the inner joint 80A is a sliding type constant velocity joint. The outer joint 80B is a fixed type constant velocity joint. On the other hand, the steering angle of the steerable drive wheel 86 is changed by the tie rod 82, the knuckle arm 83, the steering device 84, and the steering 85. The left and right steerable drive wheels 86 are held by the left and right knuckle arms 83, respectively. Since the left and right knuckle arms 83 are connected to each other by the tie rod 82, the left and right steerable drive wheels 86 integrally change the steering angle. The steering device 84 is a device that converts rotation of the steering 85 into movement of the tie rod 82. In this manner, the rotational operation performed on the steering 85 is reflected as a change in the steering angle of the left and right steerable drive wheels 86 via the tie rod 82 and the left and right knuckle arms 83. At this time, a joint angle, which is a connection angle between the steerable drive wheel 86 and the drive shaft 80, is generated in the outer joint 80B in accordance with the steering angle of the steerable drive wheel 86.

The outer joint 80B provided at the coupling portion between the drive shaft 80 and the steerable drive wheel 86 is an example of a fatigue-damaged portion of the drive shaft 80. Fatigue damage to the outer joint 80B occurs, for example, in the outer layer of the ball groove of the outer joint 80B.

When the vehicle 10 travels, torque output from the engine 21 and the motor generator 23 is input to the drive shaft 80 via the power split mechanism 60. The torque input to the drive shaft 80 is transmitted to the steerable drive wheel 86 by the outer joint 80B. Due to this input torque, stresses are generated in the outer joint 80B, and the outer joint 80B is fatigue-damaged by the load caused by these stresses. Further, the magnitude of the load due to stress that is generated in the outer joint 80B by the input torque is affected by the joint angle of the outer joint 80B.

### Data Extraction

The information processing terminal 600 transmits an instruction to analyze the degree of damage to the drive shaft 80 to the data center 500. Then, similarly to the first embodiment, the data center 500 performs a process of cutting out data from the original data using a plurality of time windows.

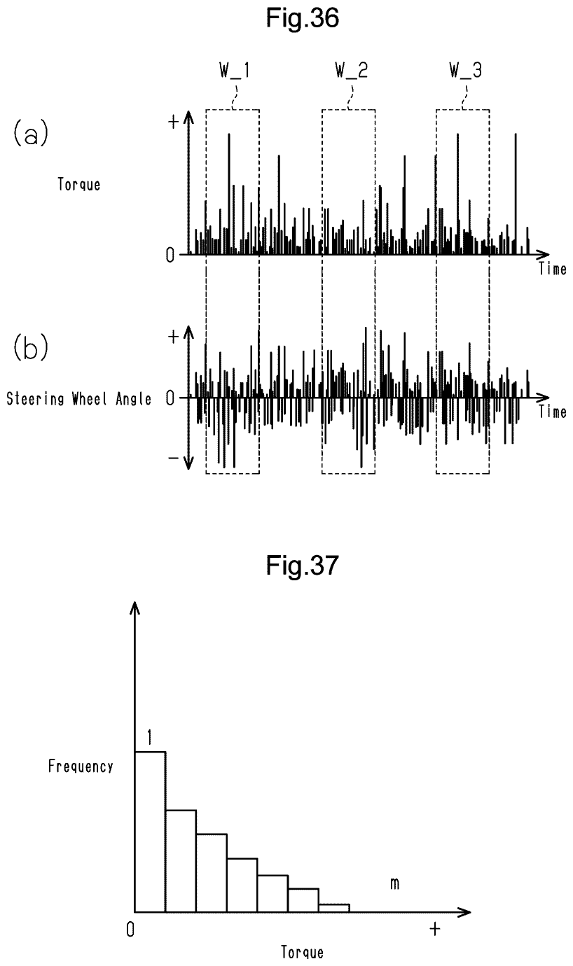

FIG. 36 shows original data of a feature related to the drive shaft 80 of the specific vehicle 10. The original data shown in FIG. 36 is part of data for 100,000 hours in the vehicle 10 to be analyzed. The original data shown in FIG. 36 includes the torque input to the drive shaft 80 and the steering wheel angle as features. The feature is a physical amount correlated with the damage to the drive shaft 80. Section (a) of FIG. 36 shows the torque input to the drive shaft 80. Section (b) of FIG. 36 shows the steering wheel angle. Regarding the steering wheel angle, the angle in the right direction toward the front of the vehicle 10 is positive, and the angle in the left direction is negative. The data center 500 finds a segmentation pattern for extracting extracted data that captures the features of the entire original data including the above-described feature. The processing circuitry 510 analyzes the damage accumulated in the drive shaft 80 of the vehicle 10 to be analyzed using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the drive shaft 80 of the vehicle 10 to be analyzed.

Next, in the process of step S110, the processing circuitry 510 sets a plurality of time windows for the original feature relating to the damage to the drive shaft 80 shown in FIG. 36 and determines a segmentation pattern, as in the first embodiment. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

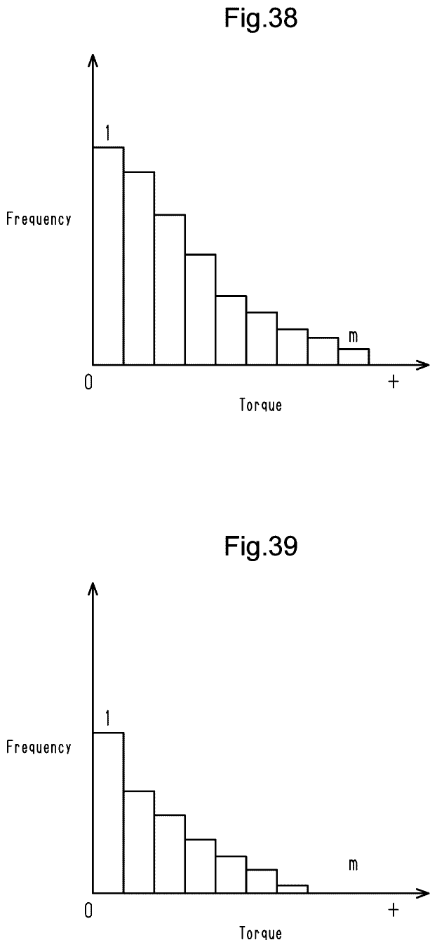

In the process of step S130, the processing circuitry 510 calculates a frequency distribution of the feature related to the damage to the drive shaft 80. In the analysis of the degree of damage to the drive shaft 80, the first feature is the torque input to the drive shaft 80. The second feature is a steering wheel angle. The processing circuitry 510 divides the torque input to the drive shaft 80 into a plurality of sections according to the steering wheel angle, and calculates the frequency distribution of the original data and the extracted data obtained by combining all the data segmented by the plurality of time windows, as in the first embodiment. FIG. 37 shows the frequency distribution of the torque input to the drive shaft 80 in the original data when the steering wheel angle of the steering wheel of the vehicle 10 to be analyzed is greater than or equal to the predetermined angle to the right. FIG. 38 shows the frequency distribution of the torque input to the drive shaft 80 in the original data when the steering wheel angle of the vehicle 10 to be analyzed is less than the predetermined angle to the right and left. FIG. 39 shows the frequency distribution of the torque input to the drive shaft 80 in the original data when the steering wheel angle of the vehicle 10 to be analyzed is greater than or equal to the predetermined angle to the left. As shown in FIGS. 37 to 39, in these frequency distributions, the input torque is divided into m classes of 1 to m with the input torque of zero as the minimum class. The frequency distribution of the extracted data is also calculated based on the class divisions corresponding to those of the original data. In the case of this example, the processing circuitry 510 divides the torque input to the drive shaft 80 included in the original data and the extracted data into three. There are three sections: a section in which the steering wheel angle is greater than or equal to a predetermined angle to the right; a section in which the steering wheel angle is less than a predetermined angle to the right and left; and a section in which the steering wheel angle is greater than or equal to a predetermined angle to the left. The processing circuitry 510 calculates the frequency distribution as described above for each of the three sections of the steering wheel angle.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 37 to 39, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Fatigue Damage Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the fifth embodiment, similarly to the first embodiment, the fatigue damage level is calculated as an index value indicating the degree of damage accumulated in the drive shaft 80 based on the extracted data. The fatigue damage level is individually calculated for each of the right and left drive shafts.

In the drive shaft 80, the 80B of the outer joint wears due to running, and damage accumulates. As the torque input to the drive shaft 80 increases, the stress acting on the joint portion increases, and the damage accumulated in the drive shaft 80 increases. As the steering wheel angle increases, the magnitude of the force acting on the outer joint 80B increases, and the damage accumulated in the drive shaft 80 increases.

As an example, the processing circuitry 510 calculates the fatigue damage level of the drive shaft 80 by the following method.

The processing circuitry 510 calculates the frequency distribution for each division based on the data obtained by dividing the torque input to the drive shaft 80 by the steering wheel angle at that time. For the data of the section other than the section in which the steering wheel angle is less than the predetermined angle to the right and left among the plurality of calculated sections, the data of the torque input to the drive shaft 80 included in the section is corrected in accordance with the section of the steering wheel angle. The correction may be performed by any method capable of reflecting a change in load due to the joint angle in consideration of the joint angle of the outer joint 80B. As an example, when the corrected input torque Tc is calculated by defining a mathematical equation incorporating the joint angle of the outer joint 80B, the subsequent processing is as follows.

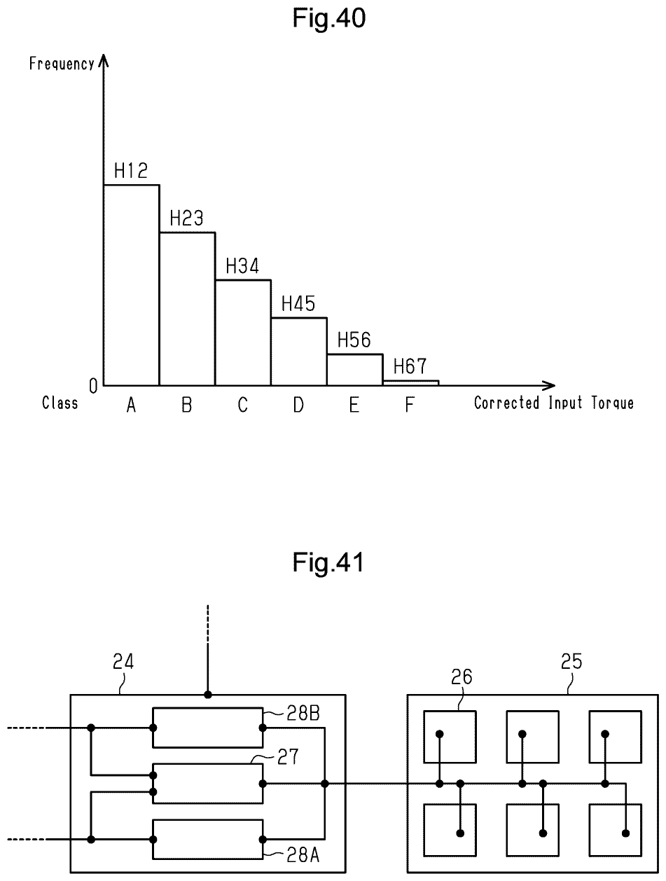

Based on the corrected input torque Tc obtained by using the formula as described above, the processing circuitry 510 aggregates the frequency distributions of all the sections into the frequency distributions of the sections in which the steering wheel angle is less than the predetermined angle to the right and left, and calculates a corrected frequency distribution which is a new frequency distribution in the extracted data. Next, the processing circuitry 510 calculates the fatigue damage level based on the corrected frequency distribution. FIG. 40 shows an example of the corrected frequency distribution in the analysis of the degree of damage to the drive shaft 80. In this correction frequency distribution, the corrected input torque Tc is classified into six classes A to F. The frequency Hij of each class indicates the number of data in which the input torque Tc after correction is greater than or equal to Ti and less than Tj. For example, in the class B, the corrected input torque Tc is classified as T2 or more and less than T3, and the frequency thereof is expressed as H23. An upper limit frequency Gij is set for each class. The upper limit frequency Gij indicates an upper limit damage accumulation frequency at which the outer joint 80B of the drive shaft 80 is fatigue-fractured when the damage due to the corrected input torque Tc included in the corresponding class is accumulated. As an example, in a case where G34 is L times, when a torque such that the corrected input torque Tc is included in the range of T3 or more and less than T4 is input to the drive shaft 80 L times, the outer joint 80B is fatigue-fractured. Similarly to the first embodiment, the processing circuitry 510 calculates the fatigue damage level according to Equation 3 using the frequency Hij for each class and the upper limit frequency Gij for each class in the corrected frequency distribution. After calculating the fatigue damage level, the processing circuitry 510 advances the process to step S170 illustrated in FIG. 4.

The processing circuitry 510 performs the same processing as in the first embodiment for the process of the subsequent steps S170 to S190.

### Operation of Fifth Embodiment

The data center 500 which is the information processing apparatus of the fifth embodiment extracts part of data from original data collected over a specified period using a plurality of sensors mounted on the vehicle 10, and analyzes the degree of damage accumulated in the drive shaft 80.

The data center 500 includes a processing circuitry 510 that executes processing in accordance with a program. The original data includes the torque input to the drive shaft 80 mounted on the vehicle 10 as the first feature. The original data includes the steering wheel angle of the vehicle 10 as the second feature. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the fatigue damage level as the index value of the damage by using the extracted data in which the errors are less than or equal to the thresholds (step S160).

According to the data center 500, the analysis can be performed using the extracted data in which the distribution of the feature related to the damage to the drive shaft 80 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of Fifth Embodiment

The fifth embodiment has the following advantages in addition to the advantages (1-1) to (1-5) of the first embodiment.

(5-1) The data center 500 analyzes the degree of damage to the drive shaft 80, and the processing circuitry 510 of the data center 500 sets the torque input to the drive shaft 80 as the first feature and the steering wheel angle as the second feature.

In the drive shaft 80, the 80B of the outer joint wears due to running, and damage accumulates. As the torque input to the drive shaft 80 increases, the stress acting on the joint portion increases, and the damage accumulated in the drive shaft 80 increases. As the steering wheel angle increases, the magnitude of the force acting on the outer joint 80B increases, and the damage accumulated in the drive shaft 80 increases. The data center 500 acquires the extracted data by using the two physical quantities affecting the damage accumulated in the drive shaft 80 as the features. Therefore, according to the data center 500, it is possible to extract data suitable for analyzing the degree of damage to the drive shaft 80.

### Modifications of Fifth Embodiment

The above-described fifth embodiment may be modified as follows. The fifth embodiment and the following modifications of the fifth embodiment can be implemented in combination with each other as long as there is no technical contradiction.

The data center 500 extracts data by using the torque input to the drive shaft 80 as the first feature and the steering wheel angle of the vehicle 10 as the second feature. However, the physical quantities used as the first feature and the second feature are not limited to the physical quantities described above. Any physical quantity such as the rotational speed of the drive shaft 80, the vertical acceleration of the vehicle 10, the road surface information based on the position information of the vehicle 10, and the climate information may be used as long as the physical quantity affects the degree of damage to the drive shaft 80. For example, as the rotational speed of the drive shaft 80 increases, the damage accumulated in the outer joint 80B for a certain period of time increases. For example, as the vertical acceleration of the vehicle 10 increases, the damage accumulated in the outer joint 80B due to the load caused by the vertical swing of the vehicle 10 increases.

The device or component to which the above-described analysis method can be applied is not limited to the drive shaft 80 of the steerable drive wheel described in the fifth embodiment, which is mainly used for changing the direction of the vehicle. The four wheel steering can also be used to analyze the degree of damage to an auxiliary steerable drive wheel that is a drive wheel used to change the direction of the vehicle in an auxiliary manner. The auxiliary steered driving wheels mainly correspond to driving wheels other than the front wheels of the vehicle 10. For example, the auxiliary steerable drive wheel is a rear wheel of a rear-wheel drive vehicle or a rear wheel of a four wheel drive vehicle. The auxiliary steerable drive wheel changes the steering angle of the wheel slightly within a range smaller than that of the steering wheel or the steerable drive wheel in accordance with the steering wheel angle. In one example, the assistive steerable drive wheel produces a steering angle in an opposite direction to the steering wheel or steerable drive wheel at vehicle speeds below a predetermined speed. At a vehicle speed equal to or higher than the predetermined speed, the auxiliary steerable drive wheel generates a steering angle in the same direction as the steering wheel or the steerable drive wheel. The data center 500 can analyze the damage accumulated in the drive shaft 80 of the auxiliary steerable drive wheel as described above.

### Sixth Embodiment

Next, a sixth embodiment of the information processing apparatus will be described with reference to FIGS. 41 to 52. The sixth embodiment is an information processing apparatus that analyzes the degree of damage to a battery 25 mounted in a vehicle. The sixth embodiment is different from the first embodiment in a device or a component to be analyzed for the degree of damage. In the following description, differences from the first embodiment will be mainly described. Detailed description of the same members as those in the first embodiment will be omitted. Also in the sixth embodiment, the information processing apparatus that analyzes the degree of damage is the processing circuitry 510 of the data center 500.

### Configuration of Battery 25 and PCU 24

As described with reference to FIG. 1, the vehicle 10 includes the battery 25 and the PCU 24. As shown in FIG. 41, the battery 25 is an assembled battery including a plurality of cells 26. Each cell 26 is a minimum constituent unit of the battery 25 that functions as a storage battery. The battery 25 shown in FIG. 41 includes six cells 26. The battery 25 is, for example, a lithium ion battery. The battery 25 is connected to the PCU 24. The PCU 24 includes a converter 27, a first inverter 28A and a second inverter 28B. The first and second inverters 28A and 28B convert electric power supplied from the battery 25 to the motor generator 23. The first inverter 28A converts a direct current supplied from the battery 25 into an appropriate alternating current and supplies the alternating current to the first motor generator 23A. The second inverter 28B converts a direct current supplied from the battery 25 into an appropriate alternating current and supplies the alternating current to the second motor generator 23B. On the other hand, the converter 27 converts electric power supplied from the motor generator 23 to the battery 25. The converter 27 converts an alternating current generated by the motor generator 23 into a direct current that can be stored in the battery 25.

For example, the battery 25 discharges when electric power is supplied from the battery 25 to rotate the motor generator 23, which is an electric motor. The battery 25 is charged with electric power supplied from the motor generator 23 when the motor generator 23 regenerates electric power as a generator. By repeating such charging and discharging, the battery 25 is deteriorated and damages are accumulated. The damage accumulated in the battery 25 is affected by the battery temperature and the state of charge (SOC) indicating the state of charge of the battery 25. For example, when the battery temperature is equal to or higher than a certain temperature, the deterioration of the battery 25 progresses as the battery temperature increases. For example, the deterioration of the battery 25 is likely to progress in a state where the SOC is less than or equal to a certain value. For example, deterioration of the battery 25 is likely to progress in a state where the SOC is greater than or equal to a certain value. In order to suppress the progress of such deterioration, the second control device 92 shown in FIG. 1 can limit charging and discharging of the battery 25 by controlling the PCU 24. When the battery 25 is charged and discharged with high electric power, deterioration progresses. In order to suppress such deterioration, the second control device 92 can limit the electric power when the battery 25 is charged and discharged. A numerical value for setting the upper limit of the amount of current when the battery 25 is charged is the charging power upper limit value Win. The discharging power upper limit value Wout is a numerical value for setting the upper limit of the amount of current when the battery 25 is discharged. For example, the second control device 92 can set the charging power upper limit value Win and the discharging power upper limit value Wout in accordance with the battery temperature and the SOC. The second control device 92 can also set the charging power upper limit value Win and the discharging power upper limit value Wout in accordance with deterioration of the battery 25. The second control device 92 may set the values of the charging power upper limit value Win and the discharging power upper limit value Wout to be smaller as the damage accumulated in the battery 25 is larger. In such a case, the charging power upper limit value Win and the discharging power upper limit value Wout reflect the damage accumulated in the battery 25.

### Data Extraction

The information processing terminal 600 transmits, to the data center 500, an instruction to analyze the degree of damage to the battery 25 that supplies and receives electric power to and from the first motor generator 23A that is a motor. Then, similarly to the first embodiment, the data center 500 performs a process of cutting out data from the original data using a plurality of time windows.

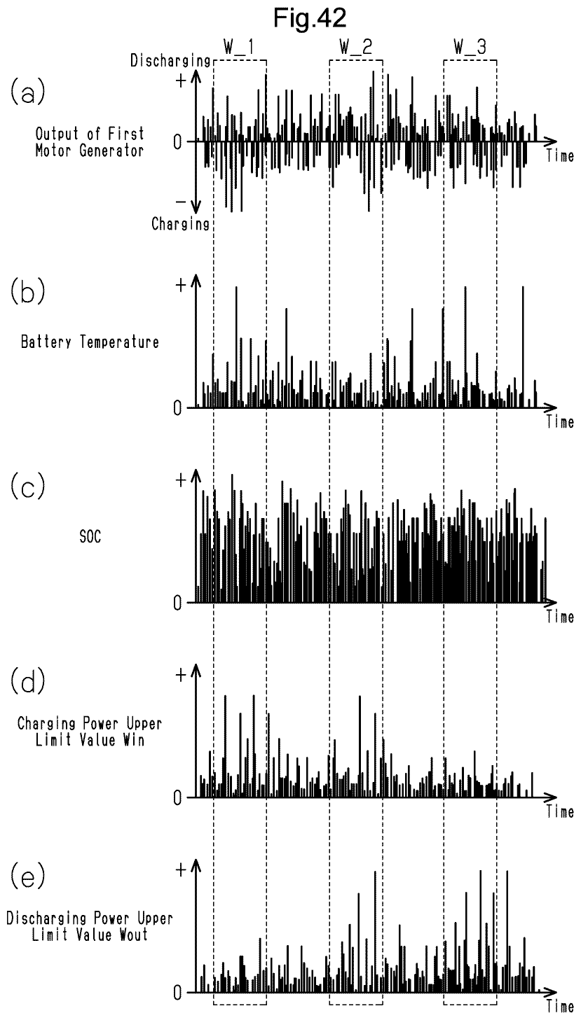

FIG. 42 shows the original data of the feature related to the battery 25 of the specific vehicle 10. The original data shown in FIG. 42 is part of data for 100,000 hours in the vehicle 10 to be analyzed. The original data shown in FIG. 42 includes, as features, the output of the first motor generator 23A, the temperature of the battery 25, the SOC of the battery 25, the charging power upper limit value Win of the battery 25, and the discharging power upper limit value Wout of the battery 25. The feature is a physical amount correlated with the damage to the battery 25. Section (a) of FIG. 42 shows the output of the first motor generator 23A. Section (b) of FIG. 42 shows the temperature of the battery 25. Section (c) of FIG. 42 shows the SOC of the battery 25. Section (d) of FIG. 42 shows the charging power upper limit value Win of the battery 25. Section (e) of FIG. 42 shows the discharging power upper limit value Wout of the battery 25. The data center 500 finds a segmentation pattern for extracting extracted data that captures the features of the entire original data including the above-described feature. The processing circuitry 510 analyzes the damage accumulated in the battery 25 of the vehicle 10 to be analyzed by using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the battery 25 of the vehicle 10 to be analyzed.

Next, in the process of step S110, the processing circuitry 510 sets a plurality of time windows as in the first embodiment, and determines a segmentation pattern. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

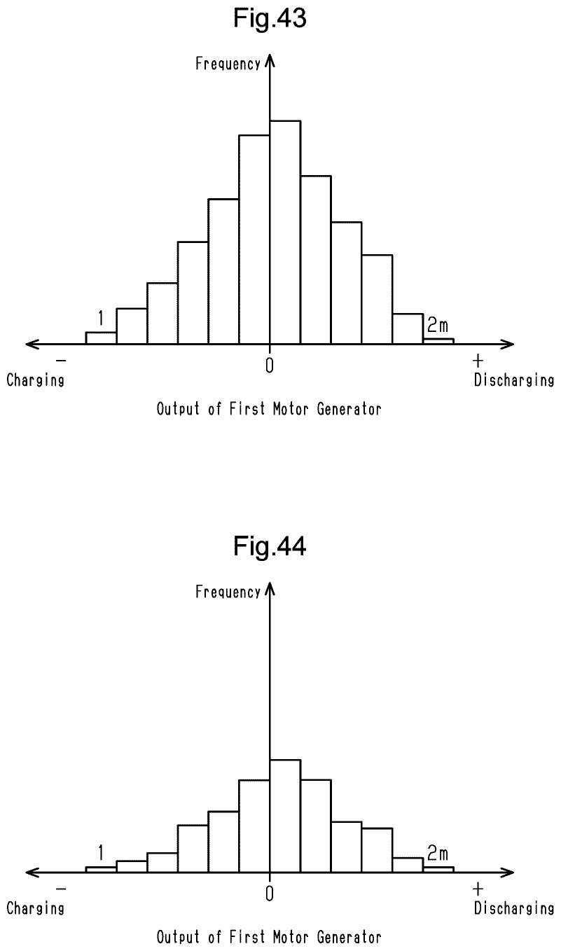

In the process of step S130, the processing circuitry 510 calculates the frequency distributions of the features related to the damage to the battery 25. In the analysis of the degree of damage to the battery 25, the first feature is the output of the first motor generator 23A. The second feature is the temperature of the battery 25. The temperature of the battery 25 may be, for example, an average value of the temperatures of the six cells 26 constituting the battery 25. The processing circuitry 510 divides the output of the first motor generator 23A into a plurality of outputs according to the temperature of the battery 25, and calculates the frequency distributions of the original data and the extracted data obtained by combining all the datasets segmented by the plurality of time windows, as in the first embodiment. FIG. 43 shows a frequency distribution of the output of the first motor generator 23A in the original data when the temperature of the battery 25 in the vehicle 10 to be analyzed is lower than the predetermined temperature. FIG. 44 shows a frequency distribution of the output of the first motor generator 23A when the temperature of the battery 25 in the vehicle 10 to be analyzed is equal to or higher than the predetermined temperature. As shown in FIGS. 43 and 44, in these frequency distributions, the classes are divided such that the number of classes in the positive direction and the number of classes in the negative direction are equal to each other with the output zero as the center. The range in which the output is positive is a state in which the first motor generator 23A operates as a traction motor and the battery 25 is discharging. When the output is in a negative range, the first motor generator 23A operates as a power generator and the battery 25 is charged. In the example shown in FIGS. 43 and 44, the range in which the output is positive and the range in which the output is negative are each divided into m classes. In this example, the outputs are classified into 2m classes from 1 to 2m, with the class having the smallest value of the outputs being 1. The frequency distribution of the extracted data is also calculated based on the class divisions corresponding to those of the original data. In the case of this example, the processing circuitry 510 divides the output of the first motor generator 23A included in the original data and the extracted data into two sections of a section in which the temperature of the battery 25 is lower than a predetermined temperature and a section in which the temperature of the battery 25 is equal to or higher than the predetermined temperature. The processing circuitry 510 calculates the frequency distribution as described above for each of the two battery temperature sections.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 43 and 44, n is 2m. Similarly, i is an index ranging from 1 to 2m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Deterioration Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the sixth embodiment, the deterioration level is calculated as an index value indicating the degree of damage accumulated in the battery 25 based on the extracted data. For example, the deterioration level can be defined as a value from 0 to 1 indicating the ratio of deterioration accumulated in the battery 25, with the deterioration level leading to the occurrence of a problem related to the battery 25 being 1. The deterioration of the battery is, for example, deterioration of an active material inside the battery or an increase in internal resistance of the battery. Due to such deterioration, the battery causes problems such as a decrease in charge capacity and discharge capacity.

The battery 25 deteriorates due to repetition of charging and discharging, and damage accumulates. The larger the output of the first motor generator 23A supplied with electric power from the battery 25 is, the larger the discharge from the battery 25 is. The larger the output of the first motor generator 23A that supplies electric power to the battery 25 is, the larger the charge to the battery 25 is. The larger the charge to the battery 25 and the discharge from the battery 25 are, the more easily the deterioration of the battery 25 progresses. The higher the temperature of the battery 25 is, the more easily the deterioration of the battery 25 progresses.

As an example, the processing circuitry 510 calculates the deterioration level of the battery 25 by the following method.

The processing circuitry 510 calculates a frequency distribution for each division based on the outputs of the first motor generator 23A divided by the temperature of the battery 25 at that time. One of the plurality of calculated sections is determined as a reference section. Next, with respect to the data of the section other than the reference section, the data of the output included in the section is corrected according to the section of the temperature. This correction can use any method that can reflect the change in the speed of the deterioration reaction of the battery 25 due to the temperature in consideration of the temperature of the battery 25. As an example, when the corrected output Pc is calculated by defining a mathematical equation in which the temperature of the battery 25 is incorporated, the subsequent processing is as follows.

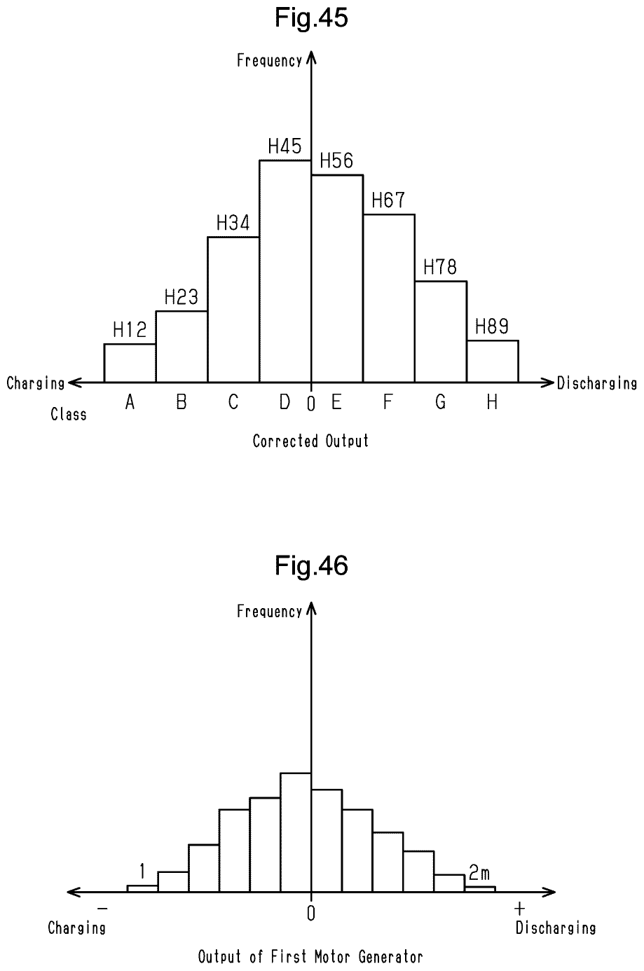

On the basis of the corrected output Pc obtained by using the formula as described above, the processing circuitry 510 aggregates the frequency distributions of all the sections into one frequency distribution determined as a reference section, and calculates a corrected frequency distribution which is a new frequency distribution in the extracted data. Next, the processing circuitry 510 calculates the deterioration level based on the corrected frequency distribution. FIG. 45 shows an example of the corrected frequency distribution in the analysis of the degree of damage to the battery 25. In this correction frequency distribution, the corrected outputs Pc are classified into eight classes A to H. The classes A to D classify the corrected outputs Pc when the first motor generator 23A operates as a power generator into four classes. The classes E to H classify the corrected outputs Pc into four classes when the first motor generator 23A operates as the traveling motor. The frequency Hij of each class indicates the number of data in which the value of the output Pc after correction is greater than or equal to Pi and less than Pj. For example, in the class B, the values of the corrected outputs Pc greater than or equal to P2 and less than P3 are classified, and the frequency thereof is expressed as H23. An upper limit frequency Gij is set for each class. The upper limit frequency Gij indicates an upper limit damage accumulation frequency at which a failure due to deterioration occurs in the battery 25 when the damage due to the corrected output Pc included in the corresponding class is accumulated. As an example, in a case where G34 is L times, when the corrected power Pc is generated L times so as to be included in the range greater than or equal to the P3 and less than the P4, a malfunction due to deterioration occurs in the battery 25. Similarly to the third embodiment, the processing circuitry 510 calculates the deterioration level according to the following Equation 6 by using the frequency Hij for each class and the upper limit frequency Gij for each class in the corrected frequency distribution.

$$Deterioration Level = \frac{{H}_{12}}{{G}_{12}} + \frac{{H}_{23}}{{G}_{23}} + … + \frac{{H}_{78}}{{G}_{78}} + \frac{{H}_{89}}{{G}_{89}} \qquad Equation 6$$

Upon calculating the deterioration level, the processing circuitry 510 advances the process to step S170 illustrated in FIG. 4.

The processing circuitry 510 performs the same processing as in the first embodiment for the process of the subsequent steps S170 to S190.

### Operation of Sixth Embodiment

The data center 500 which is the information processing apparatus of the sixth embodiment extracts part of data from original data collected over a specified period using a plurality of sensors mounted on the vehicle 10, and analyzes the degree of damage accumulated in the battery 25.

The data center 500 includes a processing circuitry 510 that executes processing in accordance with a program. The output of the first motor generator 23A, which is a motor mounted in the vehicle 10, is included as the first feature. The original data includes the temperature of the battery 25 as the second feature. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the deterioration level as the index value of the damage by using the extracted data in which the errors are less than or equal to the thresholds (step S160).

According to the data center 500, the analysis can be performed using the extracted data in which the distribution of the feature related to the damage to the battery 25 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of Sixth Embodiment

The sixth embodiment has the following advantages in addition to the advantages (1-1) to (1-5) of the first embodiment.

(6-1) The data center 500 analyzes the degree of damage to the battery 25 that supplies and receives electric power to and from the first motor generator 23A that is a motor. The processing circuitry 510 of the data center 500 sets the output of the first motor generator 23A as a first feature and the temperature of the battery 25 as a second feature.

The battery 25 deteriorates due to repetition of charging and discharging, and damage accumulates. The larger the output of the first motor generator 23A, which is a motor supplied with electric power from the battery 25, the larger the discharge from the battery 25. The larger the output of the first motor generator 23A that supplies electric power to the battery 25 is, the larger the charge to the battery 25 is. The larger the charge to the battery 25 and the discharge from the battery 25 are, the more easily the deterioration of the battery 25 progresses. The higher the temperature of the battery 25 is, the more easily the deterioration of the battery 25 progresses. The data center 500 acquires the extracted data by using the two physical quantities that affect the magnitude of the damage accumulated in the battery 25 as the features. Therefore, according to the data center 500, it is possible to extract data suitable for analyzing the degree of damage to the battery 25.

### Modification of Sixth Embodiment

The sixth embodiment may be modified as described below. The sixth embodiment and the following modifications of the sixth embodiment can be implemented in combination with each other as long as there is no technical contradiction.

The data center 500 described above uses the average value of the temperatures of the six cells 26 constituting the battery 25 as the temperature of the battery 25. The temperature used by the data center 500 as the temperature of the battery 25 is not limited to the average value of the temperatures of the six cells 26. The temperature of the cell 26 indicating the highest temperature among the temperatures of the six cells 26 can be used as the temperature of the battery 25. The temperature of the cell 26 indicating the lowest temperature among the temperatures of the six cells 26 can be used as the temperature of the battery 25. In addition to the above, the temperature of each cell 26 may be weighted in consideration of the influence of each cell 26 on the temperature of the entire battery 25. For example, the average value can be calculated by weighting so that the temperature of the cell 26 located near the center of the battery 25 is likely to be reflected in the average value of the temperatures of the six cells 26.

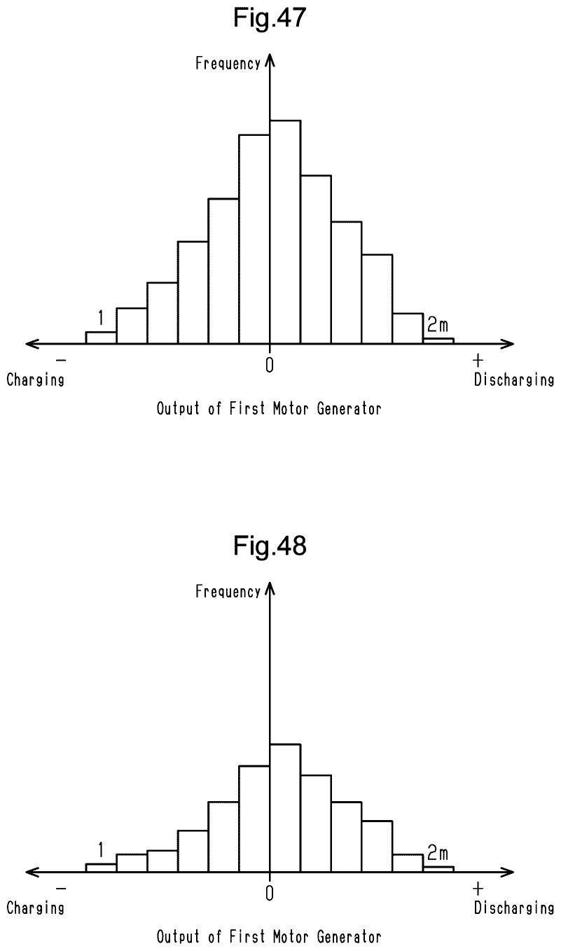

The above-described data center 500 divides the output of the first motor generator 23A into a plurality of outputs according to the temperature of the battery 25. The data center 500 can use the SOC of the battery 25 as the second feature instead of the temperature of the battery 25. The processing circuitry 510 of the data center 500 divides the output of the first motor generator 23A into a plurality of outputs according to the SOC of the battery 25, and calculates the frequency distributions of the original data and the extracted data. For example, FIG. 46 shows a frequency distribution of the output of the first motor generator 23A in the original data when the SOC of the battery 25 in the vehicle 10 to be analyzed is less than the first predetermined value. FIG. 47 shows a frequency distribution of the output of the first motor generator 23A in the original data when the SOC of the battery 25 in the vehicle 10 to be analyzed is equal to or more than the first predetermined value and less than the second predetermined value. FIG. 48 shows a frequency distribution of the output of the first motor generator 23A in the original data when the SOC of the battery 25 in the vehicle 10 to be analyzed is equal to or higher than the second predetermined value. The first predetermined value is set as a value smaller than the second predetermined value. In these frequency distributions, the classes are divided so that the number of classes in the positive direction and the number of classes in the negative direction are equal to each other with the output zero as the center. The range in which the output is positive is a state in which the first motor generator 23A operates as a traction motor and the battery 25 is discharging. When the output is in a negative range, the first motor generator 23A operates as a power generator and the battery 25 is charged. In the examples shown in FIGS. 46 to 48, the range in which the output is positive and the range in which the output is negative are each divided into m classes. In this example, the outputs are classified into 2m classes from 1 to 2m, with the class having the smallest value of the outputs being 1. The processing circuitry 510 calculates the frequency distribution of the output in the original data and the extracted data as illustrated in FIGS. 46 to 48 for each classification of the SOC of the battery 25. The data center 500 may extract the extracted data from the original data using the frequency distribution calculated by dividing the frequency distribution according to the SOC of the battery 25.

The battery 25 deteriorates due to repetition of charging and discharging, and damage accumulates. The larger the output of the first motor generator 23A, which is a motor supplied with electric power from the battery 25, the larger the discharge from the battery 25. The larger the output of the first motor generator 23A that supplies electric power to the battery 25 is, the larger the charge to the battery 25 is. The larger the charge to the battery 25 and the discharge from the battery 25 are, the more easily the deterioration of the battery 25 progresses. The deterioration of the battery 25 is affected by the magnitude of the SOC representing the state of charge of the battery 25. The data center 500 acquires the extracted data by using the two physical quantities that affect the magnitude of the damage accumulated in the battery 25 as the features. Therefore, according to the data center 500, it is possible to extract data suitable for analyzing the degree of damage to the battery 25.

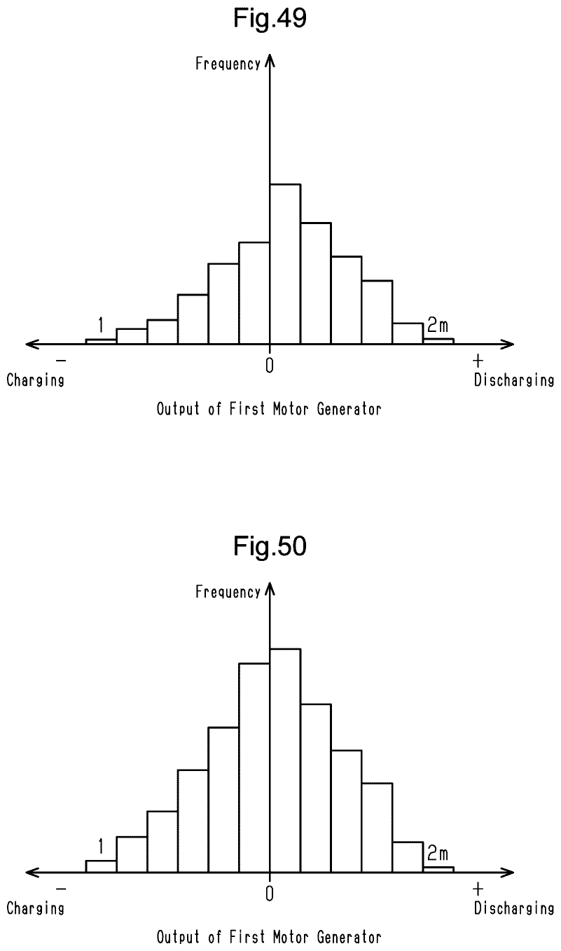

The data center 500 can use the charging power upper limit value Win of the battery 25 as the second feature instead of the temperature of the battery 25. The processing circuitry 510 of the data center 500 divides the output of the first motor generator 23A into a plurality of outputs according to the charging power upper limit value Win of the battery 25, and calculates the frequency distributions of the original data and the extracted data. For example, FIG. 49 shows a frequency distribution of the output of the first motor generator 23A in the original data when the charging power upper limit value Win of the battery 25 in the vehicle 10 to be analyzed is less than the predetermined value. FIG. 50 shows a frequency distribution of the output of the first motor generator 23A in the original data when the charging power upper limit value Win of the battery 25 in the vehicle 10 to be analyzed is greater than or equal to the predetermined value. In these frequency distributions, the classes are divided so that the number of classes in the positive direction and the number of classes in the negative direction are equal to each other with the output zero as the center. The range in which the output is positive is a state in which the first motor generator 23A operates as a traction motor and the battery 25 is discharging. When the output is in a negative range, the first motor generator 23A operates as a power generator and the battery 25 is charged. In the example shown in FIGS. 49 and 50, the range in which the output is positive and the range in which the output is negative are each divided into m classes. In this example, the outputs are classified into 2m classes from 1 to 2m, with the class having the smallest value of the outputs being 1. The processing circuitry 510 calculates the frequency distribution of the output in the original data and the extracted data as shown in FIGS. 49 and 50 for each classification of the charging power upper limit value Win of the battery 25. The data center 500 can extract the extracted data from the original data by using the frequency distribution calculated by dividing the data by the charging power upper limit value Win of the battery 25.

The battery 25 deteriorates due to repetition of charging and discharging, and damage accumulates. The larger the output of the first motor generator 23A, which is a motor supplied with electric power from the battery 25, the larger the discharge from the battery 25. The larger the output of the first motor generator 23A that supplies electric power to the battery 25 is, the larger the charge to the battery 25 is. The larger the charge to the battery 25 and the discharge from the battery 25 are, the more easily the deterioration of the battery 25 progresses. The charging power upper limit value Win is a value set in accordance with the temperature and the SOC of the battery 25. The charging power upper limit value Win is changed so as to suppress deterioration of the battery 25 in accordance with the damage accumulated in the battery 25. Therefore, the deterioration of the battery 25 is affected by the magnitude of the charging power upper limit value Win. The data center 500 acquires the extracted data by using the two physical quantities that affect the magnitude of the damage accumulated in the battery 25 as the features. Therefore, according to the data center 500, it is possible to extract data suitable for analyzing the degree of damage to the battery 25.

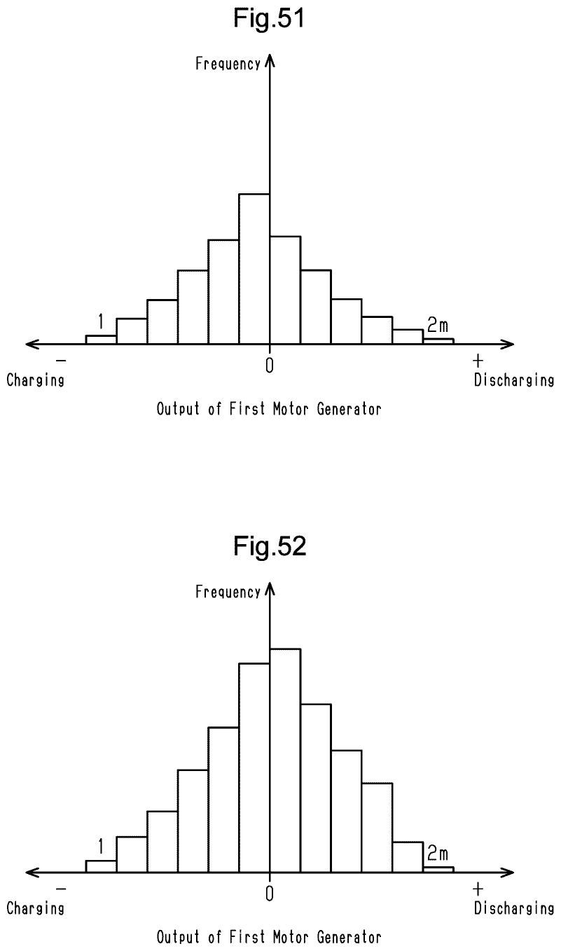

The data center 500 can use the discharging power upper limit value Wout of the battery 25 instead of the temperature of the battery 25 as the second feature. The processing circuitry 510 of the data center 500 divides the output of the first motor generator 23A into a plurality of outputs according to the discharging power upper limit value Wout of the battery 25, and calculates the frequency distributions of the original data and the extracted data. For example, FIG. 51 shows a frequency distribution of the output of the first motor generator 23A in the original data when the discharging power upper limit value Wout of the battery 25 in the vehicle 10 to be analyzed is less than the predetermined value. FIG. 52 shows a frequency distribution of the output of the first motor generator 23A in the original data when the discharging power upper limit value Wout of the battery 25 in the vehicle 10 to be analyzed is greater than or equal to a predetermined value. In these frequency distributions, the classes are divided so that the number of classes in the positive direction and the number of classes in the negative direction are equal to each other with the output zero as the center. The range in which the output is positive is a state in which the first motor generator 23A operates as a traction motor and the battery 25 is discharging. When the output is in a negative range, the first motor generator 23A operates as a power generator and the battery 25 is charged. In the example shown in FIGS. 51 and 52, the range in which the output is positive and the range in which the output is negative are each divided into m classes. In this example, the outputs are classified into 2m classes from 1 to 2m, with the class having the smallest value of the outputs being 1. The processing circuitry 510 calculates the frequency distribution of the output between the original data and the extracted data as shown in FIGS. 51 and 52 for each category of the discharging power upper limit value Wout of the battery 25. The data center 500 can extract the extracted data from the original data by using the frequency distribution calculated by dividing by the discharging power upper limit value Wout of the battery 25.

The battery 25 deteriorates due to repetition of charging and discharging, and damage accumulates. The larger the output of the first motor generator 23A, which is a motor supplied with electric power from the battery 25, the larger the discharge from the battery 25. The larger the output of the first motor generator 23A that supplies electric power to the battery 25 is, the larger the charge to the battery 25 is. The larger the charge to the battery 25 and the discharge from the battery 25 are, the more easily the deterioration of the battery 25 progresses. The discharging power upper limit value Wout is a value set in accordance with the temperature and the SOC of the battery 25. The discharging power upper limit value Wout is changed in accordance with the damage accumulated in the battery 25 so as to suppress deterioration of the battery 25. Therefore, the deterioration of the battery 25 is affected by the magnitude of the discharging power upper limit value Wout. The data center 500 acquires the extracted data by using the two physical quantities that affect the magnitude of the damage accumulated in the battery 25 as the features. Therefore, according to the data center 500, it is possible to extract data suitable for analyzing the degree of damage to the battery 25.

The data center 500 uses the output of the first motor generator 23A as the first feature. The data center 500 may use the output of the first motor generator 23A as the first feature instead of the output of the second motor generator 23B. In addition, the data center 500 can set the output of the entire motor generator 23 obtained by adding the output of the first motor generator 23A and the output of the second motor generator 23B as the first feature.

The battery 25 is charged and discharged by exchanging electric power with both the first motor generator 23A and the second motor generator 23B. That is, the electric power charged to the battery 25 and the electric power discharged from the battery 25 are a combination of the charging and discharging performed for the first motor generator 23A and the charging and discharging performed for the second motor generator 23B. Therefore, when the output of the entire motor generator 23 is set as the first feature, the magnitudes of the charging output and the discharging output performed on the battery 25 are more appropriately reflected.

### Seventh Embodiment

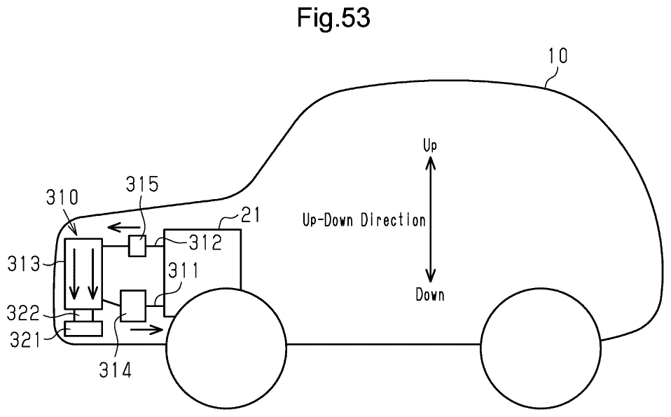

Next, a seventh embodiment of the information processing apparatus will be described with reference to FIGS. 53 to 64. The seventh embodiment is an information processing apparatus that analyzes the degree of damage to a radiator 313 of a cooling system 310 provided in an engine 21 mounted on a vehicle 10. The seventh embodiment is different from the first embodiment in a device or a component for which the degree of damage is analyzed. In the following description, differences from the first embodiment will be mainly described. Detailed description of the same members as those in the first embodiment will be omitted. Also in the seventh embodiment, the information processing apparatus that analyzes the degree of damage is the processing circuitry 510 of the data center 500.

### Configuration of Cooling System 310 in Engine 21

As shown in FIG. 53, the engine 21 mounted on the vehicle 10 is provided with a cooling system 310. The cooling system 310 is a water-cooling type cooling device that cools components of the engine 21 by supplying coolant to a water jacket provided in the engine 21.

The cooling system 310 includes a radiator 313, a water pump 314, and a water temperature gauge 315. The radiator 313 is a heat exchanger that cools coolant that is a refrigerant circulating in the cooling system 310. The coolant is, for example, long life coolant (LLC). The radiator 313 is, for example, an air-cooled heat exchanger. The water pump 314 is a pump that circulates the coolant to the radiator 313.

The cooling system 310 includes a first coolant passage 311 and a second coolant passage 312 that connect the radiator 313 and a water jacket of the engine 21. A water pump 314 is installed in the first coolant passage 311. The water pump 314 draws the coolant from the radiator 313 side and discharges the coolant to the water jacket side. The first coolant passage 311 is a water passage through which the coolant cooled by the radiator 313 is supplied to the water jacket. The second coolant passage 312 is a water passage for returning the coolant that has passed through the water jacket to the radiator 313 for cooling. The coolant circulates through the cooling system 310 as indicated by arrows in FIG. 53. The second coolant passage 312 is provided with a water temperature gauge 315. The water temperature gauge 315 measures the temperature of the coolant flowing into the radiator 313 through the second coolant passage 312.

The radiator 313 acts as a dynamic damper. The radiator 313 is mounted on the vehicle 10 via a support body 321 and an elastic body 322. The support body 321 is a part of the vehicle body of the vehicle 10. The support body 321 is, for example, a part of a skeleton component of a vehicle body provided in a vehicle front portion of the vehicle 10. The elastic body 322 is an elastic component that can expand and contract in the vertical direction of the vehicle 10. The elastic body 322 is, for example, a spring. The elastic body 322 is, for example, an elastic component made of rubber. The radiator 313 can vibrate in the vertical direction partially independently of the vibration of the vehicle 10 in the vertical direction by the expansion and contraction of the elastic body 322. The radiator 313 vibrates in the vertical direction in response to the vibration of the engine 21 to attenuate the vibration of the vehicle body caused by the vibration of the engine 21, thereby functioning as a dynamic damper that suppresses the vibration of the vehicle 10.

### Data Extraction

The information processing terminal 600 transmits an instruction to analyze the degree of damage to the radiator 313 to the data center 500. Then, similarly to the first embodiment, the data center 500 performs a process of cutting out data from the original data using a plurality of time windows.

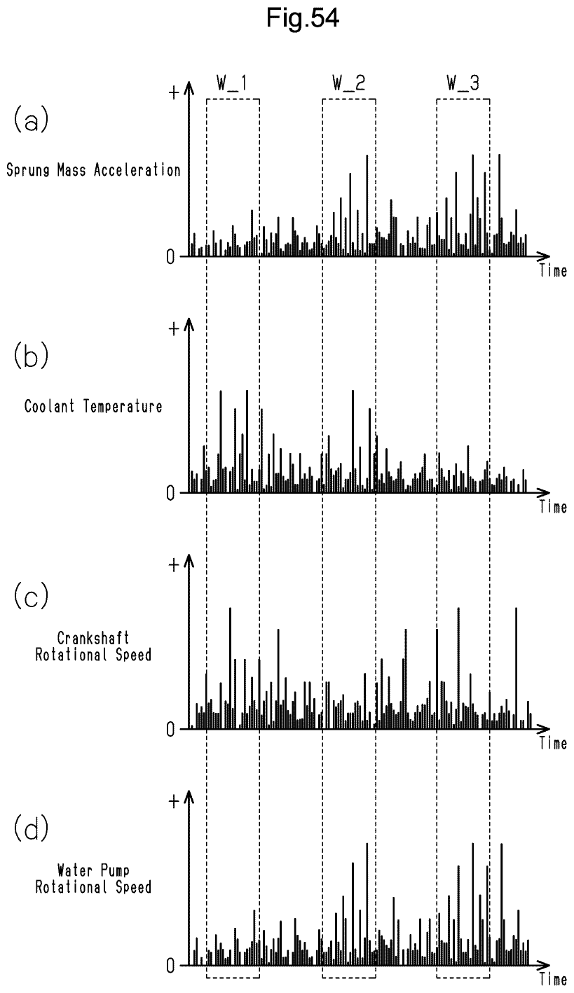

FIG. 54 shows original data of a feature related to the radiator 313 of the specific vehicle 10. The original data shown in FIG. 54 is part of data for 100,000 hours in the vehicle 10 to be analyzed. The original data shown in FIG. 54 includes, as the feature, the acceleration of the vehicle 10 on which the radiator 313 is mounted, for example, the sprung mass acceleration of the vehicle 10. The sprung mass acceleration is an acceleration generated in a vehicle body portion above the suspension in the vehicle 10. The sprung mass acceleration is, for example, an acceleration generated along the vertical direction of the vehicle 10 shown in FIG. 53. The above-described original data includes the temperature of the coolant that is the refrigerant flowing into the radiator 313. The above-described original data includes a crankshaft rotational speed which is an engine rotational speed of the engine 21 to which the radiator 313 is connected. The crankshaft rotational speed is the rotational speed of the engine output shaft 22 per minute. The original data includes the rotational speed of the water pump 314, which is a pump for circulating the coolant through the radiator 313. The feature is a physical quantity correlated with damage to the radiator 313.

Section (a) of FIG. 54 shows the sprung mass acceleration of the vehicle 10. Section (b) of FIG. 54 shows the temperature of the coolant. Section (c) of FIG. 54 shows the crankshaft rotational speed. Section (d) of FIG. 54 shows the rotational speed of the water pump 314. The data center 500 finds a segmentation pattern for extracting extracted data that captures the features of the entire original data including the above-described feature. The processing circuitry 510 analyzes the damage accumulated in the radiator 313 of the vehicle 10 to be analyzed using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the degree of damage to the radiator 313 of the vehicle 10 to be analyzed.

Next, in the process of step S110, the processing circuitry 510 sets a plurality of time windows for the original feature related to the damage to the radiators 313 shown in FIG. 54 and determines a segmentation pattern as in the first embodiment. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

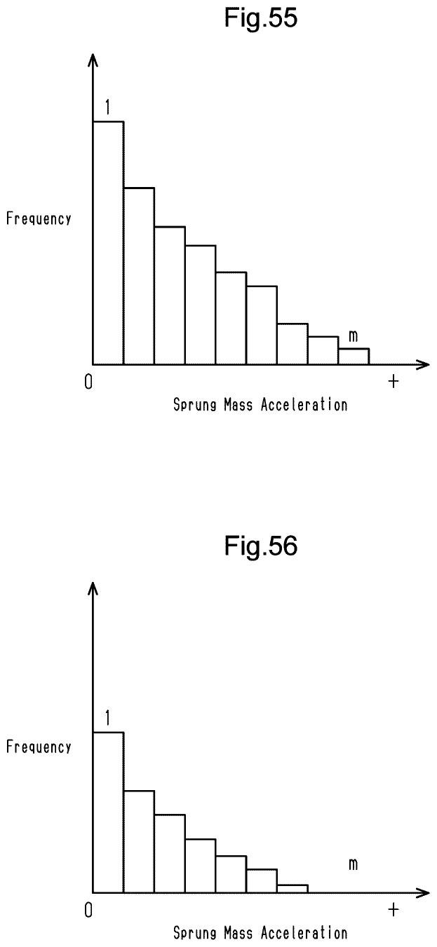

In the process of step S130, the processing circuitry 510 calculates the frequency distributions of the features related to the damage to the radiators 313. In the analysis of the degree of damage to the radiator 313, the first feature is the sprung mass acceleration of the vehicle 10. The second feature is the temperature of the coolant. The processing circuitry 510 divides the sprung mass acceleration of the vehicle 10 into a plurality of sections according to the temperature of the coolant, and calculates the frequency distribution of the original data and the extracted data obtained by combining all the data segmented by the plurality of time windows, as in the first embodiment. FIG. 55 shows the frequency distribution of the sprung mass acceleration of the vehicle 10 in the original data when the temperature of the coolant of the vehicle 10 to be analyzed is lower than the predetermined temperature. FIG. 56 shows the frequency distribution of the sprung mass acceleration of the vehicle 10 in the original data when the temperature of the coolant of the vehicle 10 to be analyzed is equal to or higher than the predetermined temperature. As shown in FIGS. 55 and 56, in these frequency distributions, the sprung mass acceleration is divided into m classes of 1 to m with the sprung mass acceleration of zero as the minimum class. The frequency distribution of the extracted data is also calculated based on the class divisions corresponding to those of the original data. In the case of this example, the processing circuitry 510 divides the sprung mass acceleration of the vehicle 10 included in the original data and the extracted data into two sections of a section in which the temperature of the coolant is lower than a predetermined temperature and a section in which the temperature of the coolant is equal to or higher than the predetermined temperature. The processing circuitry 510 calculates the frequency distribution as described above for each of the two divisions of the temperature of the coolant.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 55 and 56, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Fatigue Damage Level and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the seventh embodiment, similarly to the first embodiment, the fatigue damage level is calculated as an index value indicating the degree of damage accumulated in the radiator 313 based on the extracted data.

Damage is accumulated in the radiator 313 due to vibration generated in the vehicle 10. As the magnitude of the sprung mass acceleration generated in the vehicle 10 increases, the vibration generated in the vehicle 10 increases, and the damage accumulated in the radiator 313 increases. Damage is accumulated in the radiator 313 due to the inflow of high-temperature coolant. When the temperature of the coolant flowing into the radiator 313 is high, the thermal stress applied to each component of the radiator 313 increases, and damage is likely to accumulate. In other words, the damage accumulated in the radiator 313 increases as the temperature of the coolant increases.

As an example, the processing circuitry 510 calculates the fatigue damage level to the radiator 313 by the following method.

The processing circuitry 510 calculates the frequency distribution for each division based on the data obtained by dividing the sprung mass acceleration of the vehicle 10 by the temperature of the coolant at that time. One of the plurality of calculated sections is determined as a reference section. Next, with respect to the data of the section other than the reference section, the data of the sprung mass acceleration included in the section is corrected according to the section of the temperature of the coolant. For this correction, an arbitrary method that can reflect the deterioration of each component due to the thermal stress generated based on the temperature of the coolant can be used in consideration of the material, the heat resistant temperature, and the like of each component of the radiator 313. As an example, when the corrected sprung mass acceleration Ac, which is the sprung mass acceleration after correction, is calculated by defining a mathematical equation in which the temperature of the coolant is incorporated, the subsequent processing is as follows.

Based on the corrected sprung mass acceleration Ac obtained by using the mathematical equation as described above, the processing circuitry 510 consolidates the frequency distributions of all the divisions into one frequency distribution determined as a reference division, and calculates a corrected frequency distribution which is a new frequency distribution in the extracted data. Next, the processing circuitry 510 calculates the fatigue damage level based on the corrected frequency distribution.

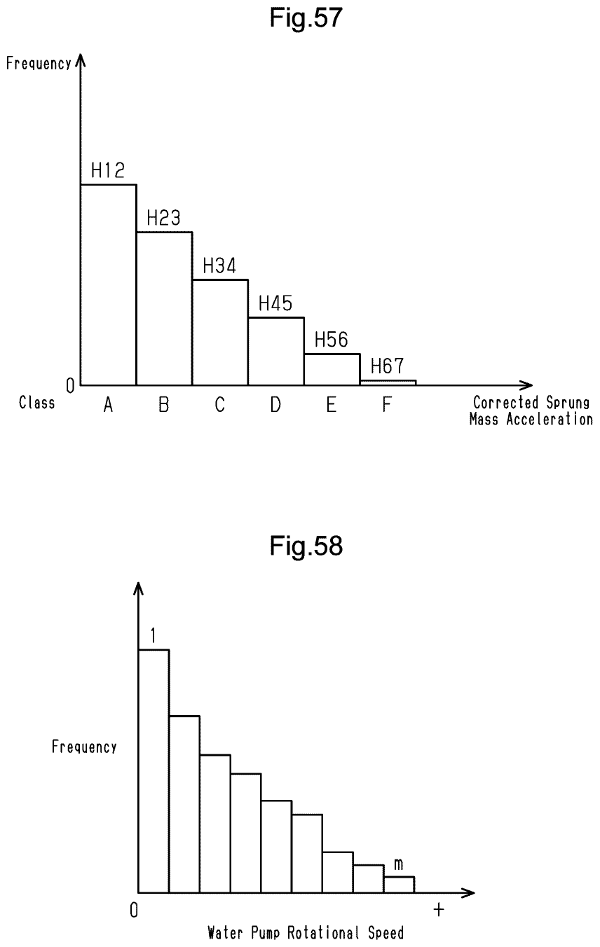

FIG. 57 shows an example of the corrected frequency distribution in the analysis of the degree of damage to the radiator 313. In this correction frequency distribution, the correction sprung mass acceleration Ac is classified into six classes A to F. The frequency Hij of each class indicates the number of data in which the corrected sprung mass acceleration Ac is greater than or equal to Ai and less than Aj. For example, in the class B, the corrected sprung mass accelerations Ac greater than or equal to A2 and less than A3 are classified, and the frequency thereof is expressed as H23. An upper limit frequency Gij is set for each class. The upper limit frequency Gij indicates an upper limit damage accumulation frequency at which fatigue failure occurs in the radiator 313 when damage due to the corrected sprung mass acceleration Ac included in the corresponding class is accumulated. As an example, when G34 is L times, the radiators 313 are fatigue-fractured when the sprung mass accelerations are generated L times such that the corrected sprung mass accelerations Ac are included in the range of not less than the A3 and less than the A4. Similarly to the first embodiment, the processing circuitry 510 calculates the fatigue damage level according to Equation 3 using the frequency Hij for each class and the upper limit frequency Gij for each class in the corrected frequency distribution. After calculating the fatigue damage level, the processing circuitry 510 advances the process to step S170 illustrated in FIG. 4.

The processing circuitry 510 performs the same processing as in the first embodiment for the process of the subsequent steps S170 to S190.

### Operation of Seventh Embodiment

The data center 500 which is the information processing apparatus of the seventh embodiment extracts part of data from original data collected over a specified period by using a plurality of sensors mounted on the vehicle 10, and analyzes the degree of damage accumulated in the radiator 313.

The data center 500 includes a processing circuitry 510 that executes processing in accordance with a program. The original data includes, as the first feature, the sprung mass acceleration of the vehicle 10 equipped with the radiator 313. The original data includes the temperature of the coolant flowing into the radiator 313 as the second feature. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the fatigue damage level as the index value of the damage by using the extracted data in which the errors are less than or equal to the thresholds (step S160).

According to the data center 500, analysis can be performed using the extracted data in which the distribution of the feature related to the damage to the radiator 313 is similar to that of the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of Seventh Embodiment

The seventh embodiment has the following advantages in addition to the advantages (1-1) to (1-5) of the first embodiment.

(7-1) The data center 500 analyzes the degree of damage to the radiator 313. The processing circuitry 510 of the data center 500 sets the sprung mass acceleration of the vehicle 10 on which the radiator 313 is mounted as a first feature and sets the temperature of the coolant flowing into the radiator 313 as a second feature.

Damage is accumulated in the radiator 313 due to vibration generated in the vehicle 10. As the magnitude of the sprung mass acceleration generated in the vehicle 10 increases, the vibration generated in the vehicle 10 increases, and the damage accumulated in the radiator 313 increases.

Damage is accumulated in the radiator 313 due to the inflow of high-temperature coolant. When the temperature of the coolant flowing into the radiator 313 is high, the thermal stress applied to each component of the radiator 313 increases, and damage is likely to accumulate. In other words, the damage accumulated in the radiator 313 increases as the temperature of the coolant increases. The data center 500 acquires the extracted data by using the two physical quantities affecting the magnitude of the damage accumulated in the radiator 313 as the features.

According to the data center 500, data suitable for analyzing the degree of damage to the radiator 313 can be extracted.

### Modifications of Seventh Embodiment

The seventh embodiment may be modified as described below. The seventh embodiment and the following modifications of the seventh embodiment can be implemented in combination with each other as long as there is no technical contradiction.

The data center 500 extracts data by dividing the sprung mass acceleration of the vehicle 10 into a plurality of sections according to the temperature of the coolant. The data center 500 can use the rotational speed of the water pump 314, which is a pump for circulating the coolant through the radiator 313, as the first feature instead of the sprung mass acceleration of the vehicle 10.

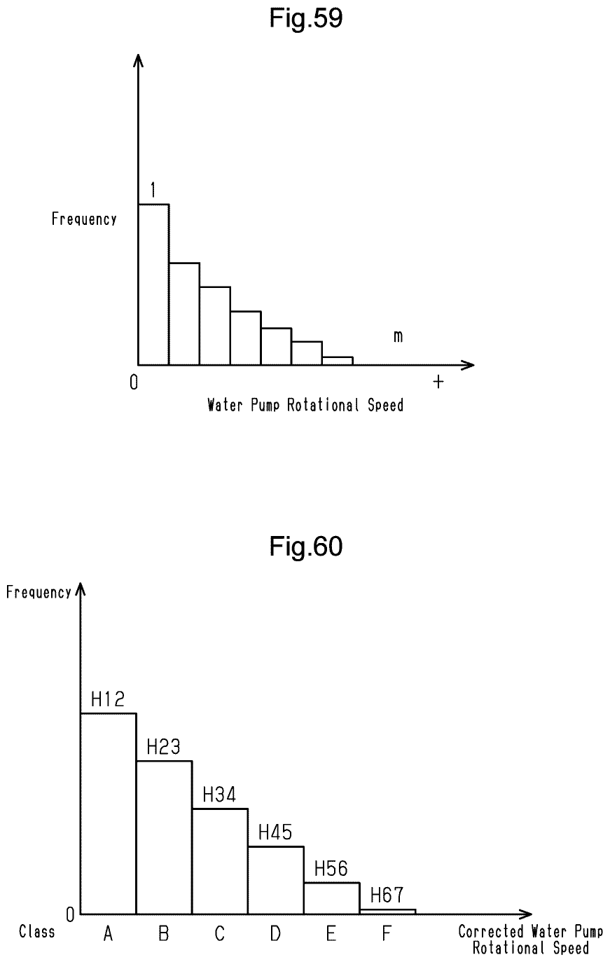

The processing circuitry 510 of the data center 500 calculates the frequency distribution of the original data and the extracted data by dividing the rotational speed of the water pump 314 into a plurality of sections according to the temperature of the coolant. For example, FIG. 58 shows a frequency distribution of the rotational speed of the water pump 314 in the original data when the temperature of the coolant of the vehicle 10 to be analyzed is lower than the predetermined temperature. FIG. 59 shows the frequency distribution of the rotational speed of the water pump 314 in the original data when the temperature of the coolant of the vehicle 10 to be analyzed is equal to or higher than the predetermined temperature. In these frequency distributions, the rotational speed of the water pump 314 is divided into m classes of 1 to m with the rotational speed of the water pump 314 of zero as the minimum class.

The processing circuitry 510 calculates the frequency distribution of the rotational speed of the water pump 314 between the original data and the extracted data as shown in FIGS. 58 and 59 for each division of the temperature of the coolant. The data center 500 may extract the extracted data from the original data using the frequency distribution calculated by dividing the data according to the temperature of the coolant.

Thereafter, in the same manner as described above, the processing circuitry 510 corrects the data of the rotational speed of the water pump 314 included in the section according to the section of the temperature of the coolant, and calculates the rotational speed of the water pump 314 after the correction. Based on the corrected rotational speed of the water pump 314, as shown in FIG. 60, the processing circuitry 510 calculates a corrected frequency distribution which is a new frequency distribution in the extracted data by aggregating the frequency distributions of all the sections into one frequency distribution determined as a section serving as a reference. The processing circuitry 510 calculates the fatigue damage level to the radiator 313 based on the corrected frequency distribution shown in FIG. 60 in the same manner as described above.

The radiator 313 is more likely to be damaged as the pressure of the coolant circulating inside the radiator 313 is higher. When the rotational speed of the water pump 314 is high, the pressure of the coolant circulating inside the radiator 313 becomes high. In other words, the radiator 313 is more likely to be damaged as the rotational speed of the water pump 314 increases.

Damage is accumulated in the radiator 313 due to the inflow of high-temperature coolant. When the temperature of the coolant flowing into the radiator 313 is high, thermal stress applied to the components of the radiator 313 increases, and damage is likely to accumulate. In other words, the damage accumulated in the radiator 313 increases as the temperature of the coolant increases. The data center 500 acquires the extracted data by using the two physical quantities affecting the magnitude of the damage accumulated in the radiator 313 as the features.

According to the data center 500, data suitable for analyzing the degree of damage to the radiator 313 can be extracted.

The data center 500 extracts data by dividing the sprung mass acceleration of the vehicle 10 into a plurality of sections according to the temperature of the coolant. The data center 500 can use, as the second feature, a crankshaft rotational speed that is an engine rotational speed of the engine 21 to which the radiator 313 is connected, instead of the temperature of the coolant.

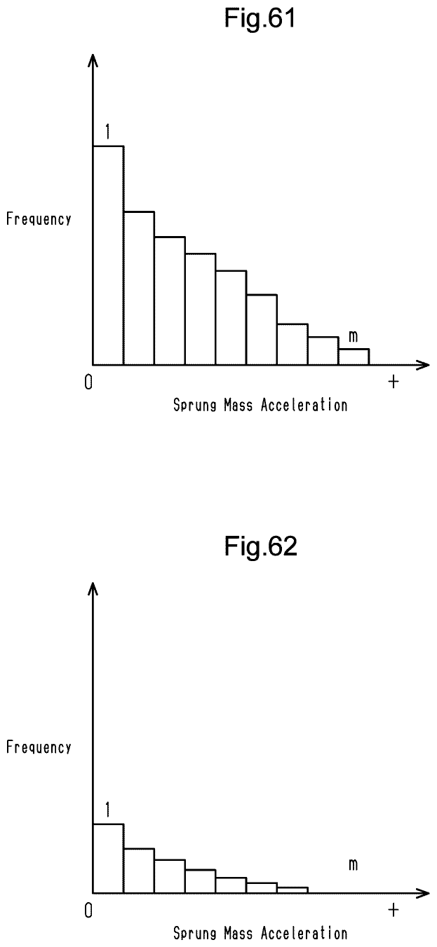

The processing circuitry 510 of the data center 500 calculates the frequency distribution of the original data and the extracted data by dividing the sprung mass acceleration into a plurality of parts according to the number of rotations of the crankshaft. For example, FIG. 61 shows the frequency distribution of the sprung mass acceleration of the vehicle 10 in the original data when the crankshaft rotational speed is outside the predetermined range. FIG. 62 shows a frequency distribution of the sprung mass acceleration of the vehicle 10 in the original data when the crankshaft rotational speed is within the predetermined range. In these frequency distributions, the sprung mass acceleration is divided into m classes of 1 to m with the sprung mass acceleration of zero as the minimum class.

The processing circuitry 510 calculates the frequency distribution of the sprung mass acceleration between the original data and the extracted data as shown in FIGS. 61 and 62 for each division of the crankshaft rotational speed. The data center 500 may extract the extracted data from the original data using the frequency distribution calculated by dividing the original data according to the number of rotations of the crankshaft.

The predetermined range is, for example, a range in which the crankshaft rotational speed is equal to or higher than RVa and lower than RVb. The above-described range is, for example, a range of the crankshaft rotational speed in which the vibration generated in the engine 21 matches the resonance frequency of the vehicle 10. At this time, the radiator 313 functions as a dynamic damper that absorbs the vibration of the engine 21 and suppresses the vibration of the vehicle 10. That is, when the sprung mass acceleration of the vehicle 10 is the same, the vibration of the radiator 313 is larger when the crankshaft rotational speed is within the predetermined range than when the crankshaft rotational speed is outside the predetermined range.

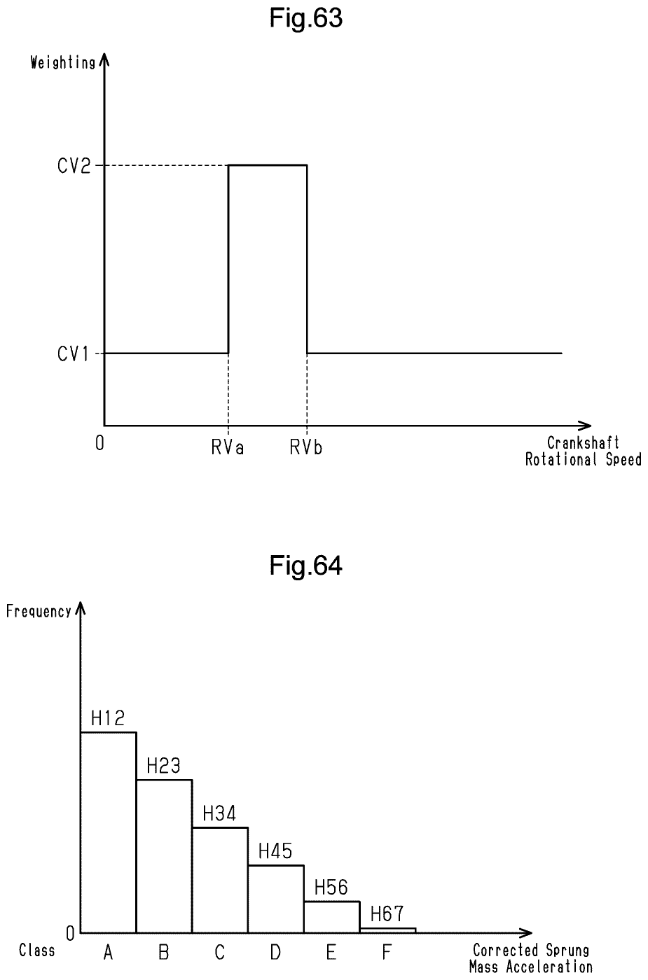

In the calculation of the fatigue damage level, the processing circuitry 510 calculates the frequency distribution of the sprung mass acceleration in the extracted data for each division of the crankshaft rotational speed. At this time, the processing circuitry 510 weights the sprung mass acceleration in accordance with the crankshaft rotational speed as shown in FIG. 63. When the crankshaft rotational speed is in the range of RVa or more and less than RVb, that is, when the crankshaft rotational speed is within the predetermined range, the processing circuitry 510 multiplies the sprung member accelerations by coefficient CV2 used for weighting. When the crankshaft rotational speed is in a range of less than RVa or greater than or equal to RVb, that is, when the crankshaft rotational speed is outside the predetermined range, the processing circuitry 510 multiplies the sprung member accelerations by coefficient CV1 used for weighting. The value of CV2 is set to be larger than CV1. That is, the processing circuitry 510 corrects the data of the sprung mass acceleration so that the sprung mass acceleration is larger when the crankshaft rotational speed is within the predetermined range than when the crankshaft rotational speed is out of the predetermined range.

In this manner, the processing circuitry 510 calculates the frequency distribution of the sprung mass acceleration obtained by correcting the data of the sprung mass acceleration by weighting for each division of the crankshaft rotational speed. Thereafter, as illustrated in FIG. 64, the processing circuitry 510 calculates a corrected frequency distribution which is a new frequency distribution in the extracted data by aggregating the corrected frequency distributions of the respective sections into one frequency distribution determined as a section serving as a reference. The processing circuitry 510 calculates the fatigue damage level to the radiator 313 based on the corrected frequency distribution shown in FIG. 64 in the same manner as described above.

Damage is accumulated in the radiator 313 due to vibration generated in the vehicle 10. As the magnitude of the sprung mass acceleration generated in the vehicle 10 increases, the vibration generated in the vehicle 10 increases, and the damage accumulated in the radiator 313 increases.

Vibration is generated in the engine 21 due to the movement of components inside the engine 21. The magnitude of the vibration in the engine 21 varies depending on the rotational speed of the crankshaft. The vibration generated in the vehicle 10 due to the vibration of the engine 21 damages the radiator 313. That is, the magnitude of damage to the radiator 313 is affected by the number of rotations of the crankshaft. For example, the radiator 313 serving as a dynamic damper is likely to vibrate significantly in a range in which the crankshaft rotational speed is close to the resonance frequency of the vehicle 10. Therefore, the radiator 313 is likely to be greatly damaged when the crankshaft rotational speed is close to the resonance frequency.

The information processing apparatus acquires the extracted data by using the two physical quantities affecting the magnitude of the damage accumulated in the radiator 313 as the features. According to the data center 500, data suitable for analyzing the degree of damage to the radiator 313 can be extracted.

The heat exchanger whose degree of damage is analyzed by the data center 500 is not limited to the radiator 313. The data center 500 may analyze the degree of damage to an oil cooler which is a heat exchanger for cooling lubricating oil. In this case, the refrigerant flowing into the heat exchanger is oil. The oil is, for example, ATF. In this case, the pump for circulating the refrigerant through the heat exchanger is an oil pump.

### Eighth Embodiment

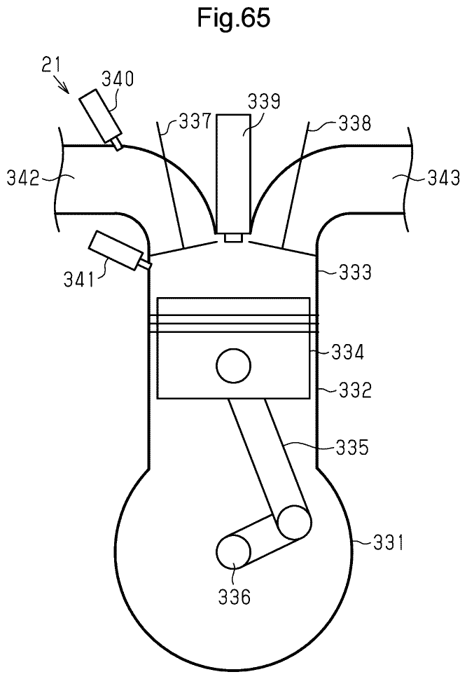

Next, an eighth embodiment of the information processing apparatus will be described with reference to FIGS. 65 to 71. The eighth embodiment is an information processing apparatus that analyzes the degree of damage to the engine 21 by using, as an index, the deposit accumulation amount in the intake system of the engine 21 mounted on the vehicle 10. The eighth embodiment is different from the first embodiment in a device or a component for which the degree of damage is analyzed. In the following description, differences from the first embodiment will be mainly described. Detailed description of the same members as those in the first embodiment will be omitted. Also in the eighth embodiment, the information processing device that analyzes the degree of damage is the processing circuitry 510 of the data center 500.

### Structure of Engine 21

As shown in FIG. 65, the engine 21 is an internal combustion engine having a plurality of cylinders 332. The engine 21 is, for example, a gasoline engine. Each cylinder 332 constitutes a combustion chamber in which a mixture of gasoline and intake air is combusted.

The engine 21 includes a crankcase 331, cylinders 332, a cylinder head 333, an intake passage 342, and an exhaust passage 343. A piston 334 and a connecting rod 335 are accommodated in each cylinder 332. The connecting rod 335 is connected to a crankshaft 336 accommodated in the crankcase 331.

A cylinder head 333 is attached to an upper portion of each cylinder 332. Each cylinder 332 and the cylinder head 333 constitute a combustion chamber in each cylinder 332. The cylinder head 333 includes an intake valve 337, an exhaust valve 338, and an ignition device 339.

The engine 21 is a gasoline engine that supplies gasoline by using both port injection and in-cylinder injection. The intake passage 342 is provided with a port injector 340 that performs port injection. The cylinder head 333 is provided with a direct injector 341 that performs in-cylinder injection. Each of the ignition device 339, the port injector 340, and the direct injector 341 is connected to a control device (not shown). The control device is, for example, an ECU that controls fuel injection and ignition in the engine 21.

An intake passage 342 and an exhaust passage 343 that communicate with each combustion chamber are connected to the cylinder head 333.

The intake passage 342 is a passage for introducing intake air from the outside into each combustion chamber. A downstream end of the intake passage 342 communicates with each combustion chamber. A downstream end portion of the intake passage 342 provided in the cylinder head 333 is an intake port. At this end, an intake valve 337 is provided. An opening of the intake passage 342 to the combustion chamber is opened and closed by an intake valve 337. The intake system of the engine 21 includes the intake passage 342, the intake port, and the intake valve 337 as components.

The exhaust passage 343 is a passage for introducing exhaust gas from each cylinder 332 to an exhaust system component. An upstream end of the exhaust passage 343 communicates with each combustion chamber. An upstream end portion of the exhaust passage 343 provided in the cylinder head 333 is an exhaust port. At this end, an exhaust valve 338 is provided. An opening of the exhaust passage 343 to the combustion chamber is opened and closed by an exhaust valve 338.

### Deposits in Intake System of Engine 21

After the air-fuel mixture is combusted in each combustion chamber of the engine 21, the combustion gas is discharged through the exhaust passage 343. The combustion gas contains fine particles generated by combustion. The fine particles are, for example, soot containing carbon remaining after combustion. When the combustion gas containing these fine particles is blown back to the intake system of the engine 21, the fine particles adhere to and accumulate in the intake system. These particulates deposited in the intake system are referred to as deposits. For example, the deposit is accumulated in an intake port of the engine 21. For example, the deposit accumulates in the intake passage 342 of the engine 21.

The deposits accumulated in the intake system are affected by the valve overlap amount in the engine 21. The valve overlap amount is a length of a period during which both the intake valve 337 and the exhaust valve 338 are in the open state in the combustion cycle in each cylinder 332. The longer the period during which both the intake valve 337 and the exhaust valve 338 are in the open state, the larger the valve overlap amount. When the valve overlap amount is large, the blow-back of the combustion gas to the intake system increases, so that the fine particles contained in the combustion gas are likely to accumulate as deposits in the intake system.

### Data Extraction

The information processing terminal 600 transmits, to the data center 500, an instruction to analyze the degree of damage to the engine 21 using, as an index, the deposit accumulation amount in the intake system of the engine 21. Then, similarly to the first embodiment, the data center 500 performs a process of cutting out data from the original data using a plurality of time windows.

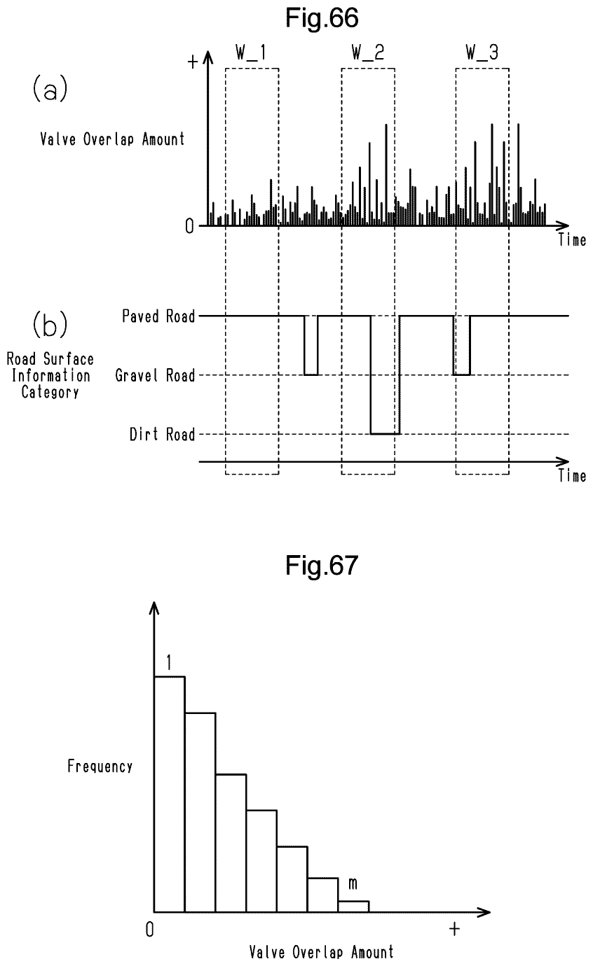

FIG. 66 shows original data of a feature related to the deposit accumulation amount in the intake system of the engine 21 of the specific vehicle 10. The original data shown in FIG. 66 is part of data for 100,000 hours in the vehicle 10 to be analyzed. The original data shown in FIG. 66 includes the valve overlap amount of the engine 21 as the feature. The original data includes, as the feature, the road surface information category assigned based on the position information of the vehicle 10 on which the engine 21 is mounted. The feature is a physical quantity that correlates with the deposit accumulation amount in the intake system of the engine 21.

Section (a) of FIG. 66 shows the valve overlap amount. Section (b) of FIG. 66 shows the road surface information category. The road surface information category is a parameter indicating a condition of a road surface on which the vehicle 10 travels. The road surface information category includes, for example, a paved road, a gravel road, and a dirt road.

The data center 500 finds a segmentation pattern for extracting extracted data that captures the features of the entire original data including the above-described feature. The processing circuitry 510 analyzes the deposit accumulation amount in the intake system of the engine 21 of the vehicle 10 to be analyzed by using the extracted data extracted based on the information of the segmentation pattern found by the data center 500.

### Segmentation Pattern Search Process

As shown in FIG. 4, the processing circuitry 510 executes a series of processes similar to those in the first embodiment in accordance with a program.

In step S100, the processing circuitry 510 acquires the original data of a specific vehicle 10. The original data includes data for analyzing the deposit accumulation amount in the intake system of the engine 21 of the vehicle 10 to be analyzed.

Next, in the process of step S110, the processing circuitry 510 sets a plurality of time windows as in the first embodiment and determines a segmentation pattern for the original feature relating to the amount of deposits accumulated in the intake system of the engine 21 shown in FIG. 66. The plurality of time windows are set so that the total period of all the time windows is shorter than the period of the entire original data.

In step S120, as in the first embodiment, the processing circuitry 510 generates extracted data by extracting datasets using a plurality of time windows on the basis of the extraction pattern determined in step S110.

In the process of step S130, the processing circuitry 510 calculates the frequency distribution of the feature related to the amount of deposits accumulated in the intake system of the engine 21. In the analysis of the deposit accumulation amount in the intake system of the engine 21, the first feature is the valve overlap amount of the engine 21. The second feature is a road surface information category assigned based on the position information of the vehicle 10.

The processing circuitry 510 divides the valve overlap amount into a plurality of sections according to the road surface information category, and calculates the frequency distribution of the original data and the extracted data obtained by combining all the data segmented by the plurality of time windows as in the first embodiment.

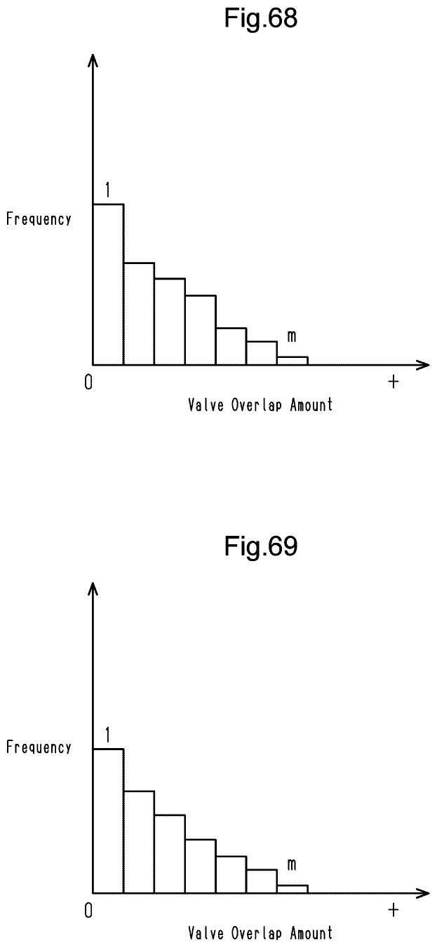

FIG. 67 shows the frequency distribution of the valve overlap amount in the original data when the road surface information category of the vehicle 10 to be analyzed is a paved road. FIG. 68 shows the frequency distribution of the valve overlap amount in the original data when the road surface information category of the vehicle 10 to be analyzed is a gravel road. FIG. 69 shows the frequency distribution of the valve overlap amount in the original data when the road surface information category of the vehicle 10 to be analyzed is a dirt road.

As shown in FIGS. 67 to 69, in these frequency distributions, the valve overlap amount is divided into m classes of 1 to m with the valve overlap amount of zero as the minimum class. The frequency distribution of the extracted data is also calculated based on the class divisions corresponding to those of the original data. In the case of this example, the processing circuitry 510 divides the valve overlap amount included in the original data and the extracted data into three. In each section, the road surface information category includes three sections of a paved road section, a gravel road section, and a dirt road section. The processing circuitry 510 calculates the frequency distribution as described above for each of the three road surface information categories.

Next, in the process of step S140 illustrated in FIG. 4, the processing circuitry 510 calculates the difference between the frequency distributions of the first feature values in the original data and the frequency distributions of the first feature values in the extracted data for each of the plurality of sections based on the second feature values, as in the first embodiment. The error can be calculated using, for example, Equation 1, which is a calculation equation of the mean absolute error MAE, as in the first embodiment. In this case, in the example illustrated in FIGS. 67 to 69, n is m. Similarly, i is an index ranging from 1 to m. When the errors have been calculated for all the sections using Equation 1 above, the processing circuitry 510 advances the process to step S150.

The process of step S150 is the same as the process performed in the first embodiment. The processing circuitry 510 determines whether the original data and the extracted data are similar to each other using the error for each division. Then, the processing circuitry 510 changes the setting of the plurality of time windows and repeats the processes of steps S110 to S150 until the extracted data in which the errors are less than or equal to the thresholds can be extracted. As a result, the segmentation pattern in which all of the errors are less than or equal to the threshold is stored in the storage device 520. In this manner, the processing circuitry 510 acquires the segmentation pattern of the extracted data similar to the original data.

### Calculation of Deposit Accumulation Amount and Predictive Notification of Failure Occurrence

In the process of step S160, the processing circuitry 510 extracts the extraction datum by cutting out the datum from the original data based on the segmentation pattern of the extraction datum similar to the original data stored in the storage device 520 in the processes up to step S150.

In the eighth embodiment, the deposit accumulation amount in the intake system of the engine 21 is calculated as the index value indicating the degree of damage accumulated in the engine 21 based on the extracted data. The deposit accumulation amount is, for example, the mass of soot accumulated in the intake passage 342 of the engine 21. The deposit accumulation amount is, for example, the mass of soot accumulated in the intake port of the engine 21.

The deposits accumulate in the intake system due to the combustion gas being blown back to the intake system. As the valve overlap amount in which the intake valve 337 and the exhaust valve 338 are opened at the same time increases, the blowback to the intake system increases. That is, as the valve overlap amount increases, the deposits are more likely to accumulate in the intake system of the engine 21.

The deposit accumulation amount in the intake system of the engine 21 changes depending on the condition of the road surface on which the vehicle 10 is traveling. The road surface information category is determined based on the position information as a parameter reflecting the condition of the road surface. For example, the road surface information category is a parameter indicating whether the road surface on which the vehicle 10 is traveling is a paved road, a gravel road, or a dirt road. For example, when the vehicle 10 is traveling on a gravel road, dust on the road surface is likely to flow into the intake system. When the combustion gas is blown back to the intake system, the fine particles contained in the dust are deposited in the intake system as a deposit together with the soot contained in the combustion gas. When the vehicle 10 is traveling on a road surface such as a gravel road or a dirt road on which particulates are likely to flow into intake air, deposits are likely to accumulate in the intake system.

As an example, the processing circuitry 510 calculates the deposit accumulation amount of the engine 21 by the following method.

First, the processing circuitry 510 converts the valve overlap amount of the engine 21 in the extracted data into the deposit amount for each road surface information category.

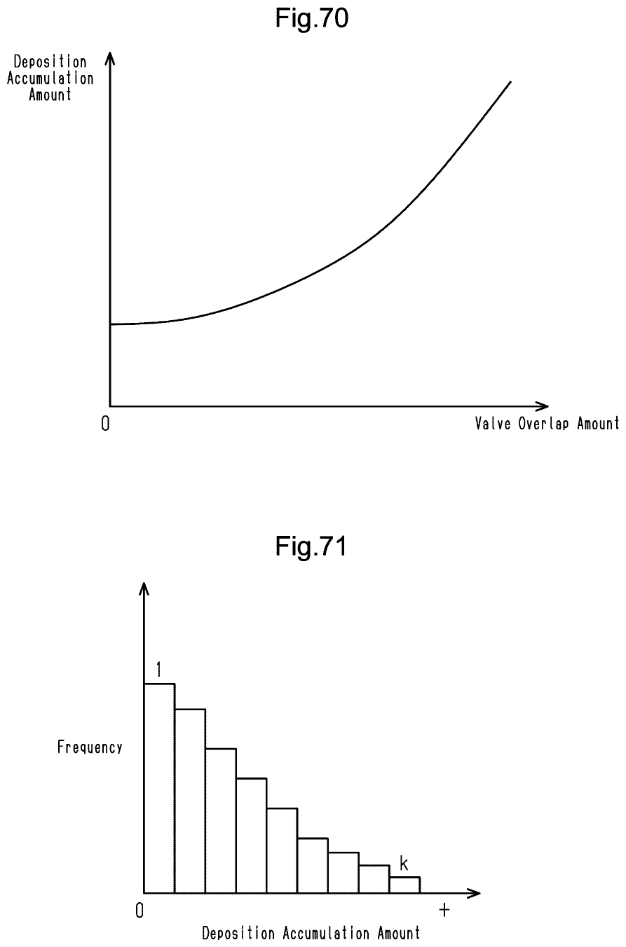

FIG. 70 is a graph showing the relationship between the valve overlap amount and the deposit accumulation amount in the engine 21. The relationship between the valve overlap amount and the deposit accumulation amount is set to be different for each of the road surface information categories. Specifically, when the valve overlap amount is the same, the deposit accumulation amount is set to be larger when the road surface information category is the gravel road than when the road surface information category is the paved road. When the valve overlap amount is the same, the deposit accumulation amount is set to be larger when the road surface information category is the dirt road than when the road surface information category is the gravel road. That is, for the same valve overlap amount, the deposit accumulation amount increases in the order of the paved road, the gravel road, and the dirt road. The processing circuitry 510 converts the valve overlap amount included in the extracted data into the deposit amount based on the relationship shown in the graph shown in FIG. 70. Thus, the frequency distribution of the deposit accumulation amount shown in FIG. 71 is calculated for each of the road surface information categories.

The processing circuitry 510 calculates the frequency distribution of the deposit accumulation amount shown in FIG. 71 for each section of the road surface information category, and then calculates the total deposit accumulation amount Ds for each section of the road surface information category according to the following mathematical equation 7.

$$D s = {\sum }_{i = 1}^{n} ( {d}_{i} \times {t}_{i} ) \qquad Equation 7$$

In Equation 7, n is the total number of classes in the frequency distribution. For example, in the example illustrated in FIG. 71, n is k. i is an index identifying a class in the frequency distribution. For example, in the example illustrated in FIG. 71, i is an index ranging from 1 to k. di is the deposit accumulation amount per frequency in the i-th class. ti is the frequency in the i-th class.

After calculating the total deposition amount Ds for each of the road surface information categories, the processing circuitry 510 calculates the total deposition amount Dp, which is the deposition amount in the entire original data, in accordance with the following mathematical equation 8.

$$D p = \frac{L a l l}{L c u t} \times ( D s p + D s g + D s d ) \qquad Equation 8$$

In Equation 8, Lall is the acquisition period of the original data. In the example illustrated in FIG. 71, Lall is 100,000 hours. Lcut is an acquisition period of the extracted data. In the example illustrated in FIG. 71, Lcut is 20000 hours. Dsp is the total deposit amount Ds when the road surface information category is a paved road. Dsg is the total deposit amount Ds when the road surface information category is a gravel road. Dsd is the total deposit amount Ds when the road surface information category is a dirt road.

After calculating the total deposition amount Dp, the processing circuitry 510 proceeds to step S170 shown in FIG. 4.

In the eighth embodiment, in the process of step S170, the processing circuitry 510 determines whether the total deposition amount Dp is greater than or equal to a boundary value. The boundary value is, for example, the mass of the deposit for predicting that the possibility of occurrence of a malfunction in the engine 21 is high on the basis of the total deposition amount Dp being greater than or equal to the boundary value. The processing circuitry 510 can predict that there is a high possibility that a malfunction will occur in the engine 21 based on the fact that the total deposition amount Dp has reached the boundary value. The malfunction in the engine 21 is, for example, knocking.

In the process of step S170, if it is determined that the total deposition amount Dp is greater than or equal to the boundary value (step S170: YES), the processing circuitry 510 advances the process to step S180. Similarly to the first embodiment, in the process of step S180, the processing circuitry 510 outputs the total deposition amount Dp and the failure prediction.

In the process of step S170, if it is determined that the total deposition amount Dp is less than the boundary value (step S170: NO), the processing circuitry 510 advances the process to step S190. Similarly to the first embodiment, in the process of step S190, the processing circuitry 510 outputs the total deposition amount Dp.

When the process of step S180 or step S190 is executed, the processing circuitry 510 ends the series of processes based on the program.

### Operation of Eighth Embodiment

The data center 500 which is the information processing apparatus of the eighth embodiment extracts part of data from original data collected over a specified period using a plurality of sensors mounted on the vehicle 10, and analyzes the degree of damage accumulated in the engine 21. The data center 500 analyzes the degree of damage accumulated in the engine 21 by using the deposit accumulation amount in the intake system of the engine 21 as an index.

The data center 500 includes a processing circuitry 510 that executes processing in accordance with a program. The original data includes the valve overlap amount of the engine 21 as the first feature. The original data includes, as the second feature, the road surface information category assigned based on the position information of the vehicle 10 on which the engine 21 is mounted. In the data center 500, the processing circuitry 510 executes a search process. The search process includes a first process (step S130) of dividing the first feature into a plurality of divisions by the second feature included in the original data and calculating a frequency distribution of the first feature in the original data for each division. The search process includes a second process (step S110) of setting a plurality of time windows for cutting out a part of the period of the original data so that the total period of all the time windows is shorter than the period of the entire original data. The search process includes a third process (step S120) in which the original data is segmented by a plurality of time windows. Data obtained by combining all the data segmented by the plurality of time windows is extracted data. The search process includes a fourth process (step S130) of dividing the first feature value into a plurality of divisions corresponding to the plurality of divisions of the second feature value of the original data, and calculating the frequency distributions of the first feature value in the extracted image for each division. The search process includes a fifth process (steps S140 and S150) of calculating a difference between the frequency distributions of the original data and the extracted data and determining whether the original data and the extracted data are similar to each other. After executing the first process, the processing circuitry 510 executes a search process of repeatedly executing the processes from the second process to the fifth process while changing the setting of the plurality of time windows. Then, the processing circuitry 510 extracts extracted data in which the error is less than or equal to a threshold. The processing circuitry 510 calculates the amount of deposits accumulated in the intake system of the engine 21 as the index value of the damage by using the extracted data in which the errors are less than or equal to the thresholds (step S160).

According to the data center 500, the analysis can be performed by using the extracted data in which the distribution of the feature related to the deposit accumulation amount in the intake system of the engine 21 is similar to the original data. Therefore, the data center 500 can obtain an analysis result close to the result of the damage analysis performed using the original data.

The extracted data extracted by the data center 500 is a part of the original data. Therefore, the extracted data has a smaller amount of data than the original data. The processing time required to analyze the degree of damage increases as the amount of data used for the analysis increases. By using the extracted data, the data center 500 can shorten the analysis time as compared with the case of using the original data.

### Advantages of Eighth Embodiment

The eighth embodiment has the following advantages in addition to the advantages (1-1) to (1-5) of the first embodiment.

(8-1) The data center 500 analyzes the degree of damage to the engine 21 using the deposit accumulation amount in the intake system of the engine 21 as an index. The processing circuitry 510 of the data center 500 sets the valve overlap amount of the engine 21 as the first feature, and sets the road surface information category assigned based on the position information of the vehicle 10 on which the engine 21 is mounted as the second feature.

The deposits accumulate in the intake system due to the combustion gas being blown back to the intake system. As the valve overlap amount in which the intake valve 337 and the exhaust valve 338 are opened at the same time increases, the blowback to the intake system increases. That is, as the valve overlap amount increases, the deposits are more likely to accumulate in the intake system of the engine 21.

The deposit accumulation amount in the intake system of the engine 21 changes depending on the condition of the road surface on which the vehicle 10 is traveling. The road surface information category is determined based on the position information as a parameter reflecting the condition of the road surface. For example, the road surface information category is a parameter indicating whether the road surface on which the vehicle 10 is traveling is a paved road, a gravel road, or a dirt road. For example, when the vehicle 10 is traveling on a gravel road, dust on the road surface is likely to flow into the intake system. When the combustion gas is blown back to the intake system, the fine particles contained in the dust are deposited in the intake system as a deposit together with the soot contained in the combustion gas. When the vehicle 10 is traveling on a road surface such as a gravel road or a dirt road on which particulates are likely to flow into intake air, deposits are likely to accumulate in the intake system.

The data center 500 acquires the extracted data by using the two physical quantities affecting the deposit accumulation amount in the intake system of the engine 21 as the features. According to the data center 500, data suitable for analyzing the degree of damage to the engine 21 can be extracted.

### Modification of Eighth Embodiment

The eighth embodiment may be modified as follows. The eighth embodiment and the following modifications of the eighth embodiment can be implemented in combination with each other as long as there is no technical contradiction.

The data center 500 determines whether the original data and the extracted data are similar to each other by using an error for each section of the road surface information category in the frequency distribution of the valve overlap amount. The data center 500 may determine whether the original data and the extracted data are similar to each other by using an error for each section of the road surface information category in the frequency distribution of the deposit accumulation amount.

In this case, in step S130, the data center 500 calculates the frequency distributions of the valve overlap amounts for the original data and the frequency distributions of the valve overlap amounts for the extracted data for each of the road surface information categories. Thereafter, the data center 500 calculates the frequency distribution of the deposit accumulation amount for the original data and the frequency distribution of the deposit accumulation amount for the extracted data for each section of the road surface information category based on the relationship shown in FIG. 70. Then, in step S140, the data center 500 calculates the difference between the frequency distributions of the amounts of deposits in the original data and the frequency distributions of the amounts of deposits in the extracted data for each of the road surface information categories. The data center 500 may determine whether the original data and the extracted data are similar to each other by using the error of the frequency distribution of the deposit accumulation amount.

In step S160, the data center 500 may calculate a predicted value of the amount of deposits actually accumulated in the intake system of the vehicle 10 based on the total accumulation amount of deposits Dp. For example, the processing circuitry 510 of the data center 500 calculates the deposit accumulation prediction amount from the deposit total accumulation amount Dp based on the relational equation stored in the storage device 520. The above relational equation is, for example, an arbitrary function obtained by investigating in advance the relationship between the total deposition amount Dp calculated based on the extracted data and the deposition amount actually deposited in the intake system of the above plurality of vehicles 10 for the plurality of vehicles 10. The deposit accumulation amount in the intake system of the vehicle 10 can be more accurately analyzed by calculating the deposit accumulation prediction amount from the deposit total accumulation amount Dp using the function based on the actually measured data.

### Modifications

The following are elements that can be modified and are generally applicable to each of the above-described embodiments. The following modification can be combined as long as the combined modification remains technically consistent with each other.

In the above-described embodiment, an example in which the information processing apparatus is embodied as the data center 500 has been described. An example in which the calculation of the index value is executed in the data center 500 has been described. On the other hand, the information processing apparatus may be embodied as the information processing terminal 600. In this case, the calculation of the index value is executed by the processing circuit 610 of the information processing terminal 600. The information processing device may be embodied as a control device of the vehicle 10. In this case, the calculation of the index value may be executed by the control device of the vehicle 10. For example, the calculation of the index value may be executed by the second control device 92 of the vehicle 10.

The data center 500 determines that the original data and the extracted data are similar to each other when all of the errors for the respective sections are less than or equal to the threshold. On the other hand, the data center 500 may not use all of the errors for the respective sections for the similarity determination. It is possible to determine that the extracted data is similar to the original data when all the errors are less than or equal to the threshold by using only the sections having a large influence on the degree of damage to one or more devices or components.

The data center 500 determines the similarity when the error for each section is less than or equal to a threshold. On the other hand, the data center 500 can calculate the sum of errors for each section and determine that the extracted data is similar to the original data when the calculated sum of errors is less than or equal to a threshold.

When the total frequencies in the frequency distributions of the respective sections are compared, the frequency distribution of the section to which the second feature is applied more often has a larger total frequency. Therefore, the influence of each error calculated for each section on the similarity determination based on the sum of the errors is likely to be larger in a section to which the second feature is applied more frequently. Data in a section to which the second feature is often applied in the original data is likely to have a large influence in the analysis of the degree of damage. Therefore, in order to extract data suitable for analyzing the degree of damage, it is desirable that the error of the frequency distribution between the original data and the extracted data is small for the section to which the second feature is often applied.

The data center 500 of the modification example analyzes the degree of damage by using the extracted data in which the sum of the errors is less than or equal to the threshold. Therefore, the extracted data having a large error in the frequency distribution for the section to which the second feature is often applied is less likely to be used for the analysis. That is, the analysis is likely to be performed using the extracted data having a small error in the frequency distribution for the section to which the second feature is often applied. According to the data center 500, it is possible to appropriately determine whether the original data and the extracted data are similar to each other by reflecting the fact that the frequency at which the second feature is applied is different for each section.

In addition, the data center 500 may not use a part of the error for each section for the calculation of the total sum. The sum of the errors may be calculated using only the sections having a large influence on the degree of damage to one or more devices or components. When the sum of the errors thus calculated is less than or equal to a threshold, it can be determined that the extracted data is similar to the original data.

The data center 500 determines the similarity between the original data and the extracted data by calculating the error of the frequency distribution. On the other hand, the data center 500 may determine whether the original data and the extracted data are similar to each other without calculating the error. For example, when the difference between the original data and the extracted data is not significant, it can be determined that they are similar to each other by using a statistical method such as a goodness of fit test.

The data center 500 performs both the extraction of data and the analysis of the degree of damage by using the data of the second feature when the data of the first feature is collected. On the other hand, the data center 500 may not necessarily use the same feature in the extraction of data and the analysis of the degree of damage. For example, it is possible to analyze the degree of damage using another feature when the first feature and the second feature are extracted.

The processing circuitry 510 of the data center 500 may exchange the combination of the first feature and the second feature with each other to perform the extraction of data and the analysis of the degree of damage.

In step S110 of FIG. 4, the data center 500 can set a plurality of time windows in consideration of the ratio of each section to the entire data. For example, the plurality of time windows can be set such that the ratio of the data of each section to the entire original data is equal to the ratio of the data of each section corresponding to the original data to the entire extracted data.

The processing circuitry 510 includes a central processing unit (CPU), a random access memory (RAM), and a read-only memory (ROM). The processing circuitry 510 executes software processing. However, this is merely exemplary. For example, the processing circuitry 510 may include a dedicated hardware circuit that processes at least a part of the software processing executed in the above-described embodiment. The dedicated hardware circuit is, for example, an application-specific integrated circuit (ASIC). That is, the processing circuit may be modified as long as it has any one of the following configurations (a) to (c). (a) The processing circuitry 510 includes a processing device that executes all processes in accordance with a program and a program storage device such as a ROM that stores the program. That is, the processing circuitry 510 includes a software execution device. (b) The processing circuitry 510 includes a processing device that executes a part of processing in accordance with a program, and a program storage device. Further, the processing circuitry 510 includes a dedicated hardware circuit that executes the remaining processing. (c) The processing circuitry 510 includes a dedicated hardware circuit for executing all processes. There may be multiple software execution devices and/or dedicated hardware circuits. That is, the processing can be executed by a processing circuit (processing circuitry) including at least one of a software execution device and a dedicated hardware circuit. The processing circuitry may include multiple software execution devices and multiple dedicated hardware circuits. The program storage device, or computer readable medium, includes any type of storage device that is a medium accessible by a versatile computer or a dedicated computer. The program may be stored in a computer-readable non-volatile data storage medium such as a CD-ROM and distributed as a program product. The program may be provided as a downloadable program product by an information provider connected to a network such as the Internet.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing device configured to extract part of data from original data collected over a specified period using sensors mounted on a vehicle and analyze a degree of damage to a device or a component mounted on the vehicle, the information processing device comprising processing circuitry, wherein
a physical quantity related to the damage to the device or the component included in the original data is defined as a first feature, and a physical quantity that is different from the first feature included in the original data is defined as a second feature,
the processing circuitry is configured to execute a first process that divides the original data into multiple datasets using the second feature and calculates, for each of the datasets of the original data, a frequency distribution of the first feature in the dataset,
the processing circuitry is configured to change time windows and repeatedly execute:
a second process that sets the time windows for segmenting data for a specific period of the original data such that a period obtained by summing periods of all the time windows is shorter than the specified period;
a third process that segments the data from the original data using the time windows;
a fourth process that divides extracted data into multiple datasets in correspondence with divisions of the datasets of the original data and calculates, for each of the datasets of the extracted data, the frequency distribution of the first feature in the dataset of the extracted data, wherein the extracted data is obtained by combining all the data segmented by the time windows; and
a fifth process that determines whether the original data is similar to the extracted data using the frequency distribution, and
the processing circuitry is configured to analyze, using the extracted data similar to the original data, the degree of the damage to the device or the component based on the first feature and the second feature.

2. The information processing device according to claim 1, wherein
the processing circuitry is configured to, in the fifth process, calculate an error between the frequency distribution of the original data and the frequency distribution of the extracted data for each of the divisions and determine that the original data is similar to the extracted data when a sum of the calculated errors is less than or equal to a threshold.

3. The information processing device according to claim 1, wherein
the processing circuitry is configured to:
calculate, in the fifth process, an error between the frequency distribution of the original data and the frequency distribution of the extracted data for each of the divisions; and
determine that the original data is similar to the extracted data when all of the errors for the divisions are less than or equal to a threshold.

4. The information processing device according to claim 1, wherein
the processing circuitry is configured to correct the first feature included in the extracted data in accordance with the divisions, and analyze the degree of the damage to the device or the component based on the corrected first feature.

5. The information processing device according to claim 1, wherein
the information processing device is configured to analyze a degree of damage to a parking lock device that prevents rotation of an output shaft of a transmission; and
the processing circuitry sets, as the first feature, a vehicle speed obtained when a shift position of the transmission is a parking position, and sets an inclination angle of the vehicle as the second feature.

6. The information processing device according to claim 1, wherein
the information processing device is configured to analyze a degree of damage to a rotating machine, and
the processing circuitry sets an angular acceleration of the rotating machine as the first feature and sets, as the second feature, a temperature of the rotating machine or a temperature correlated with the temperature of the rotating machine.

7. The information processing device according to claim 1, wherein
the information processing device is configured to analyze a degree of damage to a rotating machine, and
the processing circuitry sets an angular acceleration of the rotating machine as the first feature and sets, as the second feature, a temperature of refrigerant that cools the rotating machine.

8. The information processing device according to claim 1, wherein
the information processing device is configured to analyze a degree of damage to a seal component with which a rotor is in sliding contact, and
the processing circuitry sets a rotational speed of the rotor as the first feature and sets, as the second feature, a temperature of fluid to be sealed by the seal component.

9. The information processing device according to claim 1, wherein
the information processing device is configured to analyze a degree of damage to a seal component with which a rotor is in sliding contact, and
the processing circuitry sets a rotational speed of the rotor as the first feature and sets an ambient temperature as the second feature.

10. The information processing device according to claim 1, wherein
the information processing device is configured to analyze a degree of damage to a planetary gear, and
the processing circuitry sets, as the first feature, a torque to be input to the planetary gear and sets, as the second feature, a temperature of lubricant that lubricates the planetary gear.

11. The information processing device according to claim 1, wherein
the information processing device is configured to analyze a degree of damage to a planetary gear, and
the processing circuitry sets, as the first feature, a torque to be input to the planetary gear and sets, as the second feature, a rotational speed of a pump that discharges lubricant that lubricates the planetary gear.

12. The information processing device according to claim 1, wherein
the information processing device is configured to analyze a degree of damage to a planetary gear, and
the processing circuitry sets, as the first feature, a torque to be input to the planetary gear and sets an inclination angle of the vehicle as the second feature.

13. The information processing device according to claim 1, wherein
the information processing device is configured to analyze a degree of damage to a drive shaft, and
the processing circuitry sets, as the first feature, a torque to be input to the drive shaft and sets a steering wheel angle as the second feature.

14. The information processing device according to claim 1, wherein
the information processing device is configured to analyze a degree of damage to a battery that supplies and receives power to and from an electric motor, and
the processing circuitry sets an output of the electric motor as the first feature and sets, as the second feature, one selected from a group consisting of a temperature of the battery, a state of charge (SOC) of the battery, a charging power upper limit value of the battery, and a discharging power upper limit value of the battery.

15. The information processing device according to claim 1, wherein
the information processing device is configured to analyze a degree of damage to a heat exchanger, and
the processing circuitry sets, as the first feature, an acceleration of the vehicle on which the heat exchanger is mounted and sets, as the second feature, a temperature of refrigerant flowing into the heat exchanger.

16. The information processing device according to claim 1, wherein
the information processing device is configured to analyze a degree of damage to a heat exchanger, and
the processing circuitry sets, as the first feature, an acceleration of the vehicle on which the heat exchanger is mounted and sets, as the second feature, an engine rotational speed of an internal combustion engine to which the heat exchanger is connected.

17. The information processing device according to claim 1, wherein
the information processing device is configured to analyze a degree of damage to a heat exchanger, and
the processing circuitry sets, as the first feature, a rotational speed of a pump that circulates refrigerant through the heat exchanger and sets, as the second feature, a temperature of the refrigerant flowing into the heat exchanger.

18. The information processing device according to claim 1, wherein
the information processing device is configured to analyze a degree of damage to an internal combustion engine using, as an index, a deposit accumulation amount in an intake system of an internal combustion engine, and
the processing circuitry sets a valve overlap amount of the internal combustion engine as the first feature and sets, as the second feature, a road surface information category given based on position information of the vehicle on which the internal combustion engine is mounted.

19. An information processing method in which processing circuitry extracts part of data from original data collected over a specified period using sensors mounted on a vehicle and analyzes a degree of damage to a device or a component mounted on the vehicle, wherein
a physical quantity related to the damage to the device or the component included in the original data is defined as a first feature, and a physical quantity that is different from the first feature included in the original data is defined as a second feature,
the information processing method comprises:
executing, by the processing circuitry, a first process that divides the original data into multiple datasets using the second feature and calculates, for each of the datasets of the original data, a frequency distribution of the first feature in the dataset,
by the processing circuitry, changing time windows and repeatedly executing:
a second process that sets the time windows for segmenting data for a specific period of the original data such that a period obtained by summing periods of all the time windows is shorter than the specified period;
a third process that segments the data from the original data using the time windows;
a fourth process that divides extracted data into multiple datasets in correspondence with divisions of the datasets of the original data and calculates, for each of the datasets of the extracted data, the frequency distribution of the first feature in the dataset of the extracted data, wherein the extracted data is obtained by combining all the data segmented by the time windows; and
a fifth process that determines whether the original data is similar to the extracted data using the frequency distribution, and
analyzing, by the processing circuitry, using the extracted data similar to the original data, the degree of the damage to the device or the component based on the first feature and the second feature.

20. A non-transitory computer-readable storage medium storing a program that causes processing circuitry to extract part of data from original data collected over a specified period using sensors mounted on a vehicle and analyze a degree of damage to a device or a component mounted on the vehicle, wherein
a physical quantity related to the damage to the device or the component included in the original data is defined as a first feature, and a physical quantity that is different from the first feature included in the original data is defined as a second feature,
the program, when executed by the processing circuitry, causes the processing circuitry to execute a first process that divides the original data into multiple datasets using the second feature and calculates, for each of the datasets of the original data, a frequency distribution of the first feature in the dataset,
the program, when executed by the processing circuitry, causes the processing circuitry to change time windows and repeatedly execute:
a second process that sets the time windows for segmenting data for a specific period of the original data such that a period obtained by summing periods of all the time windows is shorter than the specified period;
a third process that segments the data from the original data using the time windows;
a fourth process that divides extracted data into multiple datasets in correspondence with divisions of the datasets of the original data and calculates, for each of the datasets of the extracted data, the frequency distribution of the first feature in the dataset of the extracted data, wherein the extracted data is obtained by combining all the data segmented by the time windows; and
a fifth process that determines whether the original data is similar to the extracted data using the frequency distribution, and
the program, when executed by the processing circuitry, causes the processing circuitry to analyze, using the extracted data similar to the original data, the degree of the damage to the device or the component based on the first feature and the second feature.
